(19) United States
(12) Patent Application Publication
(10) Pub. No.: US 2025/0106718 A1
(43) Pub. Date: Mar. 27, 2025

(54) DYNAMIC SERVICE SWITCH FOR MULTI-SIM OPERATION BASED ON NON-TERRESTRIAL NETWORK DURING DISCONTINUOUS SATELLITE COVERAGE

(71) Applicant: Samsung Electronics Co., Ltd., Suwon-si (KR)

(72) Inventors: Aman AGARWAL, Bangalore (IN); Siddharth SHUKLA, Bangalore (IN); Kailash Kumar JHA, Bangalore (IN); Nishant, Bangalore (IN); Lalith KUMAR, Bangalore (IN)

(21) Appl. No.: 18/919,225

(22) Filed: Oct. 17, 2024

Related U.S. Application Data
(63) Continuation of application No. PCT/KR2024/014219, filed on Sep. 20, 2024.

(30) Foreign Application Priority Data
Sep. 21, 2023 (IN) 202341063460
Sep. 4, 2024 (IN) 202341063460

(51) Int. Cl. H04W 36/08; H04B 7/185; H04W 60/06; H04W 84/06

(52) U.S. Cl. CPC H04W 36/083; H04B 7/18519; H04W 60/06; H04W 84/06

(57) ABSTRACT

A method performed by a user equipment (UE) may comprise: receiving one or more discontinuous coverage parameters associated with a first SIM of the UE, identifying a default SIM of at least one service as the first SIM of the UE over a first non-terrestrial network (NTN), estimating a time period for completion of the at least one service based on one or more service parameters associated with the at least one service, configuring a second SIM of the UE to provide the at least one service based on the time period and the one or more discontinuous coverage parameters, and switching the default SIM of at least one service from the first SIM to the second SIM of the UE.

### CROSS-REFERENCE TO RELATED APPLICATIONS

This application is a continuation of International Application No. PCT/KR2024/014219 designating the United States, filed on Sep. 20, 2024, in the Korean Intellectual Property Receiving Office and claiming priority to Indian Provisional Patent Application No. 202341063460, filed on Sep. 21, 2023, and Indian Complete patent application No. 202341063460, filed on Sep. 4, 2024, in the Indian Patent Office, the disclosures of each of which are incorporated by reference herein in their entireties.

### BACKGROUND

### Field

The disclosure relates to a service switching system, and for example, relates to dynamic service switch for multi-Subscriber Identity Module (SIM) operation based on Non-Terrestrial Network (NTN) during discontinuous satellite coverage.

### Description of Related Art

Typically, for a User Equipment (UE) with dual Subscriber Identity Modules (SIMs), it is possible that a SIM, for example, SIM 1, may be preset as default SIM for default data usage and/or for default calling/messaging usage and/or for default emergency services usage and/or for default application usage. For example, the default SIM may be preset as Default/Designated Data Service/Subscription (DDS) SIM and/or the default calling/messaging SIM and is camped to 4G/5G service under Non-Terrestrial Network (NTN) satellite coverage. The other SIM, for example, SIM 2, which is the non-DDS/non-default calling/messaging SIM is camped to 4G/5G service under either terrestrial or NTN satellite coverage of a different operator. As per Rel-18 of the 3rd Generation Partnership Project (3GPP), specification of TR 23.700-28 v18.1.0 describes that discontinuous satellite coverage for satellite access is characterized by the fact that Uu interface (between 4G/5G UE and 4G/5G-RAN) is available for the UE less than 100% of the time, due to predictable patterns of satellite coverage. As such, for the UE using a Next Generation Radio Access Network (NG-RAN/LTE) that provides discontinuous coverage (e.g., for satellite access with discontinuous coverage), the UE may be out of NTN network coverage at a certain time.

In general, the default SIM (e.g., SIM 1), which was earlier camped to 4G/5G service under NTN satellite coverage, might be out of network coverage for a certain duration due to the predictable movement of the satellite. Due to this discontinuous NTN coverage on the default SIM (e.g., SIM 1), the user services which are just initiated or ongoing on the default SIM prior to satellite coverage loss such as voice call, data service, emergency call service etc. are interrupted, thereby affecting user experience. Moreover, in the case of critical services such as emergency services, any interruption/failure may be very critical for the user and such failures/interruption needs to be avoided. During this discontinuous NTN service period on the default SIM, the UE may either have to remain with no service or it may attempt to register on any available different RAT's/PLMNs to receive the normal service. This would take some time, and the user may not be able to use any services on the default SIM. However, during the same time instance, the other SIM (e.g., SIM 2) might be in coverage and may be able to provide services (data/calling/messaging/emergency services, etc.) to the user without any interruption.

Currently, there is no provision for the UE to predetermine or pre-empt the loss of services (e.g., data/calling/messaging/emergency services, etc.) accurately from the default SIM. For example, the services ongoing on the default SIM are interrupted in the event of out-of-coverage encountered during discontinuous satellite coverage period and the user may not get services (e.g., Data/Calling/Messaging/Emergency/Application services) from the primary SIM. The user may have to manually switch the DDS or Default Calling/Messaging/Emergency/Application option to another SIM Card (Secondary SIM) to get Data/Calling/Messaging/Emergency/Application services leading to a poor user experience. In view of the above, there exists a need for uninterrupted continuation of services in the event of discontinuous satellite coverage on the default SIM.

The information disclosed in this background of the disclosure section is simply to aid in understanding of the general background of the disclosure and should not be taken as an acknowledgement or any form of suggestion that this information forms the prior art already known to a person skilled in the art.

### SUMMARY

In an example embodiment, a method for multi-Subscriber Identity Module (SIM) operation in a Non-Terrestrial Network (NTN) is disclosed. The method includes: detecting, by a User Equipment (UE), a default configuration of at least one service of a plurality of services on a first SIM of the UE over a first Non-Terrestrial Network (NTN); estimating, by the UE, a time period for completion of the at least one service on the first SIM based on one or more service parameters associated with the at least one service; determining, by the UE, one or more first discontinuous coverage parameters associated with the first SIM of the UE; configuring, by the UE, a second SIM of the UE to provide the at least one service based on the time period and the one or more first discontinuous coverage parameters; and switching, by the UE, the default configuration of at least one service from the first SIM to the second SIM of the UE.

In an example embodiment, a User Equipment (UE) for multi-Subscriber Identity Module (SIM) operation in a Non-Terrestrial Network (NTN) is disclosed. The UE includes: a first SIM, a second SIM, a memory and at least one processor, comprising processing circuitry. The first SIM is configured to provide at least one service of a plurality of services for the UE over a first Non-Terrestrial Network (NTN). The memory is configured to store instructions. At least one processor, individually and/or collectively, is configured to execute the instructions stored in the memory and configured to: detect a default configuration of the at least one service on the first SIM of the UE; estimate a time period for completion of the at least one service on the first SIM based on one or more service parameters associated with the at least one service; determine one or more first discontinuous coverage parameters associated with the first SIM of the UE; configure the second SIM of the UE to provide the at least one service based on the time period and the one or more first discontinuous coverage parameters; and switch the default configuration of at least one service the at least one service from the first SIM to the second SIM of the UE.

In an example embodiment, a method for multi-Subscriber Identity Module (SIM) operation in a Non-Terrestrial Network (NTN) is disclosed. The method includes: receiving, by a User Equipment (UE), one or more first discontinuous coverage parameters associated with a first SIM of the UE; identifying a default configuration of at least one service of a plurality of services on a first SIM; determining, by the UE, a discontinuous coverage of the first SIM based on the one or more first discontinuous coverage parameters; and continuing, by the UE, the at least one service of the plurality of services over a second SIM based on the discontinuous coverage.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

to the above and other aspects, features and advantages of certain embodiments of the present disclosure will be more apparent from the following detailed description, taken in conjunction with the accompanying drawings in which:

FIGS. 1A, 1B and 1C are diagrams illustrating example environments depicting discontinuous satellite coverage for a User Equipment (UE), in which various embodiments of the present disclosure may be implemented;

FIG. 2 is a block diagram illustrating an example configuration of a UE for multi-Subscriber Identity Module (SIM) operation based on Non-Terrestrial Network (NTN) during discontinuous satellite coverage, according to various embodiments;

FIG. 3 is a signal flow diagram illustrating an example multi-Subscriber Identity Module (SIM) operation based on NTN during discontinuous satellite coverage, according to various embodiments;

FIGS. 4A and 4B are diagrams illustrating examples of a UE displaying a User Interface (UI) corresponding to switching between multi-Subscriber Identity Module (SIMs) during discontinuous satellite coverage, according to various embodiments;

FIG. 5A is a flowchart illustrating an example multi-Subscriber Identity Module (SIM) operation for call services based on Non-Terrestrial Network (NTN) during discontinuous satellite coverage, according to various embodiments;

FIG. 5B is a flowchart illustrating an example multi-Subscriber Identity Module (SIM) operation for data services based on Non-Terrestrial Network (NTN) during discontinuous satellite coverage, according to various embodiments;

FIG. 6 is a flowchart illustrating an example method for multi-SIM operation based on NTN during discontinuous satellite coverage, according to various embodiments;

FIG. 7 is a flowchart illustrating an example method for multi-SIM operation based on NTN during discontinuous satellite coverage, according to various embodiments; and

FIG. 8 is a block diagram illustrating an example configuration of computer for multi-SIM operation based on NTN during discontinuous satellite coverage, according to various embodiments.

It should be appreciated by those skilled in the art that any block diagrams herein represent conceptual views of illustrative systems embodying the principles of the disclosure. Similarly, it will be appreciated that any flowcharts, flow diagrams, state transition diagrams, pseudo code, and the like represent various processes which may be substantially represented in computer-readable medium and executed by a computer or processor, whether or not such computer or processor is explicitly shown.

### DETAILED DESCRIPTION

In the present disclosure, the word “exemplary” is used herein to refer, for example, to “serving as an example, instance, or illustration”. Any embodiment or implementation of the present disclosure described herein as “exemplary” is not necessarily to be construed as preferred or advantageous over other embodiments.

While the disclosure is susceptible to various modifications and alternative forms, various example embodiments have been shown by way of example in the drawings and will be described in greater detail below. It should be understood, however that it is not intended to limit the disclosure to the particular forms disclosed, but on the contrary, the disclosure is to cover all modifications, equivalents, and alternative falling within the spirit and the scope of the disclosure.

The terms “comprises”, “comprising”, or any other variations thereof, are intended to cover a non-exclusive inclusion, such that a setup, device, or method that comprises a list of components or steps does not include only those components or steps but may include other components or steps not expressly listed or inherent to such setup or device or method. In other words, one or more elements in a device or system or apparatus proceeded by “comprises . . . a” does not, without more constraints, preclude the existence of other elements or additional elements in the device or system or apparatus.

In the following detailed description, reference is made to the accompanying drawings that form a part hereof, and in which are shown by way of illustration various example embodiments in which the disclosure may be practiced. It is to be understood that various embodiments may be utilized and that changes may be made without departing from the scope of the present disclosure. The following description is, therefore, not to be taken in a limiting sense.

The following abbreviations and definitions may be referred to herein: 3GPP: Third Generation Partnership Project
a. 5GC: 5G Core
b. 5GCN: 5G Core Network
c. 5G-GUTI: 5G-Globally Unique Temporary Identifier
d. 5GMM: 5G Mobility Management
e. 5GS: 5G System
f. 5GSM: 5GS Session Management
g. 5G-S-TMSI: 5G S-Temporary Mobile Subscription Identifier
h. 5G-TMSI: 5G Temporary Mobile Subscription Identifier
i. AI: Artificial Intelligence
j. AMF: Access and Mobility Management Function
k. AS: Access Stratum
l. BSR: Better System Reselection
m. CAG: Closed access group
n. CAG ID: Closed Access Group Identifier
o. CN: Core Network
p. CU: Centralized Unit
q. DB: Database
r. DC: Discontinuous Coverage
S. DisCo: Discontinuous Coverage
t. DL: Downlink
u. DRX: Discontinuous Reception
v. DU: Distributed Unit
w. eDRX: Extended Discontinuous Reception
x. EHPLMN: Equivalent Home Public Land Mobile Network
y. EMM: EUTRA Mobility Management
z. eNB: Evolved Node-B
aa. eNPN: Enhanced Non-Public Networks
bb. EPC: Evolved Packet Core
cc. EPLMN: Equivalent Public Land Mobile Network
dd. EPS: Evolved Packet System
ee. eSIM: embedded Subscriber Identity Module
ff. E-UTRA: Evolved Universal Mobile Telecommunication Access
gg. EUTRAN: Evolved Universal Mobile Telecommunication Access Network
hh. FPLMN: Forbidden Public Land Mobile Network
ii. FR: Frequency Range
jj. GEO: Geostationary Orbit
kk. GERAN: GSM Edge Radio Access Network
ll. GERAN EC-GSM-IoT: GSM Edge Radio Access Network Extended Coverage-GSM-Internet of Things
mm. gNB: Next generation Node-B
nn. gNB-CU: Next generation Node-B Control Unit
oo. gNB-DU: Next generation Node-B Distributive Unit
pp. GPRS: General Packet Radio Service
qq. GSM: Global System for Mobile Communication
rr. HPPLMN: Higher Priority Public Land Mobile Network
ss. HPLMN: Home Public Land Mobile Network
tt. IAB: Integrated access and backhaul.
uu. IAB-UE: The part of the IAB node that supports the Uu interface towards the IAB-donor or another parent IAB-node (and thus manages the backhaul connectivity with either PLMN or SNPN it is registered with) is referred to as an IAB-UE.
vv. LADN: Local Area Data Network
ww. LEO: Low Earth Orbit
xx. LRPLMN: Last Registered Public Land Mobile Network
yy. LRPLMNSI: Last Registered PLMN Selection Indication
zz. LRRAT: Last Registered Radio Access Technology
aaa. MCC: Mobile Country Code
bbb. ME: Mobile Equipment
ccc. MEC: Multi-Access Edge Computing
ddd. MEO: Medium Earth Orbit
eee. MICO: Mobile Initiated Communication Only
fff. ML: Machine Learning
ggg. MME: Mobility Management Entity
hhh. MNC: Mobile Network Code
iii. MPS: Multimedia Priority Service
jjj. MS: Mobile Station. The disclosure makes no distinction between MS and UE.
kkk. NAS: Non-Access Stratum
lll. NB-S1 Mode: Narrow Band with S1 Interface
mmm. NF: Network Function
nnn. NGAP: Next Generation Application Protocol
ooo. NG-RAN: Next Generation Radio Access Network
ppp. Non-3GPP: Non-3rd Generation Participation Project
qqq. NPN: Non-Public Networks
rrr. NR: New Radio
sss. NTN: Non-Terrestrial Networks
ttt. NW: Network
uuu. OOS: Out of Service
vvv. OS Upgrade: Operating System Upgrade
www. PDN: Packet Data Network
xxx. PDU: Packet Data Unit
yyy. PLMN ID: Public Land Mobile Network Identity
zzz. PSM: Power Saving Mode
aaaa. QOS: Quality of Service
bbbb. RAT: Radio Access Technology
cccc. RPLMN: Registered Public Land Mobile Network
dddd. RRC: Radio Resource Control
eeee. RU: Registration Update
ffff. SAT: Satellite
gggg Satellite: an artificial body placed in orbit round the earth or moon or another planet in order to collect information or for communication.
hhhh. Satellite Constellation: Group of satellites, placed in orbit round the earth or moon or another planet in order to collect information or for communication.
iiii. SCAF: Satellite Coverage Availability Function
jjjj. SCAI: Satellite Coverage Availability Information
kkkk. Service User: An individual who has received a priority level assignment from a regional/national authority (e.g., an agency authorised to issue priority assignments) and has a subscription to a mobile network operator.
llll. SIM: Subscriber Identity Module
mmmm. SMS: Short Messaging Service
nnnn. SNPN: Standalone Non-Public Networks
oooo. SUCI: Subscription Concealed Identifier
pppp. SW: Software
qqqq. TAC: Tracking Area Code
rrrr. TAI: Tracking Area Identity
ssss. TAU: Tracking Area Update
tttt. TER: Terrestrial
uuuu. TN: Terrestrial Networks
vvvv. UCU: UE Configuration Update
wwww. UDM: Unified Data Management Function
xxxx. UE: User Equipment
yyyy. UL: Uplink
zzzz. ULI: User Location Information
aaaaa. UPU: UE Parameters Update
bbbbb. USIM: Universal Subscriber Identification Module
ccccc. Uu: The radio interface between the UE and the Node B
ddddd. VMR: Vehicle Mounted Relay
eeeee. VPLMN: Visited Public Land Mobile Network
fffff. WB-S1 Mode: Wide Band with S1 Interface
ggggg. Visited PLMN (VPLMN): This is a PLMN different from the HPLMN (if the EHPLMN list is not present or is empty) or different from an EHPLMN (if the EHPLMN list is present).
hhhhh. Allowable PLMN: In the case of an MS operating in MS operation mode A or B, this is a PLMN which is not in the list of “forbidden PLMNs” in the MS. In the case of an MS operating in MS operation mode C or an MS not supporting A/Gb mode and not supporting Iu mode, this is a PLMN which is not in the list of “forbidden PLMNs” and not in the list of “forbidden PLMNs for GPRS service” in the MS.
iiiii. Available PLMN: PLMN(s) in the given area which is/are broadcasting capability to provide wireless communication services to the UE.
jjjjj. Camped on a cell: The MS (ME if there is no SIM) has completed the cell selection/reselection process and has chosen a cell from which it plans to receive all available services. Note that the services may be limited, and that the PLMN or the SNPN may not be aware of the existence of the MS (ME) within the chosen cell.
kkkkk. EHPLMN: Any of the PLMN entries contained in the Equivalent HPLMN list.
lllll. Equivalent HPLMN list: To allow provision for multiple HPLMN codes, PLMN codes that are present within this list shall replace the HPLMN code derived from the IMSI for PLMN selection purposes. This list is stored on the USIM and is known as the EHPLMN list. The EHPLMN list may also contain the HPLMN code derived from the IMSI. If the HPLMN code derived from the IMSI is not present in the EHPLMN list, then it shall be treated as a Visited PLMN for PLMN selection purposes.
mmmmm. Home PLMN: This is a PLMN where the MCC and MNC of the PLMN identity match the MCC and MNC of the IMSI.
nnnnn. Registered PLMN (RPLMN): This is the PLMN on which certain LR (location registration which is also called as registration procedure) outcomes have occurred. In a shared network the RPLMN is the PLMN defined by the PLMN identity of the CN operator that has accepted the LR.
ooooo. Registration: This is the process of camping on a cell of the PLMN or the SNPN and doing any necessary LRs.
ppppp. UPLMN: PLMN/access technology combination in the “User Controlled PLMN Selector with Access Technology” data file in the SIM (in priority order).
qqqqq. OPLMN: PLMN/access technology combination in the “Operator Controlled PLMN Selector with Access Technology” data file in the SIM (in priority order) or stored in the ME (in priority order).
rrrrr. Acceptable Cell/Network: Acceptable cell/Network is the cell/Network that is not enough to be a suitable cell/Network but meets the minimum condition at least to make an emergency call. The minimum conditions are:
   a. The cell/Network is not barred.
   b. The cell/Network selection criteria are met.
sssss. Suitable Cell/Network: The cell that the UE may camp on for a normal service. The E-UTRA and UTRA Suitable Cell criteria is defined in 36.304 4.3 Service types in Idle Mode as follows.

The cell is part of either:
the selected PLMN (PLMN that has been selected by the NAS, either manually or automatically), or:
the registered PLMN (PLMN on which certain Location Registration outcomes have occurred.
a PLMN of the Equivalent PLMN list according to the latest information provided by NAS:
The cell is not barred;
The cell is part of at least one TA that is not part of the list of “forbidden tracking areas for roaming”.
The cell selection criteria are fulfilled

S&F Satellite operation for delay-tolerant communication services: S&F Satellite operation may refer, for example, to an operation mode of a 5G system with satellite-access, where the 5G system can provide some level of communication service (in storing and forwarding the data) when satellite connectivity is intermittently/temporarily unavailable, e.g. to provide communication service for UEs under satellite coverage without a simultaneous active feeder link connection to the ground segment. This is particularly relevant for delay-tolerant communication service.

The concept of “S&F” service is widely used in the fields of delay-tolerant networking and disruption-tolerant networking. In 3GPP context, a service that could be assimilated to an S&F service is SMS, for which there is no need to have an end-to-end connectivity between the end-points (e.g. an end-point can be a UE and the other an application server) but only between the end-points and the SMSC which acts as an intermediate node in charge of storing and relying.

The support of S&F Satellite operation is especially suited for the delivery of delay-tolerant/non-real-time satellite services with Non-Geostationary Satellite Orbits (NGSO) satellites.
satellite access: direct connectivity between the UE and the satellite.
serving satellite: a satellite providing the satellite access to a UE. In the case of NGSO (Non-Geostationary Satellite Orbit), the serving satellite is always changing due to the nature of the constellation.
S&F data retention period: may refer to the data storage validity period for the 5G system with satellite access supporting store and forward operation.
S&F Data Storage Quota: may refer to the maximum amount of Data Storage for the 5G system with satellite access supporting store and forward operation.

NAS messages as referred to herein can be (but not limited to) REGISTRATION REQUEST message; DEREGISTRATION REQUEST message; SERVICE REQUEST message; CONTROL PLANE SERVICE REQUEST; IDENTITY REQUEST; AUTHENTICATION REQUEST; AUTHENTICATION RESULT; AUTHENTICATION REJECT; REGISTRATION REJECT; REGISTRATION ACCEPT; DEREGISTRATION ACCEPT; SERVICE REJECT; SERVICE ACCEPT; UE CONFIGURATION UPDATE command, UE PARAMETERS UPDATE command, and so on.

The term 5GMM sublayer states in this embodiment are at least one of the below:
1) 5GMM-NULL
2) 5GMM-DEREGISTERED
   a) 5GMM-DEREGISTERED.NORMAL-SERVICE
   b) 5GMM-DEREGISTERED.LIMITED-SERVICE
   c) 5GMM-DEREGISTERED.ATTEMPTING-REGISTRATION
   d) 5GMM-DEREGISTERED.PLMN-SEARCH
   e) 5GMM-DEREGISTERED.NO-SUPI
   f) 5GMM-DEREGISTERED.NO-CELL-AVAILABLE
   g) 5GMM-DEREGISTERED.eCALL-INACTIVE
   h) 5GMM-DEREGISTERED.INITIAL-REGISTRATION-NEEDED
3) 5GMM-REGISTERED-INITIATED
4) 5GMM-REGISTERED
   a) 5GMM-REGISTERED.NORMAL-SERVICE
   b) 5GMM-REGISTERED.NON-ALLOWED-SERVICE
   c) 5GMM-REGISTERED.ATTEMPTING-REGISTRATION-UPDATE
   d) 5GMM-REGISTERED.LIMITED-SERVICE
   e) 5GMM-REGISTERED.PLMN-SEARCH
   f) 5GMM-REGISTERED.NO-CELL-AVAILABLE
   g) 5GMM-REGISTERED.UPDATE-NEEDED
5) 5GMM-DEREGISTERED-INITIATED
6) 5GMM-SERVICE-REQUEST-INITIATED

In this embodiment, the term EMM sublayer states are at least one of the below:
1) EMM-NULL
2) EMM-DEREGISTERED
   a) EMM-DEREGISTERED.NORMAL-SERVICE
   b) EMM-DEREGISTERED.LIMITED-SERVICE
   c) EMM-DEREGISTERED.ATTEMPTING-TO-ATTACH
   d) EMM-DEREGISTERED.PLMN-SEARCH
   e) EMM-DEREGISTERED.NO-IMSI
   f) EMM-DEREGISTERED.ATTACH-NEEDED
   g) EMM-DEREGISTERED.NO-CELL-AVAILABLE
   h) EMM-DEREGISTERED.eCALL-INACTIVE
3) EMM-REGISTERED-INITIATED
4) EMM-REGISTERED
   a) EMM-REGISTERED.NORMAL-SERVICE
   b) EMM-REGISTERED.ATTEMPTING-TO-UPDATE
   c) EMM-REGISTERED.LIMITED-SERVICE
   d) EMM-REGISTERED.PLMN-SEARCH
   e) EMM-REGISTERED.UPDATE-NEEDED
   f) EMM-REGISTERED.NO-CELL-AVAILABLE
   g) EMM-REGISTERED.ATTEMPTING-TO-UPDATE-MM
   h) EMM-REGISTERED.IMSI-DETACH-INITIATED
5) EMM-DEREGISTERED-INITIATED
6) EMM-TRACKING-AREA-UPDATING-INITIATED
7) EMM-SERVICE-REQUEST-INITIATED

The term RAT as used herein may be one or more of the following: NG-RAN, 5G, 4G, 3G, 2G, EPS, 5GS, NR, NR in unlicensed bands, NR (LEO) satellite access, NR (MEO) satellite access, NR (GEO) satellite access, NR (OTHERSAT) satellite access, NR RedCap, E-UTRA, E-UTRA in unlicensed bands NB-IoT, WB-IoT, LTE-M, and so on.

Registration or 5GS registration may refer to any 5GS Registration type which can be initial registration, mobility registration, updating periodic registration, updating emergency registration, SNPN onboarding registration, disaster roaming initial registration/disaster roaming mobility registration updating, and so on.

PLMN selection as per 23.122 without RPLMN: The MS selects and attempts registration on any PLMN/access technology combinations, if available and allowable, in the following order:
a) either the HPLMN (if the EHPLMN list is not present or is empty) or the highest priority EHPLMN that is available (if the EHPLMN list is present);
b) each PLMN/access technology combination in the “User Controlled PLMN Selector with Access Technology” data file in the SIM (in priority order);
c) each PLMN/access technology combination in the “Operator Controlled PLMN Selector with Access Technology” data file in the SIM (in priority order) or stored in the ME (in priority order);
d) other PLMN/access technology combinations with received high quality signal in random order; and
e) other PLMN/access technology combinations in order of decreasing signal quality.

PLMN selection as per 23.122 with RPLMN: The MS selects and attempts registration on any PLMN/access technology combinations, if available and allowable, in the following order:
a) either the RPLMN or the Last registered PLMN;
b) either the HPLMN (if the EHPLMN list is not present or is empty) or the highest priority EHPLMN that is available (if the EHPLMN list is present);
c) each PLMN/access technology combination in the “User Controlled PLMN Selector with Access Technology” data file in the SIM (in priority order);
d) each PLMN/access technology combination in the “Operator Controlled PLMN Selector with Access Technology” data file in the SIM (in priority order) or stored in the ME (in priority order);
e) other PLMN/access technology combinations with received high quality signal in random order; and
f) other PLMN/access technology combinations in order of decreasing signal quality.

The terms UE and MS are used interchangeably in this embodiment and have the same meaning.

The term area/location/geographical area are used in this embodiment may refer to any of cell/cell ID, TAC/TAI, PLMN, MCC/MNC, Latitude/longitude, CAG cell or any geographical location/coordinate.

The various embodiments are applicable to any (but not limited to) of the RAT(s) as defined in this embodiment.

The Network or Network Functions used in this embodiment could be any 5G/EUTRAN Core Network Entities like AMF/SMF/MME/UPF/PCF/AF/OAM/NEF/UDM/HSS or the Network could be any (but not limited to) 5G/EUTRAN RAN Entity like eNodeB (eNB) or gNodeB (gNB) or NG-RAN etc.

The terms unavailability period duration, unavailability period, discontinuous coverage, discontinuous coverage period and unavailability duration are interchangeably used and have the same meaning.

The terms start time, start of unavailability period, start of unavailability duration, start of discontinuous coverage, start of discontinuous coverage period and start of unavailability period duration is interchangeably used and have the same meaning.

The terms support of/for “Unavailability Period” and “Unavailability Period Support” are used interchangeably and have the same meaning.

The NTN and TN could either operate in two different frequency bands (e.g. FR1 vs FR2), or in same frequency band (e.g. FR1 or FR2).

The terms NTN, 3GPP based Satellite Network, Satellite 3GPP access, Satellite access, Satellite Access Network, NR Satellite Access Network, Satellite NG-RAN Access Technology and NR Satellite access have been interchangeably used and have the same meaning.

The methods, issues or solutions disclosed in this disclosure are explained using NR satellite access or Satellite NG-RAN Access Technology as an example and is not restricted or limited to NR Satellite access only. However, the solutions disclosed herein are also applicable for any NTN Technology, any 3GPP based Satellite Network, any legacy 3GPP Networks (for e.g. NR, LTE etc), Satellite E-UTRAN access Technology, NB (Narrow Band)-S1 mode or WB (Wide Band)-S1 mode via satellite E-UTRAN access and/or NB-IoT (NarrowBand Internet Of Things) or WB-IoT (WideBand Internet Of Things) Satellite Access/Architecture.

The solutions and procedures which are defined for NR (5GC) are also applicable to legacy RATs like E-UTRA/LTE, the corresponding 5G CN entities needs to be replaced by LTE entities for e.g. AMF with MME, g-nodeB with e-nodeB, UDM with HSS etc. Similarly, the corresponding 5G procedures needs to be replaced by LTE procedures for e.g. Registration procedure with Attach Procedure, Registration procedure for mobility registration updating with TAU procedure, Deregistration Procedure with Detach procedure and so on. But principles of the solution remain same.

An example list of NAS messages can be, but not limited to, REGISTRATION REQUEST message; DEREGISTRATION REQUEST message; SERVICE REQUEST message; CONTROL PLANE SERVICE REQUEST; IDENTITY REQUEST; AUTHENTICATION REQUEST; AUTHENTICATION RESULT; AUTHENTICATION REJECT; REGISTRATION REJECT; DEREGISTRATION ACCEPT; SERVICE REJECT; SERVICE ACCEPT, and so on.

The Network used in this disclosure may be explained using any 5G Core Network Function for e.g. AMF. However, the network could be any 5G/EUTRAN Core Network Entities like AMF/SMF/MME/UPF, or the Network could be any 5G/EUTRAN RAN Entity like eNodeB (eNB) or gNodeB (gNB) or NG-RAN etc.

The messages used or indicated in this embodiment are shown as an example. The messages could be any signalling messages between UE and the Network Functions/Entities or between different Network functions/entities.

The term area/location/geographical area are used in this embodiment may refer to any of cell/cell ID, TAC/TAI, PLMN, MCC/MNC, Latitude/longitude, CAG cell or any geographical location/coordinate.

The 3GPP Technical document and references and the version number given in this disclosure are for reference/example and may be present in or refer to any of the 3GPP Technical documents or references.

In this disclosure, SIB19 and SIB32 are given for examples and the parameters/indication from Network can be configured in any of the broadcast or signaling messages.

The methods, issues or solutions disclosed in this disclosure are explained using NR access or NG-RAN Access Technology as an example and is not restricted or limited to NR access only. However, the solutions disclosed are also applicable for E-UTRAN access Technology, NB (Narrow Band)-S1 mode or WB (Wide Band)-S1 mode via E-UTRAN access and/or NB-IoT (NarrowBand Internet of Things) or WB-IoT (WideBand Internet of Things) Access/Architecture.

The solutions which are defined for NR (5GC) are also applicable to legacy RATs like E-UTRA/LTE, the corresponding CN entities needs to be replaced by LTE entities for e.g. AMF with MME, g-nodeB with e-nodeB, UDM with HSS etc. But principles of the solution remain same.

The Network used in this embodiment is explained using any 5G Core Network Function for e.g. AMF. However, the network could be any 5G/EUTRAN Core Network Entities like AMF/SMF/MME/UPF, or the Network could be any 5G/EUTRAN RAN Entity like eNodeB (eNB) or gNodeB (gNB) or NG-RAN etc.

The messages used or indicated in this disclosure are shown as an example. The messages could be any signaling messages between UE and the Network Functions/Entities or between different Network functions/entities.

The terms camp and register are used interchangeably and have the same meaning.

The solutions and procedures disclosed are illustrated using 5G or LTE as an example. It could be any applicable for any RAT(s)/Access, but the core principles remain the same.

The terms camp, register, attach and Tracking area update (TAU) are interchangeably used in this embodiment and have the same meaning.

The solutions and procedures of the disclosure are illustrated using one of cell(s), RAT(s), PLMN(s) and Access(es) as an example. It could be applicable for any Network or Network Entity and the core principle remains the same.

The term area as used in this disclosure may refer to any of cell/cell ID, TAC/TAI, PLMN, MCC/MNC, Latitude/longitude, any CAG/CAG identifier or any geographical location/coordinate.

For the list of possible NAS messages reference may be made to 3GPP TS 24.501 or 3GPP TS 24.301, for list of AS messages please refer to 3GPP TS 38.331 or 3GPP TS 36.331.

The cause names in this disclosure are for illustration purpose and it can have any name. The non access stratum (NAS) messages and access stratum (AS) messages described in this embodiment are only for illustration purpose it can be any NAS or AS messages as per defined protocol between UE and AMF/MME or UE and gNB (NG-RAN/any RAN node)/eNB.

The term Network as used in this disclosure may refer to any PLMN, RAT, Access, Access Technology or any combination of these.

The term NTN or NR/E-UTRAN Satellite Access Network as used in this disclosure may refer to any of the NR Satellite Access Network or E-UTRAN Satellite Access Network or NR Satellite Access Technology or E-UTRAN Satellite Access Technology.

In this disclosure, RPLMN and LRPLMN may refer to the same thing and have same meaning.

In this disclosure, Registered PLMN and Last Registered PLMN may refer to the same thing and have same meaning.

The terms searching, scanning, selecting, registering, attaching, initiating Tracking Area Update (TAU) and camping have been used interchangeable and have same meaning.

The terms unavailability period duration, unavailability period, discontinuous coverage, discontinuous coverage period and unavailability duration are interchangeably used and have the same meaning.

The terms start time, start of unavailability period, start of unavailability duration, start of discontinuous coverage, start of discontinuous coverage period and start of unavailability period duration is interchangeably used and have the same meaning.

In Non Terrestrial Networks (NTN), Continuous satellite coverage can be characterized by Uu interface is available for the UE, at a given position for 100% of the time.

The terms unavailability period duration, unavailability period, discontinuous coverage, discontinuous coverage period and unavailability duration are interchangeably used and have the same meaning.

The terms start time, start of unavailability period, start of unavailability duration, start of discontinuous coverage, start of discontinuous coverage period and start of unavailability period duration is interchangeably used and have the same meaning.

In Non Terrestrial Networks (NTN), Continuous satellite coverage can be characterized by Uu interface is available for the UE, at a given position for 100% of the time.

In Non Terrestrial Networks (NTN), Discontinuous satellite coverage can be characterized by Uu interface is available for the UE, at a given position, less than 100% of the time, due to predictable lack of satellite coverage.

Due to Discontinuous coverage, the UE may have access to satellite service coverage only at specific time and places.

In Non Terrestrial Networks (NTN), Discontinuous satellite coverage can be characterized by Uu interface is available for the UE, at a given position, less than 100% of the time, due to predictable lack of satellite coverage.

Due to Discontinuous coverage, the UE may have access to satellite service coverage only at specific time and places.

As used herein, the term “network” may refer to one or more of a Public Land Mobile Network (PLMN) or a Radio Access Technology (RAT) or an access or a system or a Radio Access Network (RAN) or a band or a frequency or a cell or a Network entity or a Network function or any Terrestrial Network or any Non-Terrestrial Network or any component of the network.

As used herein, the term “Non-Terrestrial Network (NTN)” may refer to one or more of a non-terrestrial PLMN or a non-terrestrial RAT or a non-terrestrial access or a non-terrestrial system or a non-terrestrial RAN or a non-terrestrial band or a non-terrestrial frequency or a non-terrestrial cell or a non-terrestrial Network entity or a non-terrestrial network function or a component of a non-terrestrial network or a network other than TN or a network on Satellite Access Network.

As used herein, the term “Terrestrial Network (TN)” may refer to one or more of a terrestrial PLMN or a terrestrial RAT or a terrestrial access or a terrestrial system or a terrestrial RAN or a terrestrial band or a terrestrial frequency or a terrestrial cell or a terrestrial Network entity or a terrestrial network function or a component of a terrestrial network or a Network other than NTN or a network other than Satellite Access Network.

As used herein, the term “User Equipment (UE)” may refer to one or more of an NTN-capable UE or a UE capable of availing a NTN service or a UE supporting NTN technology or a UE capable of getting NTN services using technologies other than NTN technology or a UE capable of availing a NTN service which is deployed using a 3rd Generation Partnership Project (3GPP) Satellite or NTN system or a UE capable of availing a NTN service which is deployed using a NTN Network deployed using any 3GPP technology or a UE capable of availing a NTN service which is deployed using any proprietary NTN implementation outside the scope of 3GPP NTN system or a UE having a usage setting as a voice centric UE or a UE configured to send or to receive Attach Type as Combined International Mobile Subscriber Identity (IMSI) or a UE configured to send or to receive Attach Type as Combined IMSI with SMS only.

As used herein, the term “registration procedure” is associated with registration or camping of a UE in a 5G network.

As used herein, the term “attach procedure” is associated with registration or camping of a UE in a 4G network or Long-Term Evolution (LTE) network.

As used herein, the term “detach” is associated with de-registration or detaching of a UE in a 4G Network or an LTE network.

As used herein, the term “deregistration” is associated with de-registration or detaching of a UE in a 5G Network or a NR network.

As used herein, a “voice-centric user Equipment (UE)” may refer to a UE with support for voice services for e.g. IP Multimedia System (IMS) voice or any other voice services.

As used herein, “camping” or “registering” to a network or network cell may refer to the process by which a UE (for e.g. a mobile phone or tablet or the like) connects to a specific cellular network and becomes associated with that network. It may also refer to a procedure where the UE has completed the cell/Network selection/reselection process and has chosen a cell/Network from which it plans to receive all available services. It may also refer to a process of selecting a cell of the PLMN/Network and doing any necessary procedures (for e.g. Location Registration) to avail services from the Network.

As used herein, a “non-availability of a Terrestrial Network (TN) coverage at the location of the UE” may refer to a situation where there may be no terrestrial network available at the location of the UE or there may be terrestrial network(s) available in the location of the UE but those Terrestrial Network may not be suitable or allowable for the UE for getting normal services (for e.g. UE may not be able to get normal services (for e.g. full set of services such as Voice, Data, SMS etc.) from those terrestrial network. Those terrestrial networks may be a part of a forbidden list present in the UE). The UE may assume that the UE is in a location where Terrestrial Network coverage is not available

As used herein, a “presence of the UE in an NTN only coverage area” may refer to a situation where there may be only non-terrestrial network available at the location of the UE or there may be NTN available at the location of the UE and there may be terrestrial network(s) available in the location of the UE but those Terrestrial Network may not be suitable or allowable for the UE for getting normal services (for e.g. UE may not be able to get normal services (for e.g. full set of services such as Voice, Data, SMS etc.) from those terrestrial network.

As used herein, an “allowable network” for the UE may be those Network(s) which are not a part of any of the back-off network list or a forbidden network list or a temporary back-off/forbidden Network list of the UE. It may refer to a network on which UE is allowed to camp or register to get normal or full services.

As used herein, Packet Switching (PS) mode and Circuit Switching (CS) mode may refer to two different types of traffic modes that devices (or UEs) can use to access the network.

As used herein, the NI mode may refer to the standalone mode with a direct connection between the 5G Radio Access Network (RAN) and 5G Core Network (CN). In the NI mode, the NG interface is used between RAN and 5GCN.

As used herein, the S1 mode may be associated with the Evolved Packet System (EPS) and uses the 4G core network. In S1 mode, the 4G S1 interface is used between RAN and EPC.

As used herein, a “temporary forbidden PLMN list” may refer to a list of Public Land Mobile Networks (PLMNs) stored in the UE. The list indicates the PLMNs the UE is temporarily configured to avoid camping or registering. The list indicates the list of PLMN(s) which are not a part of allowable PLMN(s) of the UE. The UE may not be allowed to register or attach to the list of the PLMN(s) which are a part of “temporary forbidden PLMN list” for normal services.

As used herein, the back-off timer in the 3GPP standard may refer to a mechanism used to control the frequency of retransmissions in a wireless communication system. The back-off timer is mainly utilized to alleviate the overload of the Mobility Management Entity (MME) or AMF or a RAN entity (for e.g. g-NodeB or NG-RAN or eNodeB etc.) and to resolve congestion at the Serving Gateway (S-GW), or the SMF or the UPF or the Packet Data Gateway (P-GW).

As used herein, the Non-3GPP Inter-Working Function (N3IWF) interface in the 5G SBA (Service Based Architecture) may be responsible for interworking between untrusted non-3GPP networks and the 5G core. N3IWF facilitates seamless handover and uninterrupted connectivity for users when they transition between different network types.

As used herein, the Evolved Packet Data Gateway (ePDG) may be responsible for interworking between the Evolved Packet Core (EPC) and untrusted non-3GPP networks that require secure access, such as Wi-Fi, Long-Term Evolution (LTE) metro, and femtocell access networks.

The UE may determine that the UE is in NR/Evolved Universal Terrestrial Radio Access Network (E-UTRAN) Satellite Access Discontinuous Coverage, optionally for a selected PLMN or network, through at-least one of the below example methods:
a) Based on the start of the unavailability period and/or unavailability period duration determined by the UE, indicated by the network (e.g., by any network function such as AMF, Mobility Management Entity (MME) etc.) or negotiated between the UE and the network. For example—if the current time is after the start time and the unavailability period duration is not over, the UE may determine that the UE is in discontinuous coverage, optionally for the selected PLMN or network;
b) Based on the unavailability type, which indicates that the unavailability period is due to NR/E-UTRAN Satellite Access Network discontinuous coverage;
c) Based on any of the network broadcast parameters or messages or any network indication (such as SIB-19, SIB-32);
d) Based on UE determination.
e) Based on Satellite Coverage Availability Information (SCAI) provided to the UE by (Application Function) AF or the 5GC (Network Function) NF (like AMF/Policy Control Function (PCF)/Unified Data Management (UDM) or any other NF etc.) or any other entity such as SCAF (Satellite Coverage Availability Function).
f) Based on any other methods or indication

In an embodiment, the UE determines that the UE is in the discontinuous coverage of the network using at least one of: a broadcast parameter; a SIB parameter; a NAS signaling parameter; an AS signalling parameter; an information regarding configuration for NTN deployment as configured in the UE; an information regarding configuration for the NTN deployment as indicated by the network; an unavailability period duration and a start of unavailability period; an unavailability type; an indication for store and forward mode; a satellite coverage availability information (SCAI); a satellite ephemeris information; an information regarding configuration for the NTN deployment as configured in a SIM; an information regarding configuration for the NTN deployment as indicated by a server; an information regarding configuration for the NTN deployment as indicated by an application function; a database indicating details of a satellite or NTN cell, its location, its availability/unavailability time and its deployment details; a machine learning or an artificial intelligence based technique to predict or determine a network availability and unavailability status; and a data driven technique to predict or determine a Network availability and unavailability status.

A method as described in the disclosure, may include prior to transmitting the registration request or Attach Request or TAU request or any AS/NAS signaling message comprises:
receiving, by the UE, a satellite coverage availability information from an application function or from the Network; and
determining, by the UE, a value of the unavailability period duration and a value of the start of unavailability period based on the received satellite coverage availability information.

The methods, as described in this disclosure, may include receiving, by the network apparatus, unavailability information due to discontinuous coverage, when the UE initiates an AS/NAS signalling procedure.

In this disclosure, the unavailability information is at least one of: a start of unavailability period, an unavailability period duration and an unavailability type.

In a method, as described in this disclosure, the unavailability type is set to unavailability due to the discontinuous coverage.

In an embodiment, the method, as described in this disclosure, the unavailability type may be set to any value (for e.g. unavailability due to the discontinuous coverage or unavailability due to UE reasons).

In a method, as described in this disclosure, the unavailability information is sent in at least one of: a registration request procedure, a mobility registration update procedure, an attach procedure, a tracking area update and a service request procedure.

Discontinuous coverage indicates a duration of no service to the UEs followed by duration of service availability for the UEs. For e.g. UE may be in satellite coverage between 10 to 1, later at 1 UE may get into discontinuous coverage e.g. NO service. Again, after certain hours e.g. 3 hours UE may get the service back on satellite access. This because the satellite which was serving in the area may travel to next location and current location is not served by another satellite.

In Non Terrestrial Networks (NTN), Continuous satellite coverage can be characterized by Uu interface is available for the UE, at a given position for 100% of the time.

In Non Terrestrial Networks (NTN), Discontinuous satellite coverage can be characterized by Uu interface is available for the UE, at a given position, less than 100% of the time, due to predictable lack of satellite coverage. Due to Discontinuous coverage, the UE may have access to satellite service coverage only at specific time and places.

In Non Terrestrial Networks (NTN), discontinuous satellite coverage can be characterized by Uu interface is available for the UE, at a given position, less than 100% of the time, due to predictable lack of satellite coverage.

In the disclosure, NTN may correspond to an NTN system or several NTN cells. In an embodiment, wherein the NTN includes at least one of: Low Earth Orbit (LEO), Medium Earth Orbit (MEO), Geostationary Orbit (GEO), High Altitude Platform Systems (HAPS), Unmanned Aerial Vehicle (UAV), Unmanned Aircraft System (UAS), a network supported by an airborne vehicle, a Network deployed using the 3rd Generation Partnership Project (3GPP) Satellite or NTN system, a NTN Network deployed using at least one 3GPP technology (for e.g. a 3GPP based Satellite system or a NTN Network deployed using a LTE network etc) and a NTN Network deployed using at least one NTN implementation outside the scope of 3GPP NTN system (for e.g. a NTN deployed using an operator server or application etc) (for e.g. a NTN deployed using an operator server or application etc.). (for e.g. in some cases, the network operators or the satellite vendors are deploying NTN services using existing 3GPP Technologies (for e.g. using 3GPP RAT(s) such as LTE, e.g. deploying LTE-based Satellite system) to ease the deployment.). The network operators, in some cases, are deploying NTN services using existing 3GPP Technologies (for e.g. using 3GPP RAT(s) such as LTE, e.g. deploying LTE-based Satellite system) to ease the deployment.

The terms NTN, 3GPP based Satellite Network, Satellite 3GPP access, Satellite access, Satellite Access Network, NR Satellite Access Network, Satellite NG-RAN Access Technology, NR Satellite access, LTE Satellite Access Network, Satellite E-UTRAN Access Technology, and LTE Satellite access have been interchangeably used and have the same meaning.

In the disclosure, the UE may ignore the last registered network, or the UE may ignore the NTN, or the UE ignores the last registered PLMN during a network search procedure. In an embodiment, the UE ignores the last registered network, or the UE ignores the NTN, or the UE ignores the last registered PLMN if the selected network is same as the last registered network/PLMN and the last registered network/PLMN is an NTN. In an embodiment, the UE ignores the NTN if the selected network is an NTN during network search procedure.

The solutions stated in this disclosure are illustrated using RPLMN or the last registered Network. However, the same solutions are also applicable to RPLMN and/or its equivalent PLMN, Last registered Network or its equivalent Network, RPLMN and/or its equivalent PLMN over NTN or over Satellite access technology, RPLMN and/or its equivalent PLMN over any access technologies, RPLMN over NTN or over Satellite access technology, RPLMN over any access technologies, Last Registered Network over any access technologies, Last Registered Network over NTN or over Satellite access technology and the core principle remains the same.

There may be terrestrial network(s) available in those area, but those Terrestrial Network may not be suitable or allowable for the UE for getting normal services (for e.g. UE may not be able to get normal services (for e.g. full set of services such as Voice, Data, SMS etc) from those terrestrial network (for e.g. those terrestrial network may not have any partnership with the Network Operator or Home PLMN (HPLMN) of the UE and may not provide normal services to the UE). Those terrestrial network may be a part of a forbidden list present in the UE). The UE may assume that the UE is in a location where Terrestrial Network coverage is not available and only NTN coverage may be available in the location which may provide normal service to the UE (for e.g. normal service with only SMS or Data etc). The NTN may be deployed by the HPLMN or any of the partner network of the Network Operator/HPLMN of the UE.

As used herein, a “non-availability of a Terrestrial Network (TN) coverage at the location of the UE” may refer to a situation where there may be no terrestrial network available at the location of the UE or there may be terrestrial network(s) available in the location of the UE but those Terrestrial Network may not be suitable or allowable for the UE for getting normal services (for e.g. UE may not be able to get normal services (for e.g. full set of services such as Voice, Data, SMS etc) from those terrestrial network. Those terrestrial network may be a part of a forbidden list present in the UE). The UE may assume that the UE is in a location where Terrestrial Network coverage is not available.

A “presence of the UE in an NTN only coverage area” as used herein may refer to a situation where there may be only non-terrestrial network available at the location of the UE or there may be NTN available at the location of the UE and there may be terrestrial network(s) available in the location of the UE but those Terrestrial Network may not be suitable or allowable for the UE for getting normal services (for e.g. UE may not be able to get normal services (for e.g. full set of services such as Voice, Data, SMS etc) from those terrestrial network.

As used herein, an “allowable network” for the UE may be those Network(s) which are not a part of any of the back-off network list or a forbidden network list or a temporary back-off/forbidden Network list of the UE. It may refer to a network on which UE is allowed to camp or register to get normal or full services.

In the disclosure, NTN may correspond to an NTN system or several NTN cells. In an embodiment, wherein the NTN includes at least one of: Low Earth Orbit (LEO), Medium Earth Orbit (MEO), Geostationary Orbit (GEO), High Altitude Platform Systems (HAPS), Unmanned Aerial Vehicle (UAV), Unmanned Aircraft System (UAS), a network supported by an airborne vehicle, a Network deployed using the 3rd Generation Partnership Project (3GPP) Satellite or NTN system, a NTN Network deployed using at least one 3GPP technology (for e.g. a 3GPP based Satellite system or a NTN Network deployed using a LTE network etc.) and a NTN Network deployed using at least one NTN implementation outside the scope of 3GPP NTN system (for e.g. a NTN deployed using an operator server or application etc.) (for e.g. a NTN deployed using an operator server or application etc.). (for e.g. in some cases, the network operators or the satellite vendors are deploying NTN services using existing 3GPP Technologies (for e.g. using 3GPP RAT(s) such as LTE, e.g. deploying LTE-based Satellite system) to ease the deployment.).

The network operators, in some cases, are deploying NTN services using existing 3GPP Technologies (for e.g. using 3GPP RAT(s) such as LTE, e.g. deploying LTE-based Satellite system) to ease the deployment.

The terms NTN, 3GPP based Satellite Network, Satellite 3GPP access, Satellite access, Satellite Access Network, NR Satellite Access Network, Satellite NG-RAN Access Technology, NR Satellite access, LTE Satellite Access Network, Satellite E-UTRAN Access Technology, and LTE Satellite access have been interchangeably used and have the same meaning.

In the disclosure, the UE may ignore the last registered network, or the UE ignores the NTN, or the UE may ignore the last registered PLMN during a network search procedure. In an embodiment, the UE may ignore the last registered network, or the UE ignores the NTN, or the UE may ignore the last registered PLMN if the selected network is same as the last registered network/PLMN and the last registered network/PLMN is an NTN. In an embodiment, the UE may ignore the NTN if the selected network is an NTN during network search procedure.

Solutions stated in this disclosure are illustrated using RPLMN or the last registered Network. However, the same solutions are also applicable to RPLMN and/or its equivalent PLMN, Last registered Network or its equivalent Network, RPLMN and/or its equivalent PLMN over NTN or over Satellite access technology, RPLMN and/or its equivalent PLMN over any access technologies, RPLMN over NTN or over Satellite access technology, RPLMN over any access technologies, Last Registered Network over any access technologies, Last Registered Network over NTN or over Satellite access technology and the core principle remains the same.

In the disclosure, there may be terrestrial network(s) available in those area, but those Terrestrial Network may not be suitable or allowable for the UE for getting normal services (for e.g. UE may not be able to get normal services (for e.g. full set of services such as Voice, Data, SMS etc.) from those terrestrial network (for e.g. those terrestrial network may not have any partnership with the Network Operator or Home PLMN (HPLMN) of the UE and may not provide normal services to the UE). Those terrestrial network may be a part of a forbidden list present in the UE). The UE may assume that the UE is in a location where Terrestrial Network coverage is not available and only NTN coverage may be available in the location which may provide normal service to the UE (for e.g. normal service with only SMS or Data etc.). The NTN may be deployed by the HPLMN or any of the partner network of the Network Operator/HPLMN of the UE.

As used herein, a “non-availability of a Terrestrial Network (TN) coverage at the location of the UE” may refer to a situation where there may be no terrestrial network available at the location of the UE or there may be terrestrial network(s) available in the location of the UE but those Terrestrial Network may not be suitable or allowable for the UE for getting normal services (for e.g. UE may not be able to get normal services (for e.g. full set of services such as Voice, Data, SMS etc.) from those terrestrial network. Those terrestrial network may be a part of a forbidden list present in the UE). The UE may assume that the UE is in a location where Terrestrial Network coverage is not available.

As used herein, a “presence of the UE in an NTN only coverage area” may refer to a situation where there may be only non-terrestrial network available at the location of the UE or there may be NTN available at the location of the UE and there may be terrestrial network(s) available in the location of the UE but those Terrestrial Network may not be suitable or allowable for the UE for getting normal services (for e.g. UE may not be able to get normal services (for e.g. full set of services such as Voice, Data, SMS etc.) from those terrestrial network.

As used herein, an “allowable network” for the UE may be those Network(s) which are not a part of any of the back-off network list or a forbidden network list or a temporary back-off/forbidden Network list of the UE. It may refer to a network on which UE is allowed to camp or register to get normal or full services.

In the disclosure, the UE may identify the availability of an NTN using any of parameters or procedures in any order or combination: identify a Network deployed by the network operator using one or more of the NTN technology, identify one or more parameters associated with deploying the NTN technology, identify one or more information associated with deploying the NTN technology, perform the identification based on an agreement between a network operator, an NTN vendor, and the UE, determine the information of the Network (for e.g. Cell/Band/Frequency/RAT/PLMN/Access etc.) on which the NTN is deployed using an indication from the Network or an indication from any of the servers or an information configured or pre-configured in the UE, identify the deployment of the NTN technology on the basis of identification or determination or reception of one or more parameters by the UE 100. The one or more parameters may include a broadcast parameter, a System Information Block (SIB) parameter, a non-access stratum (NAS) signalling parameter, and an access stratum (AS) signalling parameters.

In the disclosure, the UE may identify the availability of an NTN based on the network parameters and network conditions for example:
a band used by an operator or a satellite vendor for deploying a satellite service or an NTN service.
a PLMN used by an operator or a satellite vendor for deploying a satellite service or an NTN service.
a frequency used by an operator or a satellite vendor for deploying a satellite service or an NTN service.
a RAT used by an operator or a satellite vendor for deploying a satellite service or an NTN service.
a network deployed using any of an NTN technology.
a network used by a satellite vendor for deploying a satellite service or an NTN service.

In the disclosure, the UE may identify the availability of an NTN on the basis of identification or reception of one or more information associated with deploying the NTN technology. The one or more information may comprise of:
an information regarding configuration for NTN deployment in the UE.
an information regarding configuration for NTN deployment as indicated by the network.
an information regarding configuration for NTN deployment as configured in a Subscriber Identity Module (SIM).
an information regarding configuration for NTN deployment as indicated by a server.
an information regarding configuration for NTN deployment as indicated by an application function.
an information from a database where the database contains information indicating details of a satellite or NTN cell, its location, its availability/unavailability time and its deployment details.
an information generated by a machine learning or an artificial intelligence model to predict or determine a network type.
an information acquired using a data driven technique to predict or determine a network type.

In the disclosure, the UE registered to the network is at least one of: the UE is registered to the TN; the UE is registered to the NTN; a UE is registered to a 3GPP network; and a UE is registered to a non-3GPP (N3GPP) network.

The list of satellite IDs, allowable list of satellite IDs, allowable Satellite IDs or list of allowable Satellite IDs are used interchangeably and have the same meaning.

The term NTN or NR/E-UTRAN Satellite Access Network as used in this embodiment may refer to any of the NR Satellite Access Network or E-UTRAN Satellite Access Network or NR Satellite Access Technology or E-UTRAN Satellite Access Technology.

In this disclosure, the term Satellite is used interchangeably with 5G or 4G system with satellite access and is used to represent any Satellite(s) or constellation of Satellites(s) or any aerial body/satellite in any of the Satellite orbits (for e.g., LEO/MEO/GEO/HEO etc.) or any 5G system with Satellite Access or 4G System with Satellite Access or any RAN Entity or Core Network Entity or any Network Function(s) associated with the Satellite Access/RAT/PLMN/Network.

The terms unavailability period duration, unavailability period, discontinuous coverage, discontinuous coverage period and unavailability duration are interchangeably used and have the same meaning.

The terms start time, start of unavailability period, start of unavailability duration, start of discontinuous coverage, start of discontinuous coverage period and start of unavailability period duration is interchangeably used and have the same meaning.

The terms support of/for “Unavailability Period” and “Unavailability Period Support” are used interchangeably and have the same meaning.

The terms NTN, 3GPP based Satellite Network, Satellite 3GPP access, Satellite access, Satellite Access Network, NR Satellite Access Network, Satellite NG-RAN Access Technology and NR Satellite access have been interchangeably used and have the same meaning.

In this disclosure, SIB19, SIB32 are given for examples and the parameters/indication from Network can be configured in any of the broadcast or signalling messages.

The terms select, camp, register, attach and Tracking area update (TAU) are interchangeably used in this embodiment and have the same meaning.

The terms UE, ME and MS are used interchangeably in this embodiment and have the same meaning.

The terms select, search and scan are used interchangeably in this embodiment and have the same meaning.

The solutions illustrated in this disclosure are illustrated using RPLMN or the last registered Network. However, the same solutions are also applicable to RPLMN and/or its equivalent PLMN, Last registered Network or its equivalent Network, RPLMN and/or its equivalent PLMN over any access technologies, RPLMN over any access technologies, Last Registered Network over any access technologies and the core principle remains the same.

In the disclosure, the UE may add the last selected or the registered Network (for e.g. PLMN or RAT or Cell or Band or Network any combination of these) to any temporary back-off Network List or forbidden Network List or any back-off list. The UE may not select or search or scan or deprioritize or ignore or scan with lowest priority the Network (for e.g. cell/PLMN/RAT/Access/Band/Network) present in this list.

In the disclosure, after the network search procedure, the UE may camp or attach or register on any of the selected available Network. The UE may prefer to camp or attach or register or trigger a TAU on TN before triggering a search or scanning for the NTN and optionally, camping or attaching or registering or triggering a TAU on TN.

In the disclosure, the solutions are explained by applying during Network Search procedure. However, the solutions are also applicable before or during or after the Network search procedure and the core principle remains the same.

In the disclosure, the UE performs the network search procedure, when the UE detects an event.

In the disclosure, the UE performs the network search procedure and selects the TN on at least one of: a terrestrial PLMN; a terrestrial RAT; a terrestrial access; a terrestrial system; a terrestrial RAN; a terrestrial band; a terrestrial frequency; a terrestrial cell; a terrestrial CN entity; a terrestrial network entity, a component of terrestrial network, a terrestrial network function, a network other than NTN; and a network other than satellite access network.

In the disclosure, the terms event, trigger event and trigger conditions are used interchangeably in this embodiment and have the same meaning.

In the disclosure, the UE may ignore the NTN on at least one of: a non-terrestrial PLMN; a non-terrestrial RAT; a non-terrestrial access; a non-terrestrial system; a non-terrestrial RAN; a non-terrestrial band; a non-terrestrial frequency; a non-terrestrial cell; a non-terrestrial CN entity; a non-terrestrial network function, a non-terrestrial CN entity, a component of a non-terrestrial network a network other than TN; and a network on satellite access network.

In the disclosure, solutions are explained using Higher Priority PLMN Search timer expiry as an example. However, the solutions are applicable to any trigger conditions, for e.g. at least one of: an expiry of a timer for higher priority PLMN search procedure, a handover procedure, a redirection procedure, a reselection procedure, an expiry of a timer for Better System Reselection (BSR), an expiry of an operator defined timer, a background network search procedure, an idle mode procedure, a connected mode procedure and a network release procedure. The events may also include scenarios where the UE need to trigger or perform a Network Search or selection or scanning procedure, a PLMN Search or selection or scanning procedure, a Cell search or selection or scanning procedure or a RAT/Access Search or selection or scanning procedure.

In the disclosure, the event or trigger event includes at least one of: a switch off the UE, a switch on the UE, a recovery of the UE from lack of a coverage area, a recovery of the UE from an OOS area, a SIM insertion in the UE, a SIM re-insertion post removal in the UE, a SIM removal in the UE, a disabling of the SIM in the UE, an enabling of the SIM in the UE, a modem reset, a power cycle, a modem power up, a modem power cycle, an airplane mode on in the UE, an airplane mode off in the UE, a UE exiting airplane mode, a UE entering airplane mode, a modem exiting airplane mode, an activation of the UE, a reject cause from the network, a detach triggered by the network, a deregistration triggered by the network, on entering store and forward mode in the UE, on exiting store and forward mode in the UE, on entering store and forward mode from the network, on exiting store and forward mode from the network, a detach triggered by the UE, a deregistration triggered by the UE, a network mode change in the UE, a network selection mode change in the UE, an operating mode change in the UE, on entering satellite mode in the UE, on exiting satellite mode in the UE, a turning on of a modem, and a SIM refresh procedure. These events may also be referred to as “trigger conditions” in this embodiment. The events may also include scenarios where the UE need to trigger or perform a Network Search or selection or scanning procedure, a PLMN Search or selection or scanning procedure, a Cell search or selection or scanning procedure or a RAT/Access Search or selection or scanning procedure.

As used herein, the term “registration procedure” is associated with registration or camping of a UE in a 5G network.

As used herein, the term “attach procedure” is associated with registration or camping of a UE in a 4G network or Long-Term Evolution (LTE) network.

As used herein, the term “detach” is associated with de-registration or detaching of a UE in a 4G Network or an LTE network.

As used herein, the term “deregistration” is associated with de-registration or detaching of a UE in a 5G Network or a NR network.

As used herein, “camping” or “registering” to a network or network cell may refer to the process by which a UE (such as for e.g. a mobile phone or tablet or the like) connects to a specific cellular network and becomes associated with that network. It may also refer to a procedure where the UE has completed the cell/Network selection/reselection process and has chosen a cell/Network from which it plans to receive all available services. It may also refer to a process of selecting a cell of the PLMN/Network and doing any necessary procedures (for e.g. Location Registration) to avail services from the Network.

The term Network as used in this disclosure may refer to any PLMN, RAT, Access, Access Technology, Cell, Satellite or any combination of these.

As used herein, the term “network” may refer to one or more of a Public Land Mobile Network (PLMN) or a Radio Access Technology (RAT) or an access or a system or a Radio Access Network (RAN) or a band or a frequency or a cell or a Network entity or a Core Network (CN) entity or a Network function or any Terrestrial Network or any Non-Terrestrial Network or any component of the network.

The disclosure may used PLMN selection or Network search as an example, but it can refer to any of the Network Selection or Search procedures (for e.g. Cell Selection/Search, RAT selection/search, PLMN Selection/Search etc.).

The disclosure may be illustrated using 5G or LTE as an example. It could be any applicable for any RAT(s)/Access, but the core principles remain the same.

The disclosure may be illustrated using one of cell(s), RAT(s), PLMN(s) and Access(es) as an example. It could be applicable for any Network or Network Entity and the core principle remains the same.

The disclosure may be explained using NR access or NG-RAN Access Technology as an example and is not restricted or limited to NR access only. However, the solutions disclosed herein are also applicable for E-UTRAN access Technology, NB (Narrow Band)-S1 mode or WB (Wide Band)-S1 mode via E-UTRAN access and/or NB-IoT (Narrowband Internet of Things) or WB-IOT (WideBand Internet of Things) Access/Architecture.

The solutions for NR (5GC) are also applicable to legacy RATs like E-UTRA/LTE, the corresponding CN entities need to be replaced by LTE entities for e.g. AMF with MME, g-nodeB with e-nodeB, UDM with HSS etc. But principles of the solution remain same. In the similar way, the solutions or proposal which are defined for LTE (EPC) are also applicable to other RAT(s) (for e.g., 5G or 5GC and other RATs).

The Network used in this disclosure may be explained using any 5G Core Network Function for e.g. AMF. However, the network could be any 5G/EUTRAN Core Network Entities like AMF/SMF/MME/UPF/UDM, or the Network could be any 5G/EUTRAN RAN Entity like eNodeB (eNB) or gNodeB (gNB) or NG-RAN etc.

The 3GPP Technical document and references and the version number given in this embodiment are for reference/example and may be present in or refer to any of the 3GPP Technical documents or references.

The messages used or indicated in this embodiment are shown as an example. The messages could be any signaling messages between UE and the Network Functions/Entities or between different Network functions/entities.

The Network used in this embodiment is explained using any 5G Core Network Function for e.g. AMF. However, the network could be any 5G/EUTRAN Core Network Entities like AMF/SMF/MME/UPF/S-GW/P-GW/UDM/HSS, or the Network could be any 5G/EUTRAN RAN Entity like eNodeB (eNB) or gNodeB (gNB) or NG-RAN etc.

The solutions and procedures which are defined for NR (5GC) are also applicable to legacy RATs like E-UTRA/LTE, the corresponding 5G CN entities needs to be replaced by LTE entities for e.g. AMF with MME, g-nodeB with e-nodeB, UDM with HSS etc. Similarly, the corresponding 5G procedures needs to be replaced by LTE procedures for e.g. Registration procedure with Attach Procedure, Registration procedure for mobility registration updating with TAU procedure, Deregistration Procedure with Detach procedure and so on. But principles of the solution remain same.

The solutions which are defined for LTE (EPC) are also applicable to other RATs like NR/NG-RAN/5GC, the corresponding CN entities needs to be replaced by NR entities for e.g. MME with AMF, e-nodeB with g-nodeB, HSS with UDM etc. But principles of the solution remain same. Similarly, the corresponding LTE procedures needs to be replaced by NR procedures for e.g. Attach/TAU procedure with Registration Procedure/Registration procedure for mobility registration updating, Detach Procedure with Deregistration procedure and so on. But principles of the solution remain same.

The cause names in this disclosure are for illustration purpose and it can have any name. The non access stratum (NAS) messages and access stratum (AS) messages described in this embodiment is only for illustration purpose it can be any NAS or AS messages as per defined protocol between UE and AMF/MME or UE and gNB (NG-RAN/any RAN node)/eNB.

The disclosure may be illustrated using 5G or LTE as an example. It could be any applicable for any RAT(s)/Access, but the core principles remain the same.

As used herein, a “temporary forbidden PLMN list” may refer to a list of Public Land Mobile Networks (PLMNs) stored in the UE. The list indicates the PLMNs the UE is temporarily configured to avoid camping or registering. The list indicates the list of PLMN(s) which are not a part of allowable PLMN(s) of the UE. The UE may not be allowed to register or attach to the list of the PLMN(s) which are a part of “temporary forbidden PLMN list” for normal services.

As used herein, the back-off timer in the 3GPP standard is a mechanism used to control the frequency of retransmissions in a wireless communication system. The back-off timer is mainly utilized to alleviate the overload of the Mobility Management Entity (MME) or AMF or a RAN entity (for e.g. g-NodeB or NG-RAN or eNodeB etc.) and to resolve congestion at the Serving Gateway (S-GW), or the SMF or the UPF or/and the Packet Data Gateway (P-GW).

In the disclosure, the device may add the selected or the registered Network (for e.g. PLMN or RAT or Cell or any combination of these to any temporary back-off Network List or forbidden Network List or any back-off list) which may lead to delay in the acquisition of available NTN services.

As used herein, an “allowable network” for the UE may refer to those Network(s) which are not a part of any of the back-off network list or a forbidden network list or a temporary back-off/forbidden Network list of the UE. It may refer to a network on which UE is allowed to camp or register to get normal or full services.

Acceptable Cell/Network: Acceptable cell/Network is the cell/Network that is not enough to be a suitable cell/Network but meets the minimum condition at least to make an emergency call. The minimum conditions are:
a. The cell/Network is not barred.
b. The cell/Network selection criteria are met.

Suitable Cell/Network: The cell/Network that the UE may camp on for a normal service. The E-UTRA and UTRA Suitable Cell/Network criteria is defined in 3GPP TS 36.304 and NR Suitable Cell/Network criteria is defined in 3GPP TS 38.304.

As used herein, the Non-3GPP Inter-Working Function (N3IWF) interface in the 5G SBA (Service Based Architecture) is responsible for interworking between untrusted non-3GPP networks and the 5G core. N3IWF facilitates seamless handover and uninterrupted connectivity for users when they transition between different network types.

As used herein, the Evolved Packet Data Gateway (ePDG) is responsible for interworking between the Evolved Packet Core (EPC) and untrusted non-3GPP networks that require secure access, such as Wi-Fi, Long-Term Evolution (LTE) metro, and femtocell access networks.

In an embodiment, the UE determines the Last Registered Network using at least one of: one or more of a value or a file or a configuration or an information configured or stored in the UE (for e.g. a Last registered Network value derived or stored in the UE or a last registered PLMN value (for e.g. RPLMN) stored or derived in the UE), one or more of a value or a file or a configuration or an information configured or stored in the SIM, one or more of a value or a file or a configuration or an information configured by the network, one or more of a value or a file or a configuration or an information configured by the server, one or more of a value or a file or a configuration or an information configured by an application function, a value configured in the SIM, a value stored in or derived from one or more of a EF_EPSLOCI file or a EF_LOCI file or a EF_PSLOCI file or a EF5GS3GPPLOCI file (or any other file or value stored or derived from) in the SIM (for e.g. the value stored in the above file may refer to some other value from which UE can derive the value of the RPLMN or the last registered network), a value stored in the non-volatile memory of the device and a file stored in the SIM

As used herein, the term “network” may refer to one or more of a Public Land Mobile Network (PLMN) or a Radio Access Technology (RAT) or an access or a system or a Radio Access Network (RAN) or a band or a frequency or a cell or a Network entity or a Network function or any Terrestrial Network or any Non-Terrestrial Network or any component of the network.

As used herein, the term “Non-Terrestrial Network (NTN)” may refer to one or more of a non-terrestrial PLMN or a non-terrestrial RAT or a non-terrestrial access or a non-terrestrial system or a non-terrestrial RAN or a non-terrestrial band or a non-terrestrial frequency or a non-terrestrial cell or a non-terrestrial Network entity or a non-terrestrial CN entity or a non-terrestrial network function or a component of a non-terrestrial network or a network other than TN or a network on Satellite Access Network.

As used herein, the term “Terrestrial Network (TN)” may refer to one or more of a terrestrial PLMN or a terrestrial RAT or a terrestrial access or a terrestrial system or a terrestrial RAN or a terrestrial band or a terrestrial frequency or a terrestrial cell or a terrestrial Network entity or a terrestrial CN entity or a terrestrial network entity or a component of terrestrial network or a terrestrial network function or a terrestrial network function or a component of a terrestrial network or a Network other than NTN or a network other than Satellite Access Network.

As used herein, the term “User Equipment (UE)” may refer to one or more of an NTN-capable UE or a UE capable of availing a NTN service or a UE supporting NTN technology or a UE capable of getting NTN services using technologies other than NTN technology or a UE capable of availing a NTN service which is deployed using a 3rd Generation Partnership Project (3GPP) Satellite or NTN system or a UE capable of availing a service which is deployed using a 3GPP system or a UE capable of availing a NTN service which is deployed using a NTN Network deployed using any 3GPP technology or a UE capable of availing a NTN service which is deployed using any proprietary NTN implementation outside the scope of 3GPP NTN system or a UE having a usage setting as a voice centric UE or a UE configured to send or to receive Attach Type as Combined International Mobile Subscriber Identity (IMSI) or a UE configured to send or to receive Attach Type as Combined IMSI with SMS only.

As used herein, “camping” or “registering” to a network or network cell refers to the process by which a UE (for e.g. a mobile phone or tablet or the like) connects to a specific cellular network and becomes associated with that network. It may also refer to a procedure where the UE has completed the cell/Network selection/reselection process and has chosen a cell/Network from which it plans to receive all available services. It may also refer to a process of selecting a cell of the PLMN/Network and doing any necessary procedures (for e.g. Location Registration) to avail itself of services from the Network.

As used herein, the NI mode refers to the standalone mode with a direct connection between the 5G Radio Access Network (RAN) and 5G Core Network (CN). In the NI mode, the NG interface is used between RAN and 5GCN.

As used herein, the S1 mode is associated with the Evolved Packet System (EPS) and uses the 4G core network. In S1 mode, the 4G S1 interface is used between RAN and EPC.

The disclosure may refer to using PLMN selection or Network search as an example, but it can refer to any of the Network Selection or Search procedures (for e.g. Cell Selection/Search, RAT selection/search, PLMN Selection/Search etc.).

The terms searching, scanning, selecting, registering, attaching, initiating Tracking Area Update (TAU) and camping have been used interchangeably and have same meaning.

As used herein, Packet Switching (PS) mode and Circuit Switching (CS) mode are the two different types of traffic modes that devices (or UEs) can use to access the network. For a 5G system with satellite access, the following requirements apply: the 5G system shall support service continuity between NR terrestrial access network and NR satellite access networks owned by the same operator or owned by 2 different operators having an agreement.

The NTN and TN could either operate in two different frequency bands (e.g. FR1 vs FR2), or in same frequency band (e.g. FR1 or FR2).

The terms Satellite 3GPP access, Satellite access, Satellite Access Network, NR Satellite Access Network, Satellite NG-RAN Access Technology and NR Satellite access have been interchangeably used and have the same meaning.

The disclosure may be explained using NR satellite access or Satellite NG-RAN Access Technology as an example and is not restricted or limited to NR Satellite access only. However, the solutions disclosed herein are also applicable for Satellite E-UTRAN access Technology, NB (Narrow Band)-S1 mode or WB (Wide Band)-S1 mode via satellite E-UTRAN access and/or NB-IOT (NarrowBand Internet of Things) or WB-IoT (WideBand Internet of Things) Satellite Access/Architecture.

The solutions for NR (5GC) are also applicable to legacy RATs like E-UTRA/LTE, the corresponding CN entities need to be replaced by LTE entities for e.g. AMF with MME, g-nodeB with e-nodeB, UDM with HSS etc. But principles of the solution remain same.

An example list of NAS messages can be, but not limited to, REGISTRATION REQUEST message; DEREGISTRATION REQUEST message; SERVICE REQUEST message; CONTROL PLANE SERVICE REQUEST; IDENTITY REQUEST; AUTHENTICATION REQUEST; AUTHENTICATION RESULT; AUTHENTICATION REJECT; REGISTRATION REJECT; DEREGISTRATION ACCEPT; SERVICE REJECT; SERVICE ACCEPT, and so on.

The Network used in this disclosure may be explained using any 5G Core Network Function for e.g. AMF. However, the network could be any 5G/EUTRAN Core Network Entities like AMF/SMF/MME/UPF, or the Network could be any 5G/EUTRAN RAN Entity like eNodeB (eNB) or gNodeB (gNB) or NG-RAN etc.

The messages used or indicated in this disclosure are shown as an example. The messages could be any signaling messages between UE and the Network Functions/Entities or between different Network functions/entities.

The term area/location/geographical area are used in this embodiment may refer to any of cell/cell ID, TAC/TAI, PLMN, MCC/MNC, Latitude/longitude, CAG cell or any geographical location/coordinate.

The terms UE and MS are used interchangeably in this disclosure and have the same meaning.

The disclosure is applicable to any (but not limited to) of the RAT(s) as defined in this disclosure.

The Network used in this disclosure could be any 5G/EUTRAN Core Network Entities like AMF/SMF/MME/UPF or the Network could be any (but not limited to) 5G/EUTRAN RAN Entity like eNodeB (eNB) or gNodeB (gNB) or NG-RAN etc.

The disclosure may be explained using NR access or NG-RAN Access Technology as an example and is not restricted or limited to NR access only. However, the solutions disclosed herein are also applicable for E-UTRAN access Technology, NB (Narrow Band)-S1 mode or WB (Wide Band)-S1 mode via E-UTRAN access and/or NB-IoT (NarrowBand Internet of Things) or WB-IOT (WideBand Internet of Things) Access/Architecture.

The solutions for NR (5GC) are also applicable to legacy RATs like E-UTRA/LTE, the corresponding CN entities need to be replaced by LTE entities for e.g. AMF with MME, g-nodeB with e-nodeB, UDM with HSS etc. But principles of the solution remain same.

The Network used in this disclosure may be explained using any 5G Core Network Function for e.g. AMF. However, the network could be any 5G/EUTRAN Core Network Entities like AMF/SMF/MME/UPF, or the Network could be any 5G/EUTRAN RAN Entity like eNodeB (eNB) or gNodeB (gNB) or NG-RAN etc.

The messages used or indicated in this disclosure are shown as an example. The messages could be any signaling messages between UE and the Network Functions/Entities or between different Network functions/entities.

The terms camp and register are used interchangeably and have the same meaning.

The terms wait timer, DisCo wait timer, Discontinuous Coverage wait timer, Random timer, Random wait timer, DCW Timer are all used interchangeably and have the same meaning.

The term disable the SIM(s) in this disclosure may refer, for example, to the UE not enabling any network scanning on that SIM(s) (for e.g., by either disabling the SIM Card operations completely, or by adding the current/available network(s) on that SIM Card(s) to a temporary forbidden network list (for e.g. temporary forbidden PLMN list), or by not scanning any allowable network(s) on that SIM Card(s)).

The term enable the SIM(s) in this embodiment may refer, for example to the UE enabling any network scanning on that SIM(s) (for e.g., by either enabling the SIM Card operations, or by removing the current/available network(s) on that SIM Card(s) from a temporary forbidden network list (for e.g. temporary forbidden PLMN list), or by scanning any allowable network(s) on that SIM Card(s)).

The terms wait range, Disco Wait Range, Discontinuous Coverage Wait Range, DCW Range are all used interchangeably and have the same meaning.

The term area as used in this embodiment may refer to any of cell/cell ID, TAC/TAI, PLMN, MCC/MNC, Latitude/longitude, any CAG/CAG identifier or any geographical location/coordinate.

For the list of possible NAS messages please refer to 3GPP TS 24.501 or 3GPP TS 24.301, for list of AS messages please refer to 3GPP TS 38.331 or 3GPP TS 36.331.

The cause names in this disclosure are for illustration purpose and it can have any name. The non access stratum (NAS) messages and access stratum (AS) messages described in this embodiment are only for illustration purpose it can be any NAS or AS messages as per defined protocol between UE and AMF/MME or UE and gNB (NG-RAN/any RAN node)/eNB.

The terms default configuration, primary sim and default sim are interchangeably used in this embodiment and have the same meaning.

The disclosure may be explained to happen when a service is initiated or ongoing. However, the methods and solutions are also applicable before or during or after or without an initiation of a service. For e.g. switching by the UE one or more of a default configuration of at least one service or facilitating of at least one service can happen one or more of: before or during or after or without an initiation of a service on a first sim card.

The disclosure may be explained using discontinuous coverage on one of the SIM Card(s) as a trigger point. However, the methods and solutions are also applicable when one or more of the service(s) (for e.g. Call, messaging, emergency, data, application usage or any other service) is/are not supported on one or more of the SIM Card(s) (for e.g. due to any of the reasons for e.g. the SIM Card not in service, network not supporting that feature or service, UE not supporting that feature or service on the current/default SIM Card or any other reasons) and as per the methods and solutions enclosed in this embodiment, the UE automatically switches or sets the default configuration of those features or service on a SIM Card(s) which is available and supports that feature or service. For e.g. if emergency service (for e.g. emergency call) is not supported in the current SIM Card or the default SIM Card for calling services (for e.g. first SIM Card), the emergency service is automatically set or switched to a SIM Card (for e.g. Second SIM Card) which is available and can support emergency service (for e.g. emergency calls). For e.g. when a user dials an emergency call using a SIM Card (for e.g. first SIM Card) which doesn't support emergency service, the call is automatically dialed using another SIM card (for e.g. second SIM Card), if available, if it can support emergency service.

The terms feature and service are used interchangeably and have the same meaning.

As per 3GPP Specification document TR 23.700-28, discontinuous satellite coverage for satellite access is characterized by the fact that air interface (Uu interface, for e.g., Long Term Evolution (LTE) uu or New Radio (NR) uu interface) (between 4G/5G UE and 4G/5G-RAN (Radio Access Network)) is available for the User Equipment (UE) less than 100% of the time, due to predictable patterns of satellite coverage availability. For example, a UE using a Next Generation (NG)-RAN that provides discontinuous coverage (e.g., for satellite access with discontinuous coverage), the UE may be out of network coverage at a certain time and may be in coverage at a different time period. Further, in yet another example from mobility management perspective, the UE may have to remain with no service, or it has to attempt to register on available different Radio Access technology (RAT's)/Public Land Mobile Network (PLMNs) to receive the normal service during discontinuous coverage in current NTN RAT.

In 3GPP Specification document TS 23.501, Section 5.4.13, the provisions for support of discontinuous network coverage for satellite access have been newly introduced which covers the mobility management, satellite coverage availability information provisioning, paging and overload control aspects of discontinuous satellite coverage. New information such as satellite coverage availability information, unavailability period duration, unavailability period support, start of unavailability period, etc. have been introduced in Rel-18 pertaining to satellite coverage information which helps UE to determine and indicate the period of discontinuous coverage while availing NTN Satellite services.

For Dual SIM devices, it is possible that the Default/Designated Data Service/Subscription (DDS) Subscriber Identity Module (SIM) for default calling or default messaging is camped to 4G/5G service under NTN satellite coverage of one operator and the non-DDS SIM/non-default calling/messaging SIM is camped to 4G/5G service under terrestrial/NTN satellite coverage of a different operator. Similarly, it is very much possible that the DDS/default calling SIM which was initially camped to 4G/5G service under NTN satellite coverage might be out of network coverage for a certain duration (due to discontinuous coverage of satellite access) due to the predictable movement of the satellites. Due to this discontinuous NTN coverage on the DDS/default calling/messaging SIM, the user services which was just initiated/ongoing on the default SIM prior to satellite coverage loss such as voice call, data service, emergency call service etc. will get interrupted, leading to unsatisfactory user experience.

During this discontinuous NTN service period on the DDS/default calling SIM, the UE may either have to remain in no service or it may attempt to search and register on any other available different RAT's/PLMNs to receive the normal service which would take some time and user won't be able to use any service. However, during the same time period, the other SIM (non-DDS/non-default calling SIM) might be in coverage (any TN or NTN coverage) and may be able to provide normal services (data/calling/emergency services, etc.) to the user without any interruption. Currently, there is no provision for the UE to pre-determine or pre-empt the loss of service accurately and switch/set the default services to a SIM Card which can provide normal services to ensure uninterrupted continuation of user services (voice call, emergency call, file download, messaging) in the event of discontinuous satellite coverage on the DDS/default calling SIM even when other SIM Card is able to provide services.

Further, in the current UE implementation, the user service (Call/Emergency call, Data service, File download, Messaging etc.) ongoing/initiated on the DDS/Default Calling SIM is interrupted/failed in the event of out-of-coverage encountered during discontinuous satellite coverage period and the user may not get services (Data/Calling services) from the primary SIM and may have to manually switch the DDS or Default Calling option to other SIM Card (Secondary SIM) to get Data/Calling services leading to a poor user experience.

The journey of incorporation of non-terrestrial networks (NTNs) started with 3GPP launching a Release (Rel.) 15 study (3GPP Specification Document TR 38.811) on channel models and deployment scenarios. After completing this study, 3GPP followed up with a Release 16 study (3GPP Specification Document TR 38.821) on solutions for adapting 5G NR to support NTNs. Further, Rel. 17 prioritizes standalone deployment, applying transparent bent-pipe satellite architecture and assuming the user equipment (UE) possesses GNSS capabilities (not simultaneous operation) to pre-compensate time and frequency.

An NTN positions elements of the network infrastructure overhead in the form of Satellites, HAPS (High Altitude Platform Stations) or Drones (Unmanned Aircraft Systems). This offers a number of advantages including extending coverage to locations without any terrestrial coverage, supporting mission critical communications and providing reliability and resilience to network connection. With the current evolution of NTNs, two major directions have become apparent, e.g., 5G NR enhancements incorporate non-terrestrial communications within the 5G system and the extension of Internet of Things (IoT), or massive machine-type communications (mMTC) by non-terrestrial connectivity.

As per Rel-18 3GPP Specification Document TR 23.700-28, discontinuous satellite coverage for satellite access is characterized by the fact that Uu interface (e.g., the interface between 4G/5G UE and 4G/5G-RAN) is available for the UE less than 100% of the time, due to predictable patterns of satellite coverage. For a UE using a NG-RAN that provides discontinuous coverage (e.g. for satellite access with discontinuous coverage), the UE may be out of network coverage at a certain predictable time period. The UE may then attempt to scan for available cells due to the UL traffic or NAS layer signaling, e.g., Periodic Registration. Similarly, for a 4G UE, in Rel-18, Tracking Area and therefore RAT specific MME configuration has been introduced in order to allow support for discontinuous coverage for satellite access in EPS. The UE in EPS may deactivate the access stratum when there is no network coverage or scan for alternate PLMN/RAT services.

For a UE in discontinuous NTN coverage, the UE may have to remain with no service, or it has to attempt to register on available different RAT's/PLMNs to receive the normal service during discontinuous coverage in current NTN RAT. There may be a period of normal NTN service followed by a period of discontinuous NTN coverage where the UE might have to either stay in No Service or search for alternate RAT/PLMNs if available.

In the case of discontinuous coverage, satellite provides coverage to one part of area (for e.g., Area 1) at time T1 and revisits that area after some duration (for e.g., T1+X mins/hours). In between (e.g., between Time period T1 and T1+X mins/hours e.g., T2), the UE will be unable to acquire/get NTN coverage in that area (Area 1) e.g., UE will be in discontinuous NTN coverage. Let ‘X’ indicate the time duration after which satellite revisits the same coverage area. UE would acquire service on satellite cell for a certain time duration (T1) followed by which satellite coverage would no longer be available for certain duration due to discontinuous coverage. This would lead to any ongoing service interruption on the SIM for which NTN coverage was initially present and is now in discontinuous coverage. During this discontinuous satellite coverage duration (T2), UE would be in no service in the satellite cell and would try to search and camp on other RAT/PLMNs, if available, by performing PLMN search until it finds suitable TN/NTN cell to acquire service. If no suitable cell is found, the UE will keep performing continuous PLMN search in order to find suitable TN/NTN cell to register for normal service. Since there might not be any TN/Other NTN cell available in remote areas, UE would remain in No-Service and these periodic PLMN searches might not yield any result. The UE may not get any services from this SIM, which was camped on NTN services, for the duration of discontinuous coverage until Satellite coverage resumes.

In Rel-18 3GPP Specification Document TS 23.501, Section 5.4.13, the provisions for support of discontinuous network coverage for satellite access has been newly introduced which covers the mobility management, power saving optimization, satellite coverage availability information provisioning, paging and overload control aspects of discontinuous satellite coverage. Some terminology has been newly introduced in 3GPP Specification Document TS 23.501 pertaining to satellite coverage information and discontinuous coverage support: Discontinuous coverage support, Satellite coverage availability information, UE out-of-coverage period/Unavailability Period Duration, Satellite coverage availability information, UE out-of-coverage period/Unavailability Period Duration, Unavailability Period Support, Start of Unavailability Period, Notification of Leaving Coverage, and the like.

Discontinuous coverage support: During Registration procedure, a UE supporting Discontinuous coverage functionalities provides “discontinuous coverage support” indication as part of 5GMM Core Network Capability in the Registration Request message for initial registration and for every mobility registration. The AMF indicates whether Discontinuous coverage functionalities are supported by providing the “discontinuous coverage support” indication in Registration Accept message.

Satellite coverage availability information: This refers to location and time information related to expected coverage availability of satellite/satellite constellation that provides discontinuous coverage.

UE out-of-coverage period/Unavailability Period Duration: The time period that UE is assumed to be out of coverage in case of NR satellite access that provides discontinuous coverage, based on satellite coverage availability information. This indicates the timing information for when a UE is expected to be out of coverage, and when the UE is expected to re-gain coverage again. The UE out-of-coverage period may consider current and expected future locations of the UE.

Unavailability Period Support: During Registration procedure, the UE supporting the Unavailability Period feature provides “Unavailability Period Support” indication as part of 5GMM Core Network Capability in Registration Request message for initial registration and for every mobility registration. The AMF indicates whether the corresponding feature is supported in the AMF by providing the “Unavailability Period Supported” indication in Registration Accept message.

Start of Unavailability Period: Before the start of an event that makes the UE unavailable due to discontinuous satellite coverage, the UE includes optionally the Start of the Unavailability Period and the Unavailability Period Duration and triggers either Mobility Registration Update or UE initiated Deregistration procedure.

Notification of Leaving Coverage: If the UE and network have indicated support for discontinuous coverage reporting and the UE is about to lose coverage and cannot determine the out-of-coverage period, the UE shall include a Notification of Leaving Coverage if a Notification of Leaving Coverage Request was received from the AMF. If a Notification of Leaving Coverage Request was not received from the AMF, the UE may include the Notification of Leaving Coverage. The AMF shall consider the UE as unreachable until the UE enters CM-CONNECTED state.

UE to (R)AN: AN message (AN parameters, Registration Request (Registration type, SUCI or 5G-GUTI or PEI, [last visited TAI (if available)], Security parameters, [Requested NSSAI], [Mapping Of Requested NSSAI], [Default Configured NSSAI Indication], [UE Radio Capability Update], [UE MM Core Network Capability], [PDU Session status], [List Of PDU Sessions To Be Activated], [Follow-on request], [MICO mode preference], [Requested Active Time], [Requested DRX parameters for E-UTRA and NR], [Requested DRX parameters for NB-IoT], [extended idle mode DRX parameters], [LADN DNN(s) or Indicator Of Requesting LADN Information], [NAS message container], [Support for restriction of use of Enhanced Coverage], [Preferred Network Behaviour], [UE paging probability information], [Paging Subgrouping Support Indication], [UE Policy Container (the list of PSIs, indication of UE support for ANDSP, the operating system identifier, Indication of URSP Provisioning Support in EPS, UE capability of supporting to report URSP rule enforcement to network)] and [UE Radio Capability ID], [Release Request indication], [Paging Restriction Information], PEI, [PLMN with Disaster Condition], [Requested Periodic Update time], [Unavailability Period Duration], [Start of Unavailability Period], [Unavailability Type])).

AMF provides start of unavailability period and Unavailability Period Duration to the UE in Registration Accept: New AMF to UE: Registration Accept (5G-GUTI, Registration Area, [Mobility restrictions], [PDU Session status], [Allowed NSSAI], [Mapping Of Allowed NSSAI], [Configured NSSAI for the Serving PLMN], [Mapping Of Configured NSSAI], [NSSRG Information], [NSAG Information], [rejected S-NSSAIs], [Pending NSSAI], [Mapping Of Pending NSSAI], [Periodic Registration Update timer], [Active Time], [Strictly Periodic Registration Timer Indication], [LADN Information], [accepted MICO mode], [IMS Voice over PS session supported Indication], [Emergency Service Support indicator], [Accepted DRX parameters for E-UTRA and NR], [Accepted DRX parameters for NB-IoT], [extended idle mode DRX parameters], [Paging Time Window], [Network support of Interworking without N26], [Access Stratum Connection Establishment NSSAI Inclusion Mode], [Network Slicing Subscription Change Indication], [Operator-defined access category definitions], [List of equivalent PLMNs], [Enhanced Coverage Restricted information], [Supported Network Behaviour], [Service Gap Time], [PLMN-assigned UE Radio Capability ID], [PLMN-assigned UE Radio Capability ID deletion], [WUS Assistance Information], [AMF PEIPS Assistance Information], [Truncated 5G-S-TMSI Configuration], [Connection Release Supported], [Paging Cause Indication for Voice Service Supported], [Paging Restriction Supported], [Reject Paging Request Supported], [Paging Restriction Information acceptance/rejection], [“List of PLMN(s) to be used in Disaster Condition”], [Disaster Roaming wait range information], [Disaster Return wait range information], [Forbidden TAI(s)], [List of equivalent SNPNs], [Registered NID], [Unavailability Period Support], [Discontinuous Coverage Supported], [Return To Coverage Notification Not Required], [Unavailability Period Duration], [Start of Unavailability Period]).

For Dual SIM devices, it is possible that the Default/Designated Data Service/Subscription (DDS) SIM (e.g., for default Data usage) and/or the Default Calling/Messaging SIM (e.g., for default calling/messaging usage) is camped to 4G/5G service under NTN satellite coverage and the non-DDS/non-default calling/messaging SIM is camped to 4G/5G service under terrestrial/NTN satellite coverage of a different operator. As per Rel-18 3GPP Specification document TR 23.700-28, discontinuous satellite coverage for satellite access is characterized by the fact that Uu interface (between 4G/5G UE and 4G/5G-RAN) is available for the UE less than 100% of the time, due to predictable patterns of satellite coverage. For a UE using a NG-RAN/LTE that provides discontinuous coverage (e.g., for satellite access with discontinuous coverage), the UE may be out of NTN network coverage at a certain time.

The DDS SIM/Default Calling/Messaging SIM, which was earlier camped to 4G/5G service under NTN satellite coverage, might be out of network coverage for a certain duration due to the predictable movement of the satellite. Due to this discontinuous NTN coverage on the DDS SIM/Default Calling/Messaging SIM, the user services which are just initiated/ongoing on the default SIM prior to satellite coverage loss such as Voice Call, Data Service, emergency call Service etc. will get interrupted, leading to unsatisfactory user experience. Moreover, in the case of critical services as such Emergency services, any interruption/Failure may be very critical for the user and any failure/interruption needs to be avoided. During this discontinuous NTN service period on the DDS/Default Calling SIM, the UE may either have to remain with no service or it may attempt to register on any available different RAT's/PLMNs to receive the normal service which would take some time and user won't be able to use any services from the default SIM till then. However, during the same time instance/period, the other SIM (non-DDS/Non-Default Calling SIM) might be in coverage and may be able to provide services (Data/Calling/Messaging/Emergency services etc.) to the user without any interruption.

Currently, there is no provision for the UE to pre-determine or pre-empt the loss of service accurately and switch/set the default services to a SIM Card which can provide normal services to ensure uninterrupted continuation of user services (Voice call, Messages, Emergency call, File download) in the event of discontinuous satellite coverage on the DDS/Default Calling SIM even when other SIM Card is able to provide services.

In the current UE implementation, the user service (Calling/Emergency call, Data services, File download, Messaging etc.) ongoing on the DDS/Default Calling/messaging SIM is interrupted in the event of out-of-coverage encountered during discontinuous satellite coverage period and the user may not get services (Data/Calling/Messaging services) from the primary SIM and may have to manually switch the DDS or Default Calling option to other SIM Card (Secondary SIM) to get Data/Calling services leading to a poor user experience. There is no way for the UE to proactively predict and change the default Data subscription (DDS) or Default Calling/Messaging Setting to the SIM Card with an available network to utilize the available network coverage of other SIM (non-DDS/non-default Calling SIM) to ensure the user services continuation on the non-DDS SIM despite the DDS SIM experiencing discontinuous satellite coverage during the out-of-coverage period. Thus, there is a need for a system and a method to overcome the aforementioned problems.

The disclosure may use the Rel-18 3GPP features and parameters of Discontinuous Coverage Support for NTN for NR/LTE to accurately pre-determine the coverage availability and coverage loss (e.g., discontinuous coverage) of NTN, decide the optimum available SIM Cards for any user triggered services and efficiently switches the default user services (e.g., Default Data Subscription (DDS) for Data services, Default Calling SIM (for any types of calls) and Default Messaging SIM (for text messages)) from the default/preferred SIM Card which is about to lose service to other available SIM Card(s) which are/would be having TN/NTN service prior to default/preferred SIM entering discontinuous coverage. Further, the disclosed solution provides a pre-emptive or pre-determined time of coverage loss (during discontinuous coverage on NTN) to switch the default services (Call/Data/Emergency services/Messaging etc.) from the default SIM to other available SIM Card(s) with TN/NTN coverage to avoid any service failure for the ongoing services or services which are being initiated or about to be initiated.

A method for multi-SIM operation in a 5G-Non-Terrestrial Network (NTN). The method comprises: detecting a first SIM of a UE is configured for a default service (for e.g., default Data Subscription (DDS) or Default Calling Service or Default Messaging Service or default Emergency service or any Default Application Service or any default service) in NTN coverage; identifying a service (for e.g., Data or Call or SMS or Emergency or Application or any service) initiated at/by the UE using the first SIM over NTN. The method includes determining by the UE a NTN Satellite discontinuous coverage (for e.g., using start of unavailability period or unavailability period duration or any other parameters) on the first SIM; configuring a second SIM of the UE for the Default Service (for e.g. default Data Service (DDS) or Default Calling Service or Default Messaging Service or default Emergency service or any Default Application Service or any default service) in response to determining the discontinuous coverage period on the first SIM and switching the service initiated using the first SIM over NTN to the second SIM of the UE; receiving by the UE, unavailability period indication or discontinuous coverage indication message from the network during registration procedure; and receiving by the UE from a network, any 3GPP parameters (for e.g. Rel-18 parameters) or determining the discontinuous coverage, by the UE: based on Satellite Coverage Availability Information configured in the UE by any external server, via PDU Session or SMS or indicated by the Network Unavailability Period Duration (or UE out-of-coverage period) determined by the UE or indicated by the Network Start of Unavailability Period determined by the UE or indicated by the Network Based on Mobility Registration Update procedure or any procedure/indication (such as Notification of Leaving coverage) initiated by the UE before going into discontinuous coverage of NTN.

In an embodiment, if the coverage loss/Discontinuous coverage on NTN is determined/indicated to start at 1 pm on the DDS selected SIM (e.g., SIM1) and a huge file download/upload is initiated at 12.59 pm, Device would know that the time is not sufficient to complete the file transfer and thus move the DDS setting to other SIM Cards (e.g., SIM2) if the other SIM Card is having any of the TN/NTN coverage before the determined time of coverage loss (e.g., discontinuous coverage of NTN) and avail data services from SIM2. The file transfer won't fail and can be continued without any fail on the new DDS SIM (i.e., SIM2).

In an embodiment, if the coverage loss/Discontinuous coverage on NTN is determined/indicated to start at 1 pm on the Default Calling SIM (e.g., SIM1) and a call is initiated at 12.59 pm, Device would know that the time is not sufficient to complete the call setup and even if the call is successfully setup, it would drop due to loss of service at 1 μm and thus move the Default Call setting to other SIM Cards (e.g., SIM2) if the other SIM Card is having any of the TN/NTN coverage before the determined time of coverage loss (e.g., discontinuous coverage of NTN) and dial the Call over SIM2. The Call setup won't fail and there would not be any Call Drop or Call Setup failure on the new Default Calling SIM (e.g., SIM2).

In an embodiment, if the coverage loss/Discontinuous coverage on NTN is determined/indicated to start at 1 pm on the Default Calling SIM (e.g., SIM1) and an emergency call is initiated at 12.59 PM or just before 1 PM, Device would know that the time is not sufficient to complete the emergency call setup and even if the call is successfully setup, it would drop due to loss of service at 1 μm and thus move the Default Call setting to other SIM Cards (e.g., SIM2) if the other SIM Card is having any of the TN/NTN coverage before the determined time of coverage loss (e.g., discontinuous coverage of NTN) and dial the emergency call over SIM2. The Call setup won't fail and there would not be any emergency call Drop or emergency call Setup failure on the new default Calling SIM (e.g., SIM2). Since Emergency Calls are a priority and any call setup failure/call drop/Call Failure would be very critical for the users. Hence, with the disclosed solution, emergency calls could be placed on a SIM Card which can provide sufficient coverage to complete the call and there won't be any call drop since there would not be any coverage loss on the other SIM Card.

The disclosure provides enhanced, uninterrupted and hassle-free services to the users during discontinuous coverage of NTN on default SIM Card and provides better User experience. For Dual SIM devices, it is possible that the Default/Designated Data Service/Subscription (DDS) SIM or default calling/messaging SIM is camped to 4G/5G service under NTN satellite coverage and the non-DDS SIM/non-Default Calling/Messaging SIM is camped to 4G/5G service under terrestrial/NTN satellite coverage of a different operator. The user is about to initiate a Call/Message/File download or any Data Services/Emergency service on default (e.g., DDS or Default Calling) SIM and the time is not sufficient to complete the user service before the UE enters discontinuous satellite coverage state.

It shall be noted that, for convenience of explanation, the disclosure uses terms and names defined in the 3rd Generation Partnership Project (3GPP) standards.

In an embodiment, the system uses the Rel-18 features and parameters of Discontinuous Coverage Support for NTN for NR/LTE to accurately pre-determine the coverage availability and coverage loss (e.g., discontinuous coverage) of NTN, decide the optimal available SIM Cards for any user triggered services and efficiently switches the default user services (e.g., Default Data Subscription (DDS) for Data services, Default Calling SIM (for any types of calls) and Default Messaging SIM (for text messages)) from the default/preferred SIM Card which is about to lose service to other available SIM Card(s) which are/would be having TN/NTN service prior to default/preferred SIM entering discontinuous coverage.

In an embodiment, the system determines whether a service triggered by the user would be able to complete successfully or not before the SIM Card on which the Service is triggered enters discontinuous satellite coverage. If the UE determines, based on 3GPP Rel-18 parameters or using any available or mentioned parameters, that the service would not be able to complete before the UE entering discontinuous coverage on the triggered SIM Card, the UE will use any other available SIM Card, which is in service and would be able to successfully complete the service, for the triggered service. Moreover, the UE would set the default setting for those services to the selected available SIM Cards.

In an embodiment, the system provides a method to avoid the interruption/failure of a user service ongoing/initiated on the Default SIM in the event of discontinuous satellite coverage on the Default SIM. In an embodiment of the disclosure, the algorithm and steps may include Step-1: Determination of Start of Unavailability Period and Unavailability Period Duration by the UE/Device on preferred Default SIM card. The UE determines the Start of Unavailability Period and/or Unavailability Period Duration for the discontinuous coverage of NTN for the default SIM (DDS-set SIM or Default Calling/Messaging set SIM (e.g., SIM1) as well as other SIM Cards (if camped on NTN) for the current or any future/extrapolated UE locations based on any of the following Rel-18 parameters: Based on Satellite Coverage Availability Information configured in the UE by any external server, via PDU Session or SMS or indicated by the Network, Unavailability Period Duration (or UE out-of-coverage period) determined by the UE or indicated by the Network, Start of Unavailability Period determined by the UE or indicated by the Network, Mobility Registration Update procedure or any procedure/indication (such as Notification of Leaving coverage) initiated by the UE before going into discontinuous coverage of NTN and the like.

Switching of Default Services (Data or Call or any other services) to other SIM Card which is not in discontinuous coverage of NTN. When the UE determines that the default SIM (for e.g., SIM1) set for Data (e.g., DDS SIM) or Calling/Messaging services (e.g., Default Calling/Messaging SIM) is about to go into discontinuous coverage (e.g., based on determination of Start time of Unavailability Period), UE shall switch the Default Data and Calling/Messaging services to the SIM Card (for e.g., SIM2) (which is not in discontinuous coverage of NTN or is in TN service or is having a Start of Unavailability Period/Unavailability Period duration of a later time period) before the determined Start of Unavailability Period for the current default SIM for a period just greater than the determined Unavailability Period duration or until the current default SIM is not back in Service again. UE initiates any required service over other available SIM cards in service (e.g., SIM2) to avoid any failures. Also, if any service (Call/Message/Data/Emergency service) is being initiated on the Default SIM and if the UE determines that the Service Setup/Completion would fail due to determined Start/Duration of Discontinuous coverage on the Default SIM, UE shall redirect the services to other available SIM Cards, which is in service and not in discontinuous coverage, to provide uninterrupted services.

Switching of Default Services (Data or Call or Message or any other services) back to preferred Default SIM Card after discontinuous coverage of NTN is over. When the UE determines that the discontinuous coverage for NTN is over on the preferred default SIM Card (for e.g., SIM1) (e.g., based on determination of start time or duration of unavailability period) or if the preferred Default SIM camps for TN service, UE shall switch the default services (e.g., default data and default calling/messaging services) back to the preferred default SIM card (for e.g., SIM1) (which is back in service from discontinuous coverage of NTN or is in TN service) and avail any services from the preferred SIM Card (e.g., SIM1).

The systems and methods as discussed in this embodiment shall allow that the user services ongoing on the Default SIM (for e.g., SIM1) would not face failures/service issues in the event of discontinuous satellite coverage on the Default SIM by dynamically performing Default Service switch (e.g. DDS switch or Default Calling/Messaging Service Switch) to other available SIM Card(s) (for e.g., SIM2) prior/before the determined Start/Duration of the discontinuous coverage on the default SIM. The systems and method may enhance service continuity, may enrich user experience and may provide better user experience without any manual intervention of the users.

In an embodiment, default/preferred calling SIM (for e.g., SIM1) is camped to 4G/5G service under NTN satellite coverage and the non-default/non-preferred calling SIM (for e.g., SIM2) is camped to 4G/5G service under terrestrial/NTN satellite coverage of a different operator. Further, UE initiates a call. The call goes on the default/preferred calling SIM (e.g., SIM1). Due to the discontinuous coverage of satellite on SIM1, the UE is about to lose coverage/service on the default/preferred calling or Dialed SIM (e.g., SIM1) in near future (say after about 5 seconds), e.g., before the call could be setup/connected/completed. Due to the discontinuous NTN coverage on the dialed SIM or the default/preferred calling SIM (e.g., SIM1), the Call dialed on the SIM1 prior to satellite coverage loss (e.g., prior to discontinuous coverage) might get interrupted/face call setup failures or may drop/fail due to NTN service loss, leading to unsatisfactory user experience. During this discontinuous NTN service period on the dialed SIM (e.g., SIM1 which could be the preferred/default Calling SIM), the UE may either have to remain with no service or it may attempt to register on any available different RAT's/PLMNs to receive the normal service which may take time and there would be no Calling services available on this SIM till then. Once the UE returns to NTN satellite coverage or any service on the dialed/preferred/default Calling SIM, the user shall be able to make any calls using that SIM Card (e.g., SIM1).

In an embodiment, default/preferred calling SIM (for e.g., SIM1) is camped to 4G/5G service under NTN satellite coverage and the non-default/non-preferred calling SIM (for e.g., SIM2) is camped to 4G/5G service under terrestrial/NTN satellite coverage of a different operator. Further, UE initiates a Call. Due to the discontinuous coverage of satellite on SIM1, the UE is about to lose coverage/service on the default/preferred calling or Dialed SIM (e.g., SIM1) in near future (say after about 5 seconds), for example, before the call could be setup/connected/completed. UE determines Start of Unavailability Period and/or Unavailability Period Duration for the available SIM cards camped on NTN service (for e.g., SIM1) based on available parameters (Rel-18) (determined by the UE or indicated by the Network/Server) such as: Satellite Coverage Availability Information, Unavailability Period Duration/UE out-of-coverage period, Start of Unavailability Period, Mobility Registration Update procedure or Notification of Leaving coverage or any indication/procedure by UE just before entering Discontinuous coverage and the like.

If the UE determines that it is about to enter NTN discontinuous coverage on default/preferred calling SIM or Dialed SIM (SIM1) (e.g., x duration remaining: any UE configured small duration for e.g., 5 secs) or UE would be unable to setup/complete the call within x duration and if the other available SIMs (ex-SIM2) is in service (any TN/NTN service), UE switches or sets Default/Preferred Calling services to other available SIMs in service (ex-SIM2) and dials Calls over SIM2. UE initiates and avails calling services/dials call over new default/preferred calling SIM Card (e.g., SIM2). Further, call is successfully setup or connected over SIM2. If the UE determines Unavailability Period Duration/Discontinuous Coverage on actual default/preferred calling SIM Card (e.g., SIM1) is over or SIM1 is back in any service (TN or NTN service), UE switches or sets the Default/Preferred Calling services back to actual/original default/preferred calling SIM in service (ex-SIM1). Therefore, the user enjoys uninterrupted and seamless calling experience in the event of discontinuous satellite coverage on the default/preferred/dialed SIM.

In an embodiment, Default/Preferred Data SIM or Default/Designated Data Service/Subscription e.g., DDS SIM (for e.g., SIM1) is camped to 4G/5G service under NTN satellite coverage and the non-default/non-preferred Data SIM (for e.g., SIM2) is camped to 4G/5G service under terrestrial/NTN satellite coverage of a different operator. Further, UE initiates a Data Download or File Download (for e.g., a large File Download). Next, file download starts on the Default/Preferred Data SIM or DDS SIM (e.g., SIM1). Due to the discontinuous coverage of satellite on SIM1, the UE is about to lose coverage/service on the Default/Preferred Data or DDS SIM (e.g., SIM1) in near future (say after about 5 seconds), e.g., before the File Download can be completed. Due to the discontinuous NTN coverage on the default/preferred Data SIM or DDS SIM (e.g., SIM1), the File Download initiated on the SIM1 prior to satellite coverage loss (e.g., prior to discontinuous coverage) might get interrupted/fail due to NTN service loss, leading to unsatisfactory user experience. During this discontinuous NTN service period on the Data SIM (e.g., SIM1 which could be the preferred/default Data SIM or DDS SIM), the UE may either have to remain with no service or it may attempt to register on any available different RAT's/PLMNs to receive the normal service which may take time and there would be no Data services available on this SIM till then. Once the UE returns to NTN satellite coverage or any service on the preferred/default Data SIM or DDS SIM, the user shall be able to use Data services using that SIM Card (e.g., SIM1).

In an embodiment, Default/Preferred Data SIM or DDS SIM (for e.g., SIM1) is camped to 4G/5G service under NTN satellite coverage and the non-default/non-preferred Data SIM (for e.g., SIM2) is camped to 4G/5G service under terrestrial/NTN satellite coverage of a different operator. Further the UE initiates a Data Download or File Download (for e.g., a large File Download). Due to the discontinuous coverage of satellite on SIM1, the UE is about to lose coverage/service on the Default/Preferred Data or DDS SIM (e.g., SIM1) in near future (say after about 5 seconds), e.g., before the File download can be completed. The UE determines Start of Unavailability Period and/or Unavailability Period Duration for the available SIM cards camped on NTN service (for e.g., SIM1) based on available parameters (Rel-18) (determined by the UE or indicated by the Network/Server) such as: Satellite Coverage Availability Information, Unavailability Period Duration/UE out-of-coverage period, Start of Unavailability Period, Mobility Registration Update procedure or Notification of Leaving coverage or any indication/procedure by UE just before entering Discontinuous coverage and the like.

In an embodiment, if the UE determines that it is about to enter NTN discontinuous coverage on Default/Preferred Data SIM or DDS SIM (SIM1) (e.g., x duration remaining: any UE configured small duration for e.g., 5 secs) or UE would be unable to complete the Data activity/transfer within x duration and if the other available SIMs (ex-SIM2) is in service (any TN/NTN service), UE switches or sets Default/Preferred Data services to other available SIMs in service (ex-SIM2) and uses Data Transfer over SIM2, UE initiates and avails Data services over new default/preferred calling SIM Card (.g., SIM2), File Transfer/Download is successful over SIM2. If the UE determines Unavailability Period Duration/Discontinuous Coverage on actual Default/Preferred Data SIM or DDS SIM (e.g., SIM1) is over or SIM1 is back in any service (TN or NTN service), UE switches or sets the Default/Preferred Data services back to actual/original Default/Preferred Data SIM or DDS SIM in service (ex-SIM1). User enjoys uninterrupted and seamless Data transfer experience in the event of discontinuous satellite coverage on the default/preferred Data or DDS SIM.

In an embodiment, default/preferred calling SIM (for e.g., SIM1) is camped to 4G/5G service under NTN satellite coverage and the non-default/non-preferred calling SIM (for e.g., SIM2) is camped to 4G/5G service under terrestrial/NTN satellite coverage of a different operator. The UE initiates an Emergency Call. Further, call goes on the default/preferred calling SIM (e.g., SIM1). Due to the discontinuous coverage of satellite on SIM1, the UE is about to lose coverage/service on the default/preferred calling or Dialed SIM (e.g., SIM1) in near future (say after about 5 seconds), e.g., before the emergency call could be setup/connected/completed. Due to the discontinuous NTN coverage on the dialed SIM or the default/preferred calling SIM (e.g., SIM1), the emergency call dialed on the SIM1 prior to satellite coverage loss (e.g., prior to discontinuous coverage) might get interrupted/face call setup failures or may drop/fail due to NTN service loss, leading to unsatisfactory user experience. During this discontinuous NTN service period on the dialed SIM (e.g., SIM1 which could be the preferred/default Calling SIM), the UE may either have to remain with no service or it may attempt to register on any available different RAT's/PLMNs to receive emergency services which may take time and there would be no emergency services available until UE 150 camps on any available PLMN (for e.g., SIM2 PLMN) for emergency/normal services (e.g., emergency call would be delayed). Once the UE returns to NTN satellite coverage or any service on the dialed/preferred/default Calling SIM, the user shall be able to make any Emergency calls using that SIM Card (e.g., SIM1). In the present disclosure, UE determines Start of Unavailability Period and/or Unavailability Period Duration for the available SIM cards camped on NTN service (for e.g., SIM1) based on available parameters (Rel-18) (determined by the UE or indicated by the Network/Server) such as: Satellite Coverage Availability Information, Unavailability Period Duration/UE out-of-coverage period, Start of Unavailability Period, Mobility Registration Update procedure or Notification of Leaving coverage or any indication/procedure by UE just before entering Discontinuous coverage and the like.

If the UE determines that it is about to enter NTN discontinuous coverage on default/preferred calling SIM or Dialed SIM (SIM1) (.g., x duration remaining: any UE configured small duration for e.g., 5 secs) or UE would be unable to setup/complete the emergency call within x duration and if the other available SIMs (ex-SIM2) is in service (any TN/NTN service), UE switches or sets Default/Preferred Calling services to other available SIMs in service (ex-SIM2) and dials Emergency Calls over SIM2, UE initiates and avails Emergency calling services/dials Call over new default/preferred calling SIM Card (e.g., SIM2). emergency call is successfully setup or connected over SIM2. If the UE determines Unavailability Period Duration/Discontinuous Coverage on actual default/preferred calling SIM Card (e.g., SIM1) is over or SIM1 is back in any service (TN or NTN service), UE switches or sets the Default/Preferred Calling services back to actual/original default/preferred calling SIM in service (ex-SIM1). Therefore, users can enjoy uninterrupted and seamless Emergency calling experience in the event of discontinuous satellite coverage on the default/preferred/dialed SIM.

In an embodiment, the UE can determine or predict the Satellite Coverage availability or gaps using the 3GPP Rel-17 parameters such as t-service, distance Thresh, NTN-config, etc., broadcasted in SIB19 (NR) or SIB32 (LTE) and use the disclosure to efficiently select the available SIM Cards for triggered user services or set the preferred/default SIM Card for user services.

In an embodiment, device can apply the disclosure not only to select the default or preferred SIM Card for user services but also for selecting any available SIM Cards which are in service to trigger and complete user services which can't be completed by the SIM Card on which the service was triggered by the user due to discontinuous satellite coverage or any unavailability period (such as SIM Refresh or SIM update or SIM provisioning issues etc.).

In an embodiment, if a device is having multiple available SIM Card(s) apart from the default/preferred SIM Card which is about to go into discontinuous coverage, the desired/optimal SIM for getting services can be decided based on various factors such as: Current/Extrapolated (e.g., for any future location and time) Network coverage status of each SIM, Operator's charging and subscription policy, UE's usage history, Network camping history of each SIM based on any Database or AI/ML method, Start time and Duration of Discontinuous coverage period of each SIM, User's preferences using any indication or settings option etc.

In an embodiment AI-ML based learning techniques or historical Database approaches can be used to accurate determine the UE availability periods due to discontinuous coverage or any other reasons and trigger the disclosure to provide uninterrupted user services.

Example advantages achieved by the present disclosure is a method to ensure that the user service (Call, Emergency call, File Download/Data Service, Messaging services) to be initiated on the Default/Preferred SIM, by default, is switched to other available SIM card(s) in service to ensure successful completion in an event of determination that the services would not be completed on the current/actual Default/Preferred SIM due to the SIM entering discontinuous satellite coverage state. The current disclosure also aims to utilize the newly introduced discontinuous satellite coverage parameters in 3GPP Rel-18 such as Satellite coverage availability information, Unavailability Period Duration, Unavailability Period Support, Start of Unavailability Period, Notification of Leaving Coverage, discontinuous coverage support etc., to select the optimum available SIM Card(s) for getting user services during discontinuous satellite coverage and also switch the Default/Preferred Settings to the other available SIM (provided it has network coverage), thereby ensuring that the user services are initiated and completed successfully. Further, the present disclosure would give the users a hassle-free uninterrupted service during discontinuous coverage from any of the available SIM Cards without any manual user intervention.

It may be noted that, for convenience of explanation, the disclosure uses terms and names defined in the specification TS 23.501 of Rel-18 of the 3rd Generation Partnership Project Radio Access Network (3GPP RAN) standards. More specifically, the terms ‘discontinuous coverage’, ‘discontinuous coverage support’, ‘Satellite coverage availability information’, ‘UE out-of-coverage period/Unavailability Period Duration’, ‘Unavailability Period Support’, ‘Start of Unavailability Period’, ‘Notification of Leaving Coverage’, ‘support of unavailability period’, ‘coverage availability information’ are to be interpreted as specified by the 3GPP standards.

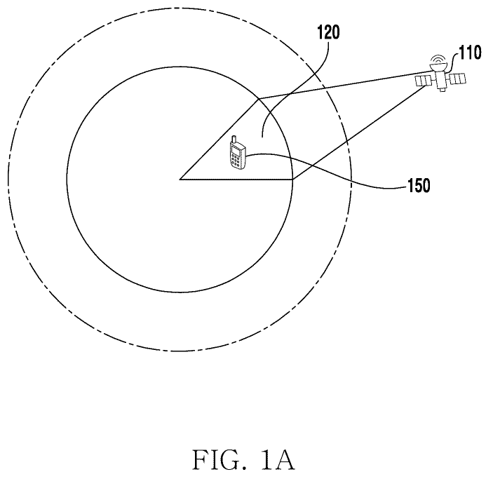

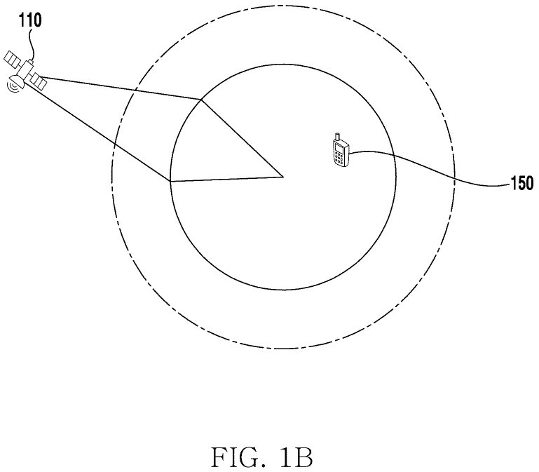

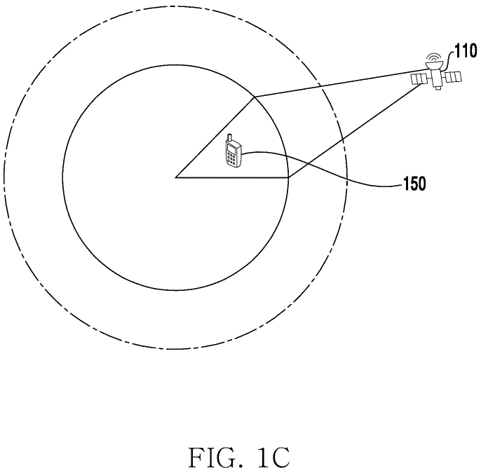

FIGS. 1A, 1B and 1C are diagrams illustrating an example environment depicting discontinuous satellite coverage for a UE 150, in which various embodiments of the present disclosure may be implemented. The environment depicts a satellite 110 providing services to electronic devices such as, a User Equipment (UE) 150 in an area 120. Examples of the UE 150 include, but not limited to, any device used by a user to communicate and/or access services such as, but not limited to, mobile phones, laptops, wearables, Internet of Things (IOTs), and the like. Examples of the services provided for the UE 150 by the satellite 110 include, but not limited to, data usage, calling, messaging, emergency services, application usage and the like. It shall be noted that although a single satellite is depicted to be providing services to the UE 150, in other implementations, the UE 150 may also be provided services by a satellite constellation that provides discontinuous coverage.

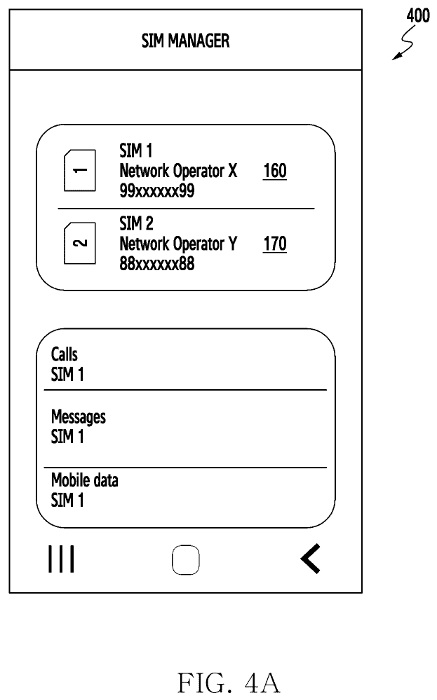

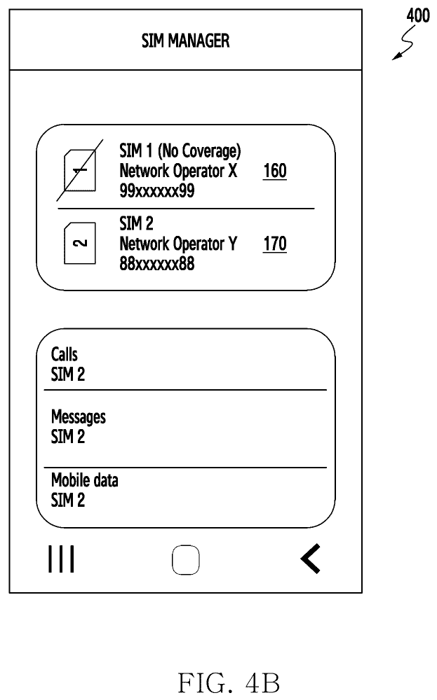

In an embodiment, the UE 150 may have a plurality of card slots configured to accommodate a plurality of SIM cards. In an example, the UE 150 is a dual SIM device capable of supporting SIM cards 160 and 170 (also referred to herein as ‘a first SIM 160’ or ‘SIM 1’ and ‘a second SIM 170’ or ‘SIM 2’) (as shown in FIG. 4A). It shall be noted that that the present disclosure is explained with reference to two SIM cards (e.g., the first SIM 160 and the second SIM 170) for exemplary purposes and embodiments of the present disclosure may be practiced with the UE 150 capable of supporting more than two SIM cards.

In an example, the first SIM 160 is camped to 4G/5G service under a first Non-Terrestrial Network (NTN) in which a satellite 110 provides discontinuous coverage and may be preset as default SIM for a plurality of services such as, default data usage, messaging, emergency service, application usage and calling usage. For example, the default SIM may be preset as the DDS SIM, and/or the default calling/messaging/emergency services/application usage SIM. It shall be noted that the first SIM 160 may be configured as the default SIM for all services or only a sub-set of the services based on user input. For example, the user may configure the first SIM 160 as the default SIM to support services relating to default data usage and calling usage while the second SIM 170 may be configured by the user as the default SIM for messaging usage, emergency service and application usage. The second SIM 170 An example of the user configuring the first SIM 160 and the second SIM 170 to provide services is shown and explained in greater detail below with reference to FIGS. 4A and 4B. In an embodiment, the second SIM 170 is registered with one of: a Terrestrial Network (TN) and a second NTN.

In the case of discontinuous coverage, the satellite 110 provides coverage to one part of an area (for example, area 120) at time T1 (see, FIG. 1A) and revisits that area 120 after some duration, for example, T1+X mins/hours (see, FIG. 1C). In the interim (e.g., between time period T1 and T1+X mins/hours which is referred to as ‘T2’), the UE 150 will be unable to acquire NTN coverage in that area 120. More specifically, the UE 150 would acquire service provided by the satellite 110 for a certain time duration (T1) followed by which coverage offered by the satellite 110 would no longer be available for certain duration (e.g., T2) due to discontinuous coverage. This would lead to any ongoing service interruption on the SIM for which NTN coverage was initially present and is now in discontinuous coverage. During this discontinuous satellite coverage duration (T2) (see, FIG. 1B), the UE 150 would receive no services from the satellite 110 and may try to search and camp on other RAT/PLMNs, if available, by performing PLMN search until it finds suitable TN/NTN cell to acquire service. If the UE 150 is unable to find a suitable cell, the UE 150 will keep performing continuous PLMN search in order to find suitable TN/NTN cell to register for the plurality of services. Since there might not be any TN/other NTN cell available in remote areas, the first SIM 160 of the UE 150 would be unable to provide services and these periodic PLMN searches might not yield any result. In general, the UE 150 may not get any services from the first SIM, which was camped on NTN services, for the duration of discontinuous coverage until Satellite coverage resumes.

Various embodiments of the disclosure provide discontinuous coverage support to the first SIM 160 of the UE 150 for NTN (e.g., both New Radio (NR)/Long Term Evolution (LTE)) to accurately predetermine the coverage availability and coverage loss (e.g., discontinuous coverage) of NTN. The UE 150 can decide the optimum available SIM card for any user triggered services and efficiently switch the default user services (e.g., DDS for data services, default calling SIM (for any types of calls) and default messaging SIM (for text messages)) from the default SIM card which is about to lose service to other available SIM card(s) which would be having TN/NTN coverage to provide services prior to the default SIM (e.g., the first SIM 160) entering discontinuous coverage. More specifically, embodiments provide techniques to determine whether a service triggered by the user on the first SIM 160 of the UE 150 would be able to complete successfully or not before the SIM card on which the service is triggered (e.g., the first SIM 160) enters discontinuous satellite coverage. If the UE 150 determines, based on 3GPP Rel-18 parameters, that the service would not be able to complete before the UE 150 enters discontinuous coverage on the triggered SIM card (e.g., the first SIM 160), the UE 150 would use any other available SIM card, such as, the second SIM 170, which is in service and would be able to successfully complete the service, for the triggered service. Moreover, the UE 150 would set the default setting for those services to the available SIM card (e.g., the second SIM 170).

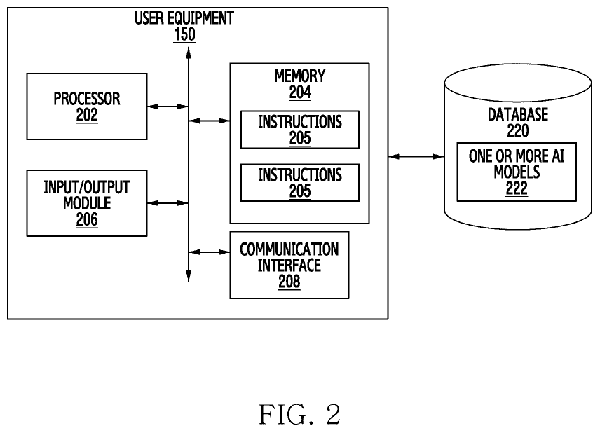

FIG. 2 is a block diagram illustrating an example configuration of the UE 150 for multi-SIM operation based on NTN during discontinuous satellite coverage, according to various embodiments. It shall be noted that components shown in FIG. 2 are for exemplary purposes to explain functioning of the UE 150 and may include more components, e.g., both hardware and software components, for performing various functionalities for multi-SIM operation. However, the block diagram may be an example of NTN network (e.g., first NTN 302, second NTN 304), a satellite (e.g., a satellite 110), or network function (NF) (e.g., AMF).

As a non-limiting example, the UE 150 supports discontinuous satellite coverage as defined by TS 23.501 v18.1.0 in Rel-18 3GPP which covers the mobility management, power saving optimization, satellite coverage availability information provisioning, paging and overload control aspects of discontinuous satellite coverage.

The UE 150 is depicted to include a processor (e.g., including processing circuitry) 202, a memory 204, an Input/Output module (e.g., including input/output circuitry) 206, and a communication interface (e.g., including communication circuitry) 208. It shall be noted that, in various embodiments, the UE 150 may include more or fewer components than those depicted herein. The various components of the UE 150 may be implemented using hardware, software, firmware or any combinations thereof. Further, the various components of the UE 150 may be operably coupled with each other. For example, various components of the UE 150 may be capable of communicating with each other using communication channel media (such as buses, interconnects, etc.).

In an embodiment, the processor 202 may include various processing circuitry, such as a multi-core processor, a single core processor, or a combination of one or more multi-core processors and one or more single core processors. For example, the processor 202 may be embodied as one or more of various processing devices, such as a coprocessor, a microprocessor, a controller, a digital signal processor (DSP), a processing circuitry with or without an accompanying DSP, or various other processing devices including, a microcontroller unit (MCU), a hardware accelerator, a special-purpose computer chip, or the like. In an example, the first SIM 160 may be supported by a first processor and the second SIM 170 may be supported by a second processor. The processor 202 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

In an embodiment, the memory 204 is capable of storing machine executable instructions, referred to herein as instructions 205. In an embodiment, the processor 202 may be embodied as an executor of software instructions. As such, the processor 202 is capable of executing the instructions 205 stored in the memory 204 to perform one or more operations described herein. The memory 204 can be any type of storage accessible to the processor 202 to perform respective functionalities, as will be explained in detail with reference to FIGS. 2 to 8. For example, the memory 204 may include one or more volatile or non-volatile memories, or a combination thereof. For example, the memory 204 may be embodied as semiconductor memories, such as flash memory, mask ROM, PROM (programmable ROM), EPROM (erasable PROM), RAM (random access memory), etc. and the like. In an embodiment, the memory 204 stores one or more Artificial Intelligence (AI) models 222. The one or more AI models 222 may be used to predict a time period for completion of at least one service initiated on the first SIM 160 based on one or more service parameters associated with the at least one service. In an embodiment, the AI models 222 may be used to determine one or more first discontinuous coverage parameters associated with the first SIM 160 of the UE 150. The one or more service parameters may include, but is not limited to a service type, a size of service file, a call setup/connection time, a response from server, a response from emergency responder, an estimated call duration based on past history, a data browsing history of the user, an application usage statistics, a service history/statistics and a current uplink/downlink data rate on the one or more SIMs.

In an embodiment, the processor 202 may be configured to execute the instructions 205 or may be otherwise configured to: (1) detecting a default configuration of at least one service of a plurality of services on a first SIM of the UE over the first Non-Terrestrial Network (NTN), (2) estimating a time period for completion of the at least one service on the first SIM, (3) determining one or more first discontinuous coverage parameters associated with the first SIM of the UE, (4) configuring a second SIM of the UE to provide the at least one service, (5) switching the default configuration of at least one service from the first SIM to the second SIM of the UE, (6) determining if a discontinuous coverage of the first SIM is completed based on the one or more first discontinuous coverage parameters, (7) restoring the first SIM as the default SIM of the UE for providing the plurality of services based on the determining.

In an embodiment, the I/O module 206 may include various input/output circuitry and mechanisms configured to receive inputs from and provide outputs to a user associated with the UE 150. The user may refer to one or more individuals, whether directly or indirectly, associated with the accessing services on the UE 150. In an embodiment, the user of the UE 150 may preset a default SIM for a plurality of services such as, a first SIM 160 for data services, call usage and emergency call services and the second SIM 170 for messaging services. An example of the UI depicting the user presetting default SIMs for different services is shown and explained in greater detail below with reference to FIG. 4A. To enable reception of inputs and provide outputs to the UE 150, the I/O module 206 may include at least one input interface and/or at least one output interface. Examples of the input interface may include, but are not limited to, a keyboard, a mouse, a joystick, a keypad, a touch screen, soft keys, a microphone, and the like. Examples of the output interface may include, but are not limited to, a display such as a light emitting diode display, a thin-film transistor (TFT) display, a liquid crystal display, an active-matrix organic light-emitting diode (AMOLED) display, a microphone, a speaker, a ringer, and the like.

In an embodiment, the communication interface 208 may include various communication circuitry and mechanisms configured to communicate with other entities in the environment 100, for example, one or more Network Functions (NFs) such as, Access and Mobility Management Function (AMF). In other words, the communication interface 208 is configured to receive a discontinuous coverage support indication in a registration accept message from the AMF (not shown in FIG. 2). For example, during the registration procedure, the UE 150 supporting Discontinuous coverage functionalities provides “discontinuous coverage support” indication as part of 5GMM Core Network Capability in the Registration Request message for initial registration and for every mobility registration. The AMF indicates to the UE 150 whether discontinuous coverage functionalities are supported by providing the “discontinuous coverage support” indication in Registration Accept message.

In an embodiment, the communication interface 208 is configured to receive one or more first discontinuous coverage parameters associated with the first SIM 160 of the UE 150. For example, the one or more first discontinuous coverage parameters are received as part of a Mobility Registration Update or the UE 150 initiated deregistration procedure performed by the first SIM 160 of the UE 150. In an embodiment, the one or more first discontinuous coverage parameters are configured by an external server (not shown in the drawings) in one of: a Protocol Data Unit (PDU) session or Short Message Service (SMS). In an embodiment, the one or more first discontinuous coverage parameters are determined by the UE 150. The one or more first discontinuous coverage parameters include at least one of: satellite coverage availability information a satellite ephemeris information, an unavailability configuration, an unavailability information, a start of an unavailability period, an unavailability period duration, an unavailability type, a network operator deployment information, an information from a server, a network broadcast parameter, a network signaling parameter and the like. Satellite coverage availability information refers to location and time information related to expected coverage availability of the satellite 110 or satellite constellation that provides discontinuous coverage. The unavailability information includes information related to start of unavailability period and unavailability period duration. For example, before the start of an event that makes the UE 150 unavailable due to discontinuous satellite coverage, the UE 150 includes optionally the start of the unavailability period and the unavailability period duration for triggering either the Mobility Registration Update or the UE 150 initiated deregistration procedure. The unavailability period duration is a time period that the UE 150 is assumed to be out of coverage in case of NR satellite access that provides discontinuous coverage, based on satellite coverage availability information. This indicates the timing information for when the UE 150 is expected to be out of coverage, and when the UE 150 is expected to re-gain coverage again. The UE out-of-coverage period may consider current and expected future locations of the UE 150. An example of the Registration Accept message is shown below:

Registration Accept (5G-GUTI, Registration Area, [Mobility restrictions], [PDU Session status], [Allowed NSSAI], [Mapping Of Allowed NSSAI], [Configured NSSAI for the Serving PLMN], [Mapping Of Configured NSSAI], [NSSRG Information], [NSAG Information], [rejected S-NSSAIs], [Pending NSSAI], [Mapping Of Pending NSSAI], [Periodic Registration Update timer], [Active Time], [Strictly Periodic Registration Timer Indication], [LADN Information], [accepted MICO mode], [IMS Voice over PS session supported Indication], [Emergency Service Support indicator], [Accepted DRX parameters for E-UTRA and NR], [Accepted DRX parameters for NB-IoT], [extended idle mode DRX parameters], [Paging Time Window], [Network support of Interworking without N26], [Access Stratum Connection Establishment NSSAI Inclusion Mode], [Network Slicing Subscription Change Indication], [Operator-defined access category definitions], [List of equivalent PLMNs], [Enhanced Coverage Restricted information], [Supported Network Behaviour], [Service Gap Time], [PLMN-assigned UE Radio Capability ID], [PLMN-assigned UE Radio Capability ID deletion], [WUS Assistance Information], [AMF PEIPS Assistance Information], [Truncated 5G-S-TMSI Configuration], [Connection Release Supported], [Paging Cause Indication for Voice Service Supported], [Paging Restriction Supported], [Reject Paging Request Supported], [Paging Restriction Information acceptance/rejection], [“List of PLMN(s) to be used in Disaster Condition”], [Disaster Roaming wait range information], [Disaster Return wait range information], [Forbidden TAI(s)], [List of equivalent SNPNs], [Registered NID], [Unavailability Period Supported], [Discontinuous Coverage Supported], [Return To Coverage Notification Not Required], [Unavailability Period Duration], [Start of Unavailability Period]).

In an embodiment, the communication interface 208 is configured to receive one or more second discontinuous coverage parameters associated with the second SIM 170 from the AMF when the second SIM 170 is registered with the second NTN. More specifically, the one or more second discontinuous coverage parameters are received as part of a Mobility Registration Update or the UE 150 initiated deregistration procedure performed by the second SIM 170 of the UE 150. The one or more second discontinuous coverage parameters include at least one of: satellite coverage availability information, a satellite ephemeris information, an unavailability configuration, an unavailability information, a start of an unavailability period, an unavailability period duration, an unavailability type, a network operator deployment information, an information from a server, a network broadcast parameter, a network signalling parameter and the like, of satellite or satellite constellation providing services to the second SIM 170 of the UE 150. It shall be noted that if the second SIM 170 is connected to a TN, then the one or more second discontinuous coverage parameters are not received from the AMF.

In an embodiment, the UE 150 may include a Notification of Leaving Coverage if a Notification of Leaving Coverage Request was received from the AMF. For example, if the UE 150 and network function (e.g., AMF) have indicated support for discontinuous coverage reporting and the if the UE 150 is about to lose coverage and cannot determine the out-of-coverage period, the UE 150 shall include a Notification of Leaving Coverage if the Notification of Leaving Coverage Request was received from the AMF.

The UE 150 is depicted to be in operative communication with a database 220. In an embodiment, the database 220 is configured to store historical data related to the one or more first discontinuous coverage parameters and the one or more second discontinuous coverage parameters. The database 220 may include call logs, message logs, data usage logs during the discontinuous coverage of the first SIM 160 and/or the second SIM 170. The database 220 may include multiple storage units such as hard disks and/or solid-state disks in a redundant array of inexpensive disks (RAID) configuration. In various embodiments, the database 220 may include a storage area network (SAN) and/or a network attached storage (NAS) system. In an embodiment, the database 220 may correspond to a distributed storage system, wherein individual databases are configured to store custom information, such as, registration related information, unavailability period information, return to coverage notifications, unavailability period duration, start of unavailability period, etc.

In various embodiments, the database 220 is integrated within the UE 150. For example, the UE 150 may include one or more hard disk drives as the database 220. In various embodiments, the database 220 is external to the UE 150 and may be accessed by the UE 150 using a storage interface (not shown in FIG. 2). The storage interface is any component capable of providing the processor 202 with access to the database 220. The storage interface may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing the processor 202 with access to the database 220.

In an embodiment, the communication interface 208 forwards the one or more first discontinuous coverage parameters to the processor 202. Optionally, the one or more second discontinuous coverage parameters are sent to the processor 202 when the second SIM 170 is connected to the second NTN. In an embodiment, the one or more AI models 222 determines the one or more first discontinuous coverage parameters. The processor 202 in conjunction with the instructions 205 in the memory 204 is configured to perform one or more operations as described herein.

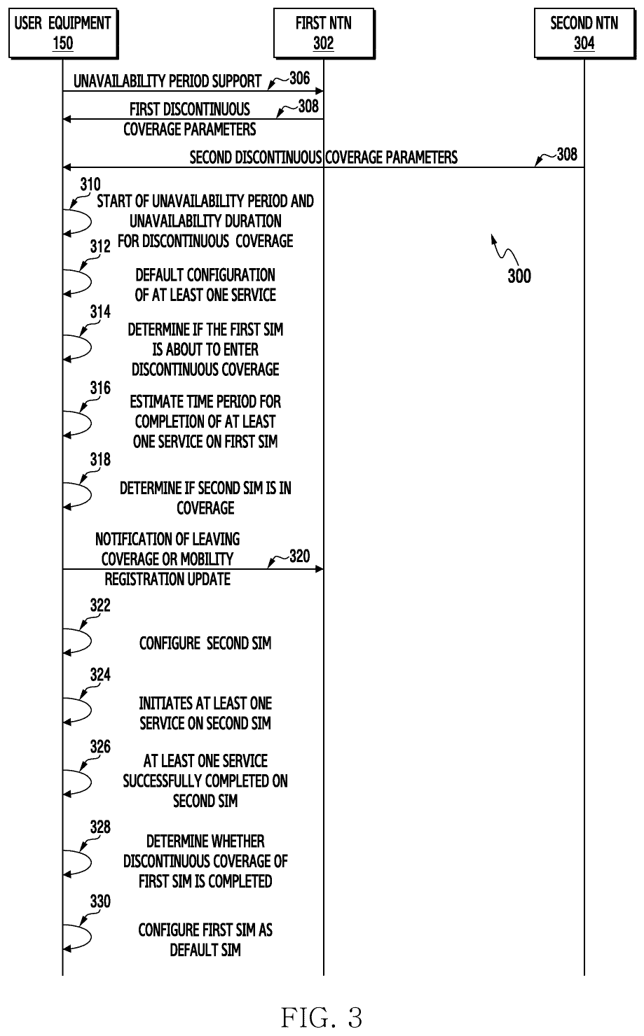

Referring now to FIG. 3 in conjunction with FIG. 2, a signal flow diagram illustrating an example method 300 for multi-SIM operation based on a first NTN 110 during discontinuous satellite coverage is illustrated according to various embodiments. As already explained, the first SIM 160 of the UE 150 is camped on the first NTN 110 which provides services using the satellite 110 and the second SIM 170 of the UE 150 is camped on one of: the second NTN 304 (see, FIG. 3). The user may provide user inputs to select default SIM for accessing various services which are shown and explained in greater detail below with reference to FIG. 4A.

FIG. 4A is a diagram illustrating an example UE 150 displaying a UI 400 depicting default settings preset by a user for the first SIM 160 and the second SIM 170, according to various embodiments. In an example, the UI 400 may be presented on the UE 150 in response to a selection input on an option associated with title “SETTINGS”. It shall be noted that the presentation of UI 400 to the user is explained herein for exemplary purposes and the option may be associated with a title different from the title explained herein.

The first SIM 160 is camped to 4G/5G service under the first NTN 110 and the second SIM 170 is registered with one of: a Terrestrial Network (TN) and a second NTN 304. The UI 400 depicts the services that may be accessed on the UE 150. For example, a content portion of the UI 400 displays services such as, calling service (shown as “CALLS’), messaging service (shown as ‘MESSAGE’), data services (shown as ‘MOBILE DATA’). As shown in FIG. 4A, each of the services displayed on the UI 400 are associated with options 402, 404, 406. For example, these options 402, 404 and 406 provide a list of SIM cards supported by the UE 150. In this example, the UE 150 supports the first SIM 160 (also referred to as ‘SIM 1’) and the second SIM 170 (also referred to as ‘SIM 2’). As such, a click/touch input on the options 402/404/406 presents an option for the user to select SIM 1/SIM 2 for each of the services.

In an example, the user may provide a selection input on the first SIM 160 for each of the services such as, default data usage, calling usage and messaging usage. As such, SIM 1 (e.g., the first SIM 160) is set to be the default SIM for default data usage, calling usage and messaging usage. In other words, SIM 1 may be preset as the DDS SIM, the default calling SIM and the default messaging SIM. However, it shall be noted that the first SIM 160 may be configured as the default SIM for all services or only a sub-set of the services based on user input. It shall be noted that the options 402, 404, 406 displayed on the UI 400 are shown herein for illustration purposes and the options 402, 404 and 406 may be displayed in any other format for receiving user input.

Referring back to FIG. 3, at 306, the UE 150 and a first NTN network 302 negotiate discontinuous coverage support. In this example representation, services of the NTN network are performed by a satellite or satellite constellation such as, the satellite 110. During registration procedure, the UE 150 supporting discontinuous coverage functionalities provides “discontinuous coverage support” indication as part of 5GMM core network capability in the registration request message for initial registration and for every mobility registration to the AMF. In response to the registration request message, the AMF indicates whether discontinuous coverage functionalities are supported by providing the “discontinuous coverage support” indication in registration accept message. In an embodiment, Registration procedure is used as an example, it could be any AS/NAS signalling message (for e.g. Attach Request/Attach Accept or TAU Request/TAU Accept etc) as enclosed in this embodiment.

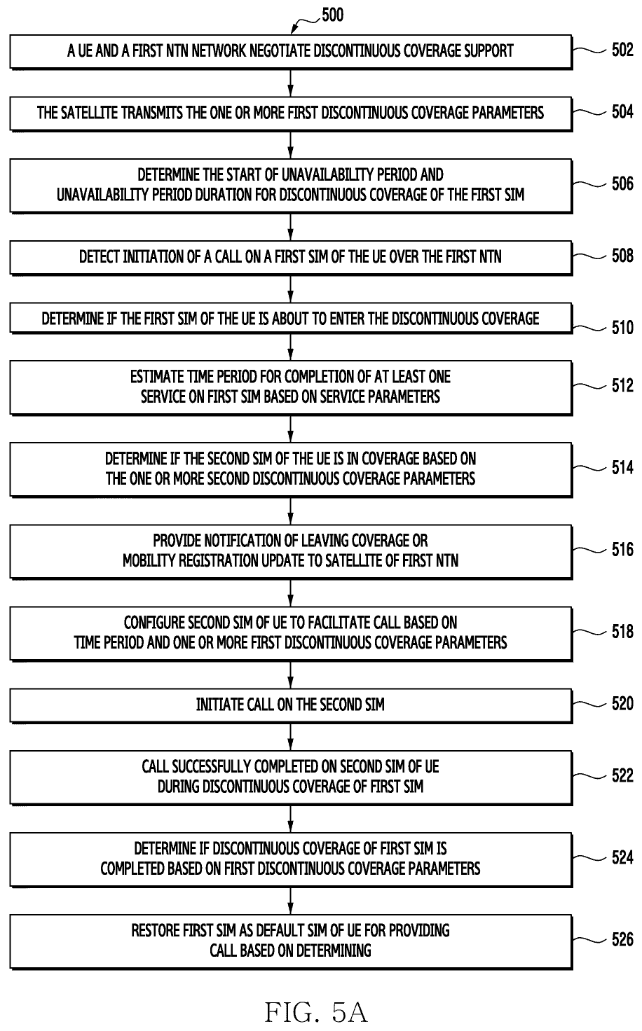

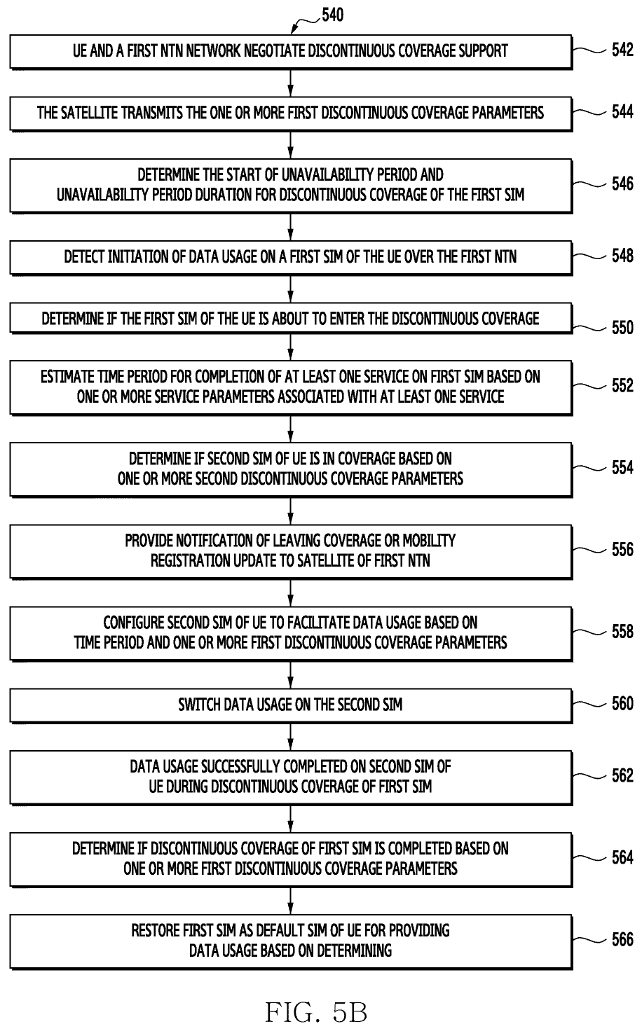

At 308, the satellite (e.g., the first NTN network 302 (or the first NTN 302)) 110 transmits the one or more first discontinuous coverage parameters. In an embodiment, the AMF transmits the one or more first discontinuous coverage parameters as part of the registration accept message. An example of the registration accept message with the one or more first discontinuous coverage parameters is shown and explained with reference to FIG. 2. In an embodiment, the one or more first discontinuous coverage parameters are received in response to one of: mobility registration update procedure, and notification of leaving coverage, initiated by the UE 150. In an embodiment, the one or more first discontinuous coverage parameters are configured by an external server (not shown in FIG. 5A) in one of: a Protocol Data Unit (PDU) session or Short Message Service (SMS). In an embodiment, if the second SIM is registered/attached on an NTN network, the second SIM may receive a second discontinuous coverage parameters from the second NTN network.

At 310, the UE 150 determines the start of unavailability period and unavailability period duration for discontinuous coverage of the first SIM 160. In an embodiment, the processor 202 is configured to determine the start of unavailability period and unavailability period duration based on the one or more first discontinuous coverage parameters. For example, the processor 202 may use the one or more AI models 222 to predict the start of unavailability period and unavailability period duration based on the one or more first discontinuous coverage parameters. To that effect, the processor 202 may determine a current location of the UE 150, position of the satellite 110 and an expected trajectory of the satellite 110. The processor 202 may determine the start of unavailability period and unavailability period duration for discontinuous coverage of the first SIM 160 based on the one or more first discontinuous coverage parameters. In an example, the unavailability period duration may be 35 minutes and start of unavailability period may be 2:15 PM Pacific Daylight Time (PDT). Accordingly, the processor 202 determines the start of unavailability period as 2.15 PM PDT and unavailability period duration for the first SIM 160 of the UE 150 during the discontinuous coverage as 35 minutes based on the one or more first discontinuous coverage parameters. It shall be noted that the start of unavailability period and the unavailability period duration may depend on an orbital period and an orbit of the satellite 110.

At 312, the UE 150 detects a default configuration of at least one service of a plurality of services on a first SIM 160 of the UE 150 over the first NTN 110. In this example representation, the user may initiate a call on the UE 150. It shall be noted that the first SIM 160 is preset as the default SIM for calling usage by the user. The default configuration may include, but is not limited to, a Default Data SIM, a Default Calling SIM, a Default Messaging SIM, a Default Application Usage SIM, a Default Emergency Usage SIM, etc.

At 314, the UE 150 determines if the first SIM 160 of the UE 150 is about to enter the discontinuous coverage. Due to the discontinuous coverage of the satellite 110 on the SIM1 (e.g., the first SIM 160), the UE 150 is about to lose coverage or service on the default calling or Dialed SIM (e.g., SIM1) in near future (say after about 6 seconds), e.g., before the call could be setup/connected/completed. For example, the processor 202 may compare the start of unavailability period and unavailability period duration for discontinuous coverage of the first SIM 160 with a current time of the first SIM 160 to determine if the UE 150 is active or about to enter the discontinuous coverage. In an example, if the current time as shown by the first SIM 160 is 2: 14:54 seconds (for e.g. 54 seconds past 2.14 PM PDT), and if the satellite 110 associated with the first NTN 110 will enter the discontinuous coverage in 5 seconds, then the processor 202 determines that the first SIM 160 of the UE 150 will not have coverage in the next 6 seconds.

At 316, the UE 150 estimates a time period for completion of the at least one service on the first SIM 160 based on one or more service parameters associated with the at least one service. In an embodiment, the one or more service parameters are a service type, a size of service file, a call setup/connection time, a response from server, a response from emergency responder, an estimated call duration based on past history, a data browsing history of the user, an application usage statistic, a service history/statistic, a current uplink/downlink data rate on the one or more SIM and the like. The one or more SIMs include the first SIM 160, the second SIM 170 and the like. In an example, the processor 202 estimates the time period for completion of the call on the first SIM 160 based on a service type, for example, audio call/video call. For example, if a video call is initiated on the first SIM 160, the processor 202 estimates the video call to last for 5 minutes. In an embodiment, the processor 202 estimates the time period for completion of the call on the first SIM 160 based on the historical data in the database 220 and the one or more service parameters. In an example, for the call initiated on the UE 150, the one or more AI models 222 may be trained to estimate a time period of the call based on the historical data. For example, if the call is from a number registered as sales, the historical data will indicate that the user spends an average of 30 seconds on the call. Such historical data along with day/time (weekday, weekend public holiday, morning, afternoon, evening, night, etc.), location (e.g., office, home, outdoor, outstation, etc.) of the day may be used to predict the time period. It shall be noted that the time period is an estimate and not an accurate representation of the time duration of the call.

At 318, the UE 150 determines if the second SIM 170 of the UE 150 is in coverage based on the one or more second discontinuous coverage parameters. To that effect, the processor 202 is configured to receive the one or more second discontinuous coverage parameters associated with the second SIM 170, wherein the second SIM 170 is registered with the second NTN 304. As already explained, the database 220 of the UE 150 may have received the one or more second discontinuous coverage parameters from the AMF associated with the NTN network 302 as part of the registration accept message. As such, the processor 202 is configured to determine a completion status of the at least one service on the second SIM 170 based on the time period and one or more second discontinuous coverage parameters associated with the second SIM 170. The completion status is one of: successful completion status and a failed completion status. For example, if the time period for the call is estimated as 1 minute and the second SIM 170 will enter discontinuous coverage only after 2 hours and 20 minutes, then the second SIM 170 will be in coverage to facilitate the call. As such, the processor 202 determines the completion status as successful completion status for the call on the second SIM 170. It shall be noted that the steps from 514 to 526 are performed only if the second SIM 170 is connected in the NTN network 302. If the second SIM 170 of the UE 150 is camping on a Terrestrial network) then the at least one service is automatically switched and initiated to the second SIM 170 of the UE 150.

At 320, the first SIM 160 of the UE 150 provides Notification of Leaving Coverage or Mobility Registration Update to the satellite 110 of the first NTN 110.

At 322, the UE 150 configures the second sim 170 of the UE 150 to provide the at least one service based on the time period and the one or more first discontinuous coverage parameters. More specifically, the processor 202 is configured to switch the at least one service initiated using the first SIM 160 to the second SIM 170 of the UE 150. In an embodiment, a predefined threshold time Tₕ, may be used to determine if the UE 150 would be able to provide the at least one service. For example, if the UE 150 determines that it is about to enter NTN discontinuous coverage on the default calling SIM (e.g., SIM 1) or the UE 150 would be unable to setup/complete the call within the threshold time duration, then the at least one service may be switched to the other available SIMs (for example, SIM 2) with service from the TN/NTN networks. The UE 150 configures the second SIM 170 as the default SIM for calling services and initiates the call automatically over the SIM 2. In an embodiment, the processor 202 may automatically set the available SIM, for example, the second SIM 170 as the default SIM for the plurality of services for which the first SIM was set to be the default SIM. An example of the same is shown in FIG. 4B. In an embodiment, the UE 150 may have one or more SIMs. The one or more SIMs comprise the first SIM 160, the second SIM 170 and the like. In an embodiment, the UE 150 selects the second SIM from the one or more SIMs. The UE 150 determines a capability of the second SIM 170 to provide the at least one service of the plurality of services. The UE 150 configures the second SIM of the UE to provide the at least one service when the second SIM 170 is capable of providing the at least one service. In an embodiment, the UE 150 may switch or set the default configuration or default SIM of at least one service or facilitating of at least one service on/to the second SIM before or during or after the initiation of a service on a first SIM Card or without the initiation of a service on the first SIM card.

As shown in FIG. 4B, due to SIM 1 (e.g., the first SIM 160) not capable of supporting service during the discontinuous coverage period, the SIM 2 is automatically set to be the default SIM for data usage, calling usage and messaging usage without any manual intervention.

At 324, the UE 150 initiates the at least one service on the second SIM 170.

At 326, the at least one service is successfully completed on the second SIM 170 of the UE 150 during discontinuous coverage of the first SIM 160.

At 328, the processor 202 of the UE 150 determines if a discontinuous coverage of the first SIM 160 is completed based on the one or more first discontinuous coverage parameters.

At 330, the processor 202 is configured to set the first SIM 160 as the default SIM of the UE 150 for providing the plurality of services based on the determining. If the UE 150 determines unavailability period duration on actual default calling SIM card (e.g., SIM1) is over or SIM1 is back in any service (NTN network 302), the UE 150 switches or sets the services back to original default SIM providing the service (e.g., SIM1). This ensures the user enjoys uninterrupted and seamless experience in the event of discontinuous satellite coverage on the default SIM (e.g., SIM 1).

In an embodiment, the steps of method 300 may be executed when the second SIM is camped on TN. This embodiment is not illustrated again for the sake of brevity.

The sequence of operations of the method 300 need not be necessarily executed in the same order as they are presented. Further, one or more operations may be grouped together and performed in form of a single step, or one operation may have several sub-steps that may be performed in parallel or in sequential manner.

FIG. 5A is a flowchart illustrating an example method 500 for multi-SIM operation for call services based on NTN during discontinuous satellite coverage, according to various embodiments.

At 502, the UE 150 and a first NTN network 302 negotiate discontinuous coverage support.

At 504, the satellite 110 transmits the one or more of the first discontinuous coverage parameters. For example, the first NTN network 302 (or the first NTN 302) may comprise the satellite 110.

At 506, the UE 150 determines the start of unavailability period and unavailability period duration for discontinuous coverage of the first SIM 160.

At 508, the UE 150 detects initiation of a call on a first SIM 160 of the UE 150 over the first NTN 110. It shall be noted that the first SIM 160 is preset as the default SIM for calling services by the user.

At 510, the UE 150 determines if the first SIM 160 of the UE 150 is about to enter the discontinuous coverage. Due to the discontinuous coverage of the satellite 110 on the SIM1 (e.g., the first SIM 160), the UE 150 is about to lose coverage or service on the default calling or Dialed SIM (e.g., SIM1) in near future (say after about 6 seconds), e.g., before the call could be setup/connected/completed.

At 512, the UE 150 estimates a time period for completion of the at least one service on the first SIM 160 based on one or more service parameters associated with the at least one service. In an embodiment, the one or more service parameters are the service type, the size of service file, the call setup/connection time, the response from server, the response from emergency responder, the estimated call duration based on past history, the data browsing history of the user, the application usage statistics, the service history/statistics, the current uplink/downlink data rate, and the like on the first SIM 160. An example of estimating the time period is explained with reference to FIG. 3 (see, step 316) and is not repeated herein for the sake of brevity.

At 514, the UE 150 determines if the second SIM 170 of the UE 150 is in coverage based on the one or more second discontinuous coverage parameters. To that effect, the processor 202 is configured to receive the one or more second discontinuous coverage parameters associated with the second SIM 170, wherein the second SIM 170 is registered with the second NTN 304. As such, the processor 202 is configured to determine a completion status of the at least one service on the second SIM 170 based on the time period and one or more second discontinuous coverage parameters associated with the second SIM 170. The completion status is one of: successful completion status and a failed completion status. An example of determining the completion status is explained with reference to FIG. 3 (see, step 318). If the second SIM 170 of the UE 150 is camping on a Terrestrial network, then the call is automatically switched and initiated on the second SIM 170 of the UE 150.

At 516, the first SIM 160 of the UE 150 provides Notification of Leaving Coverage or Mobility Registration Update to the satellite 110 of the first NTN 110.

At 518, the UE 150 configures the second SIM 170 of the UE 150 to facilitate the call based on the time period and the one or more first discontinuous coverage parameters. More specifically, the processor 202 is configured to switch the call initiated using the first SIM 160 to the second SIM 170 of the UE 150. In an embodiment, a predefined threshold time Tₕ, may be used to determine if the UE 150 would be able to provide the call. In an embodiment, the UE 150 may switch or set the default configuration or default SIM of at least one service or facilitating of at least one service on/to the second SIM before or during or after the initiation of a service on a first SIM Card or without the initiation of a service on the first SIM card.

At 520, the UE 150 initiates the call on the second SIM 170.

At 522, the call is successfully completed on the second SIM 170 of the UE 150 during discontinuous coverage of the first SIM 160.

At 524, the processor 202 of the UE 150 determines if a discontinuous coverage of the first SIM 160 is completed based on the one or more first discontinuous coverage parameters.

At 526, the processor 202 is configured to set the first SIM 160 as the default SIM of the UE 150 for providing the call based on the determining.

The sequence of operations of the method 500 need not be necessarily executed in the same order as they are presented. Further, one or more operations may be grouped together and performed in form of a single step, or one operation may have several sub-steps that may be performed in parallel or in sequential manner.

FIG. 5B is a flowchart illustrating an example method 540 for multi-SIM operation for data services based on NTN during discontinuous satellite coverage, according to various embodiments.

At 542, the UE 150 and a first NTN network 302 negotiates discontinuous coverage support.

At 544, the satellite 110 transmits the one or more first discontinuous coverage parameters. For example, the first NTN network 302 (or the first NTN 302) may comprise the satellite 110.

At 546, the UE 150 determines the start of unavailability period and unavailability period duration for discontinuous coverage of the first SIM 160.

At 548, the UE 150 detects initiation of data services (for sending a message) on a first SIM 160 of the UE 150 over the first NTN 110. It shall be noted that the first SIM 160 is preset as the default SIM for availing data services by the user.

At 550, the UE 150 determines if the first SIM 160 of the UE 150 is about to enter the discontinuous coverage. Due to the discontinuous coverage of the satellite 110 on the SIM1 (e.g., the first SIM 160), the UE 150 is about to lose coverage or service on the default data service SIM (e.g., SIM1) in near future (say after about 2 seconds), e.g., before the data usage could be completed.

At 552, the UE 150 estimates a time period for completion of the at least one service on the first SIM 160 based on one or more service parameters associated with the at least one service. In an embodiment, the one or more service parameters are the service type, the size of service file, the call setup/connection time, the response from server, the response from emergency responder, the estimated call duration based on past history, the data browsing history of the user, the application usage statistics, the service history/statistics, the current uplink/downlink data rate, and the like on the first SIM 160. An example of estimating the time period is explained with reference to FIG. 3 (see, step 316) and is not repeated herein for the sake of brevity.

At 554, the UE 150 determines if the second SIM 170 of the UE 150 is in coverage based on the one or more second discontinuous coverage parameters. To that effect, the processor 202 is configured to receive the one or more second discontinuous coverage parameters associated with the second SIM 170, wherein the second SIM 170 is registered with the second NTN 304. As such, the processor 202 is configured to determine a completion status of the at least one service on the second SIM 170 based on the time period and one or more second discontinuous coverage parameters associated with the second SIM 170. The completion status is one of: successful completion status and a failed completion status. An example of determining the completion status is explained with reference to FIG. 3 (see, step 318). If the second SIM 170 of the UE 150 is camping on a Terrestrial network, then the data services are automatically switched and initiated on the second SIM 170 of the UE 150.

At 556, the first SIM 160 of the UE 150 provides Notification of Leaving Coverage or Mobility Registration Update to the satellite 110 of the first NTN 110.

At 558, the UE 150 configures the second SIM 170 of the UE 150 to facilitate the data usage for sending a message based on the time period and the one or more first discontinuous coverage parameters. More specifically, the processor 202 is configured to switch the data usage initiated using the first SIM 160 to the second SIM 170 of the UE 150. In an embodiment, a predefined threshold time Tₕ, may be used to determine if the UE 150 would be able to provide the call.

At 560, the UE 150 initiates the data usage for sending a message on the second SIM 170.

At 562, the message is successfully completed on the second SIM 170 of the UE 150 during discontinuous coverage of the first SIM 160.

At 564, the processor 202 of the UE 150 determines if a discontinuous coverage of the first SIM 160 is completed based on the one or more first discontinuous coverage parameters.

At 566, the processor 202 is configured to set the first SIM 160 as the default SIM of the UE 150 for providing the call based on the determining.

The UE initiates a Data Download or File Download (for e.g., a large File Download). Due to the discontinuous coverage of satellite on SIM1, the UE is about to lose coverage/service on the Default/Preferred Data or DDS SIM (e.g., SIM1) in near future (for example after about 5 seconds), e.g., before the File download could be completed. The UE determines Start of Unavailability Period and/or Unavailability Period Duration for the available SIM cards camped on NTN service (for e.g., SIM1) based on available parameters (Rel-18) (determined by the UE or indicated by the Network/Server) such as: Satellite Coverage Availability Information, Unavailability Period Duration/UE out-of-coverage period, Start of Unavailability Period, Mobility Registration Update procedure or Notification of Leaving coverage or any indication/procedure by UE just before entering Discontinuous coverage and the like.

In an embodiment, if the UE determines that it is about to enter NTN discontinuous coverage on Default/Preferred Data SIM or DDS SIM (SIM1) (e.g., x duration remaining: any UE configured small duration for e.g., 5 secs) or UE would be unable to complete the Data activity/transfer within x duration and if the other available SIMs (ex-SIM2) is in service (any TN/NTN service), UE switches or sets Default/Preferred Data services to other available SIMs in service (ex-SIM2) and uses Data Transfer over SIM2, UE initiates and avails Data services over new default/preferred calling SIM Card (e.g., SIM2), File Transfer/Download is successful over SIM2. If the UE determines Unavailability Period Duration/Discontinuous Coverage on actual Default/Preferred Data SIM or DDS SIM (e.g., SIM1) is over or SIM1 is back in any service (TN or NTN service), UE switches or sets the Default/Preferred Data services back to actual/original Default/Preferred Data SIM or DDS SIM in service (ex-SIM1). User enjoys uninterrupted and seamless Data transfer experience in the event of discontinuous satellite coverage on the default/preferred Data or DDS SIM.

The sequence of operations of the method 540 need not be necessarily executed in the same order as they are presented. Further, one or more operations may be grouped together and performed in form of a single step, or one operation may have several sub-steps that may be performed in parallel or in sequential manner.

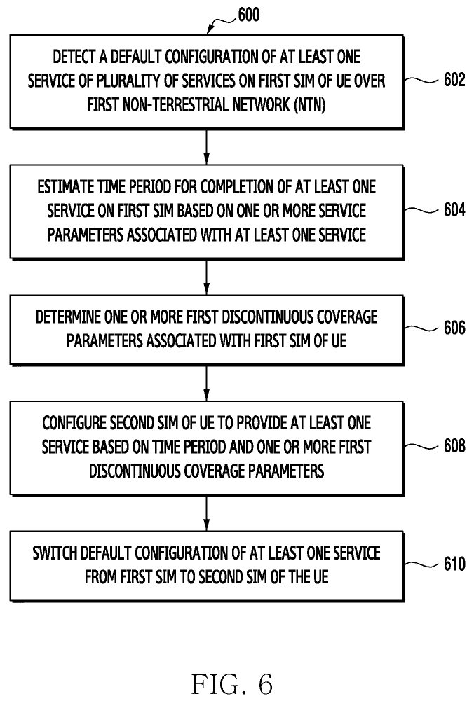

An example of a flow diagram depicting a method for multi-SIM operation based on Non-Terrestrial Network (NTN) during discontinuous satellite coverage is explained in greater detail below with reference to FIG. 6.

FIG. 6 is a flowchart illustrating an example method for multi-Subscriber Identity Module (SIM) operation based on Non-Terrestrial Network (NTN) during discontinuous satellite coverage, according to various embodiments. The method 600 depicted in the flow diagram may be executed by, for example, the processor 202 of the UE 150 shown and explained with reference to FIGS. 2 to 5A-5C. Operations of the flowchart, and combinations of operation in the flowchart, may be implemented by, for example, hardware, firmware, a processor, circuitry and/or a different device associated with the execution of software that includes one or more computer program instructions. The operations of the method 600 are described herein with reference to the UE 150. It is noted that the operations of the method 600 can be described and/or practiced using one or more processors of a system/device other than the processor 202 of the UE 150. The method 600 starts at operation 602.

At operation 602 of the method 600, the default configuration of at least one service of a plurality of services on a first SIM 160 of the UE 150 over a first Non-Terrestrial Network 302 (NTN) is detected by a processor of a User Equipment (UE), for example, the processor 202 of the UE 150.

At operation 604 of the method 600, a time period for completion of the at least one service on the first SIM 160 is estimated based on one or more service parameters associated with the at least one service. In an embodiment, the one or more service parameters are the service type, the size of service file, the call setup/connection time, the response from server, the response from emergency responder, the estimated call duration based on past history, the data browsing history of the user, the application usage statistics, the service history/statistics, the current uplink/downlink data rate, and the like on the first SIM 160. In an example, the processor 202 estimates the time period for completion of the call on the first SIM 160 based on a service type, for example, audio call/video call. For example, if a video call is initiated on the first SIM 160, the processor 202 estimates the video call to last for 5 minutes. In an embodiment, the processor 202 estimates the time period for completion of the call on the first SIM 160 based on the historical data in the database 220 and the one or more service parameters. In an example, for the call initiated on the UE 150, the one or more AI models 222 may be trained to estimate a time period of the call based on the historical data. For example, if the call is from a number registered as sales, the historical data will indicate that the user spends an average of 30 seconds on the call. Such historical data along with day/time (weekday, weekend public holiday, morning, afternoon, evening, night, etc.), location (e.g., office, home, outdoor, outstation, etc.) of the day may be used to predict the time period. It shall be noted that the time period is an estimate and not an accurate representation of the time duration of the call.

At operation 606 of the method 600, one or more first discontinuous coverage parameters associate with the first SIM 160 of the UE 150 is determined. For example, the one or more first discontinuous coverage parameters may be transmitted from the first NTN network 302 or AMF.

At operation 608 of the method 600, a second SIM 170 of the UE 150 is configured to provide the at least one service based on the time period and the one or more first discontinuous coverage parameters. For example, the UE 150 determines if the second SIM 170 of the UE 150 is in coverage based on the one or more second discontinuous coverage parameters. Configuring the second SIM 170 of the UE 150 to provide the at least one service is explained in detail with reference to FIG. 3 and is not repeated herein for the sake of brevity.

At operation 610 of the method 600, the at least one service initiated using the first SIM 160 is switched to the second SIM 170 of the UE 150.

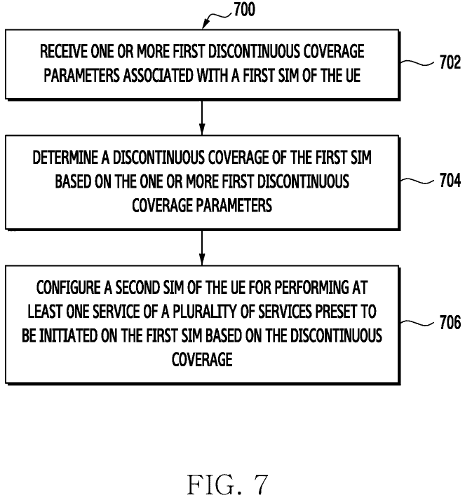

FIG. 7 is a flowchart illustrating an example method for multi-Subscriber Identity Module (SIM) operation based on Non-Terrestrial Network (NTN) during discontinuous satellite coverage, according to various embodiments. The method 700 depicted in the flowchart may be executed by, for example, the processor 202 of the UE 150 shown and explained with reference to FIGS. 2 to 5A-5B. Operations of the flowchart, and combinations of operation in the flowchart, may be implemented by, for example, hardware, firmware, a processor, circuitry and/or a different device associated with the execution of software that includes one or more computer program instructions. The operations of the method 700 are described herein with reference to the UE 150. It is noted that the operations of the method 700 can be described and/or practiced using one or more processors of a system/device other than the processor 202 of the UE 150. The method 700 starts at operation 702.

At operation 702 of the method 700, one or more first discontinuous coverage parameters associated with a first SIM of the UE 150 are received receiving by a processor of a UE, such as the processor 202 of the UE 150. In an embodiment, the AMF transmits the one or more first discontinuous coverage parameters as part of the registration accept message. An example of the registration accept message with the one or more first discontinuous coverage parameters is shown and explained with reference to FIG. 2. In an embodiment, the one or more first discontinuous coverage parameters are received in response to one of: mobility registration update procedure, notification of leaving coverage and any NAS/AS signaling message, initiated by the UE 150. In an embodiment, the one or more first discontinuous coverage parameters are configured by an external server (not shown in FIG. 5A) in one of: a Protocol Data Unit (PDU) session or Short Message Service (SMS).

At operation 704 of the method 700, a discontinuous coverage of the first SIM 160 is determined based on the one or more first discontinuous coverage parameters. For example, the start of unavailability period and unavailability period duration for discontinuous coverage of the first SIM 160 are determined. In an example, the processor 202 is configured to use the one or more AI models 222 to predict the start of unavailability period and unavailability period duration based on the one or more first discontinuous coverage parameters.

At operation 706 of the method 700, a second SIM 170 of the UE 150 is configured for performing at least one service of a plurality of services preset to be initiated on the first SIM 160 based on the discontinuous coverage. Some examples of the services include, but not limited to, calls, emergency calls, messaging, data usage, application usage and the like. As such, the UE 150 is configured to determine if the second SIM 170 of the UE 150 is in coverage based on one or more second discontinuous coverage parameters. For example, the processor 202 is configured to switch the at least one service initiated using the first SIM 160 to the second SIM 170 of the UE 150. In an embodiment, a predefined threshold time Tₕ, may be used to determine if the UE 150 would be able to provide the at least one service. For example, if the UE 150 determines that it is about to enter NTN discontinuous coverage on the default calling SIM (e.g., SIM 1) or the UE 150 would be unable to setup/complete the call within the threshold time duration, then the at least one service may be switched to the other available SIMs (for example, SIM 2) with service from the TN/NTN networks. The UE 150 configures the second SIM 170 as the default SIM for calling services and initiates the call automatically over the SIM 2. In an embodiment, the processor 202 may automatically set the available SIM, for example, the second SIM 170 as the default SIM for the plurality of services for which the first SIM was set to be the default SIM. In an embodiment, the UE 150 may switch or set the default configuration or default SIM of at least one service or facilitating of at least one service on/to the second SIM before or during or after the initiation of a service on a first SIM Card or without the initiation of a service on the first SIM card.

As illustrated in FIGS. 6 and 7, the methods 600/700 may include one or more blocks illustrating a method for multi-Subscriber Identity Module (SIM) operation based on Non-Terrestrial Network (NTN) during discontinuous satellite coverage. The methods 600/700 may be described in the general context of computer executable instructions. Generally, computer executable instructions can include routines, programs, objects, components, data structures, procedures, modules, and functions, which perform specific functions or implement specific abstract data types.

The order in which the method 600/700 is described is not intended to be construed as a limitation, and any number of the described method blocks can be combined in any order to implement the method. Additionally, individual blocks may be deleted from the methods without departing from the scope of the subject matter described herein. Furthermore, the method can be implemented in any suitable hardware, software, firmware, or combination thereof.

The disclosed method 600/700 with reference to FIGS. 6 and 7, respectively, or one or more operations of the flow diagram may be implemented using software including computer-executable instructions stored on one or more computer-readable media (e.g., non-transitory computer-readable media, such as one or more optical media discs, volatile memory components (e.g., DRAM or SRAM), or non-volatile memory or storage components (e.g., hard drives or solid-state non-volatile memory components, such as Flash memory components) and executed on a computer (e.g., any suitable computer, such as a laptop computer, net book, Web book, tablet computing device, smart phone, or other mobile computing device). Such software may be executed, for example, on a single local computer.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with various embodiments described herein. The term “computer-readable medium” should be understood to include tangible items and exclude carrier waves and transient signals, e.g., be non-transitory. Examples include Random Access Memory (RAM), Read-Only Memory (ROM), volatile memory, non-volatile memory, hard drives, CD (Compact Disc) ROMs, DVDs, flash drives, disks, and any other known physical storage media.

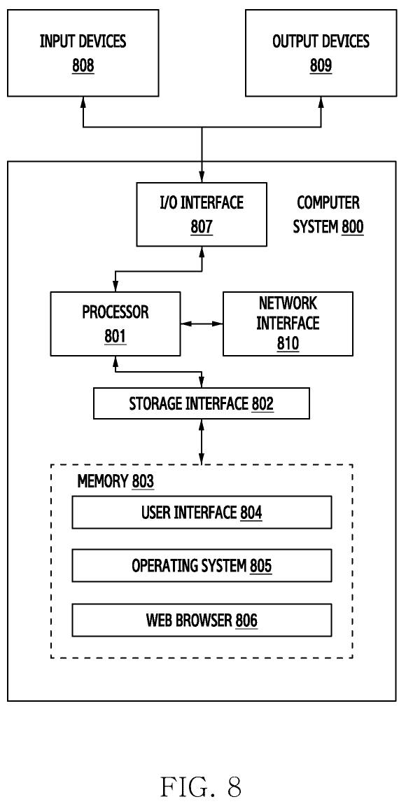

FIG. 8 is a block diagram illustrating an example configuration of a computer for multi-Subscriber Identity Module (SIM) operation based on Non-Terrestrial Network (NTN) during discontinuous satellite coverage, according to various embodiments. The computer system 800 may comprise a central processing unit (“CPU” or “processor” including processing circuitry) 801. The processor 801 may comprise at least one data processor. The processor 801 may include specialized processing units such as integrated system (bus) controllers, memory management control units, floating point units, graphics processing units, digital signal processing units, etc. The computer system 800 may be analogous to the UE 150 (shown in). The processor 801 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

The processor 801 may be disposed in communication with one or more input/output (I/O) devices (not shown) via I/O interface 807. The I/O interface 807 may employ communication protocols/methods such as, without limitation, audio, analog, digital, monoaural, RCA, stereo, IEEE-1394, serial bus, universal serial bus (USB), infrared, PS/2, BNC, coaxial, component, composite, digital visual interface (DVI), high-definition multimedia interface (HDMI), Radio Frequency (RF) antennas, S-Video, VGA, IEEE 802.n/b/g/n/x, Bluetooth, cellular (e.g., code-division multiple access (CDMA), high-speed packet access (HSPA+), global system for mobile communications (GSM), long-term evolution (LTE), WiMax, or the like), etc.

Using the I/O interface (e.g., including input/output circuitry) 807, the computer system 800 may communicate with one or more I/O devices. For example, the input device 808 may be an antenna, keyboard, mouse, joystick, (infrared) remote control, camera, card reader, fax machine, dongle, biometric reader, microphone, touch screen, touchpad, trackball, stylus, scanner, storage device, transceiver, video device/source, etc. The output device 911 may be a printer, fax machine, video display (e.g., cathode ray tube (CRT), liquid crystal display (LCD), light-emitting diode (LED), plasma, Plasma display panel (PDP), Organic light-emitting diode display (OLED) or the like), audio speaker, etc.

In various embodiments, the computer system 800 is connected to the remote devices through a communication network 809. The remote devices may be the first NTN 110 associated with the first SIM 160 and one of: the second NTN 304 or the TN. The processor 801 may be disposed in communication with the communication network via a network interface 810. The network interface 810 may communicate with the communication network. The network interface may employ connection protocols including, without limitation, direct connect, Ethernet (e.g., twisted pair 10/100/1000 Base T), transmission control protocol/internet protocol (TCP/IP), token ring, IEEE 802.11a/b/g/n/x, etc. The communication network may include, without limitation, a direct interconnection, local area network (LAN), wide area network (WAN), wireless network (e.g., using Wireless Application Protocol), the Internet, etc. Using the network interface 810 and the communication network, the computer system 800 may communicate with the remote devices. The network interface 810 may employ connection protocols include, but not limited to, direct connect, Ethernet (e.g., twisted pair 10/100/1000 Base T), transmission control protocol/internet protocol (TCP/IP), token ring, IEEE 802.11a/b/g/n/x, etc.

The communication network includes, but is not limited to, a direct interconnection, an e-commerce network, a peer to peer (P2P) network, local area network (LAN), wide area network (WAN), wireless network (e.g., using Wireless Application Protocol), the Internet, Wi-Fi, 3GPP and such. The first network and the second network may either be a dedicated network or a shared network, which represents an association of the different types of networks that use a variety of protocols, for example, Hypertext Transfer Protocol (HTTP), Transmission Control Protocol/Internet Protocol (TCP/IP), Wireless Application Protocol (WAP), etc., to communicate with each other. Further, the first network and the second network may include a variety of network devices, including routers, bridges, servers, computing devices, storage devices, etc.

In various embodiments, the processor 801 may be disposed in communication with a memory 803 (e.g., RAM, ROM, etc. not shown in FIG. 8) via a storage interface 802. The storage interface 802 may connect to memory 803 including, without limitation, memory drives, removable disc drives, etc., employing connection protocols such as serial advanced technology attachment (SATA), Integrated Drive Electronics (IDE), IEEE-1394, Universal Serial Bus (USB), fiber channel, Small Computer Systems Interface (SCSI), etc. The memory drives may further include a drum, magnetic disc drive, magneto-optical drive, optical drive, Redundant Array of Independent Discs (RAID), solid-state memory devices, solid-state drives, etc.

The memory 803 may store a collection of program or database components, including, without limitation, user interface 804, an operating system 805, web browser 806, etc. In various embodiments, computer system 800 may store user/application data, such as, the data, variables, records, etc., as described in this disclosure. Such databases may be implemented as fault-tolerant, relational, scalable, secure databases such as Oracle® or Sybase®.

The operating system 805 may facilitate resource management and operation of the computer system 800. Examples of operating systems include, without limitation, APPLE MACINTOSH® OS X, UNIX®, UNIX-like system distributions (e.g., BERKELEY SOFTWARE DISTRIBUTION™ (BSD), FREEBSD™, NETBSD™, OPENBSD™, etc.), LINUX DISTRIBUTIONS™ (e.g., RED HAT™, UBUNTU™, KUBUNTU™, etc.), IBM™ OS/2, MICROSOFT™ WINDOWS™ (XP™, VISTA™/7/8, 10 etc.), APPLE® IOS™, GOOGLE® ANDROID™, BLACKBERRY® OS, or the like.

In various embodiments, the computer system 800 may implement a web browser 806 stored program component. The web browser 808 may be a hypertext viewing application, for example MICROSOFT® INTERNET EXPLORER™, GOOGLE® CHROME™, MOZILLA® FIREFOX™, APPLER SAFARI™, etc. Secure web browsing may be provided using Secure Hypertext Transport Protocol (HTTPS), Secure Sockets Layer (SSL), Transport Layer Security (TLS), etc. Web browsers 808 may utilize facilities such as AJAX™, DHTML™, ADOBER FLASH™, JAVASCRIPT™, JAVA™, Application Programming Interfaces (APIs), etc. In various embodiments, the computer system 800 may implement a mail server stored program component. The mail server may be an Internet mail server such as Microsoft Exchange, or the like. The mail server may utilize facilities such as ASP™, ACTIVEX™, ANSI™ C++/C#, MICROSOFT®, .NET™, CGI SCRIPTS™, JAVA™, JAVASCRIPT™, PERL™, PHP™, PYTHON™, WEBOBJECTS™, etc. The mail server may utilize communication protocols such as Internet Message Access Protocol (IMAP), Messaging Application Programming Interface (MAPI), MICROSOFT® exchange, Post Office Protocol (POP), Simple Mail Transfer Protocol (SMTP), or the like. In various embodiments, the computer system 800 may implement a mail client stored program component. The mail client may be a mail viewing application, such as APPLE® MAIL™, MICROSOFT® ENTOURAGE™, MICROSOFT® OUTLOOK™, MOZILLA® THUNDERBIRD™, etc.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with various embodiments described herein. The term “computer-readable medium” should be understood to include tangible items and exclude carrier waves and transient signals, e.g., be non-transitory. Examples include Random Access Memory (RAM), Read-Only Memory (ROM), volatile memory, non-volatile memory, hard drives, CD (Compact Disc) ROMs, DVDs, flash drives, disks, and any other known physical storage media.

Various embodiments of the present disclosure provide numerous advantages. Embodiments of the present disclosure provide a dynamic service switch for multi-SIM operation based on NTN during discontinuous satellite coverage. For example, the user services ongoing on the default SIM (for example, SIM1) would not face failures or service issues in the event of discontinuous satellite coverage on the default SIM by dynamically performing default service switch (e.g., default calling/messaging Service Switch) to other available SIM Card(s) (for example, SIM2) prior/before the determined start of the discontinuous coverage on the default SIM. The current disclosure also aims to utilize the newly introduced discontinuous satellite coverage parameters in 3GPP Rel-18 such as satellite coverage availability information, unavailability period duration, unavailability period support, start of unavailability period, notification of leaving coverage, discontinuous coverage support etc., to select the optimum available SIM Card(s) for getting user services during discontinuous satellite coverage, Moreover, the disclosure also ensures dynamic switching from the default Settings to the other available SIM (provided it has network coverage), thereby ensuring that the user services are initiated and completed successfully. Further, the present disclosure would give the users a hassle-free uninterrupted service during discontinuous coverage from any of the available SIM Cards without any manual user intervention. In general, techniques disclosed herein enhance service continuity, enrich user experience and provide better user experience without any manual intervention of the users.

According to embodiments, a method for multi-Subscriber Identity Module (SIM) operation in a Non-Terrestrial Network (NTN), may comprise detecting, by a User Equipment (UE), a default configuration of at least one service of a plurality of services on a first SIM of the UE over a first NTN. The method may comprise estimating, by the UE, a time period for completion of the at least one service on the first SIM based on one or more service parameters associated with the at least one service. The method may comprise determining, by the UE, one or more first discontinuous coverage parameters associated with the first SIM of the UE. The method may comprise configuring, by the UE, a second SIM of the UE to provide the at least one service based on the time period and the one or more first discontinuous coverage parameters. The method may comprise switching, by the UE, the default configuration of at least one service from the first SIM to the second SIM of the UE.

In an embodiment, the configuring the second SIM further may comprise selecting, by the UE, the second SIM from one or more SIMs in the UE. The configuring the second SIM further may comprise determining, by the UE, a capability of the second SIM to provide the at least one service of the plurality of services. The configuring the second SIM further may comprise configuring, by the UE, the second SIM of the UE to provide the at least one service.

In an embodiment, the one or more discontinuous coverage parameters may comprise at least one of: a satellite coverage availability information, a satellite ephemeris information, an unavailability configuration, an unavailability information, a start of an unavailability period, an unavailability period duration, an unavailability type, a network operator deployment information, an information from a server, a network broadcast parameter and a network signalling parameter.

In an embodiment, the second SIM may be registered with one of: a Terrestrial Network (TN) and a second NTN.

In an embodiment, the configuring the second SIM of the UE may comprise receiving, by the UE, one or more second discontinuous coverage parameters associated with the second SIM, wherein the second SIM is registered with the second NTN. The configuring the second SIM of the UE may comprise determining, by the UE, a completion status of the at least one service on the second SIM based on the time period and one or more second discontinuous coverage parameters associated with the second SIM, wherein the completion status is one of: successful completion status and a failed completion status. The configuring the second SIM of the UE may comprise configuring, by the UE, the second SIM to facilitate the at least one service on determining the successful completion status.

In an embodiment, the configuring the second SIM of the UE may comprise configuring, by the UE, the second SIM registered with the TN, to facilitate the plurality of services for at least a specified time period corresponding to an unavailability period duration of the first SIM.

In an embodiment, the default configuration may be one of: a Default SIM, a Default Service SIM, a Default Data SIM (DDS), a Default Calling SIM, a Default Messaging SIM, a Default Application Usage SIM and a Default Emergency Usage SIM.

In an embodiment, the method may comprise determining, by the UE, whether a discontinuous coverage of the first SIM is completed based on the one or more first discontinuous coverage parameters. The method may comprise setting, by the UE, the first SIM as the default configuration of the UE for providing the plurality of services based on the determining.

In an embodiment, the one or more service parameters may include a service type, a size of service file, a call setup/connection time, a response from server, a response from emergency responder, an estimated call duration based on past history, a data browsing history of the user, an application usage statistics, a service history/statistics and a current uplink/downlink data rate on the one or more SIMs.

In an embodiment, the plurality of services may comprise data services, call services, emergency services, application usage, background services and messaging services.

According to embodiments, a User Equipment (UE) for multi-Subscriber Identity Module (SIM) operation in a Non-Terrestrial Network (NTN), may comprise a first SIM configured to provide at least one service of a plurality of services for the UE over a first NTN. The UE may comprise a second SIM. The UE may comprise a memory configured to store instructions. The UE may comprise at least one processor, comprising processing circuitry, individually and/or collectively, configured to execute the instructions stored in the memory. The at least one processor, individually and/or collectively, may be configured to detect a default configuration of the at least one service on the first SIM of the UE. The at least one processor, individually and/or collectively, may be configured to estimate a time period for completion of the at least one service on the first SIM based on one or more service parameters associated with the at least one service. The at least one processor, individually and/or collectively, may be configured to determine one or more first discontinuous coverage parameters associated with the first SIM of the UE. The at least one processor, individually and/or collectively, may be configured to configure a second SIM of the UE to provide the at least one service based on the time period and the one or more first discontinuous coverage parameters. The at least one processor, individually and/or collectively, may be configured to switch the default configuration of at least one service from the first SIM to the second SIM of the UE.

In an embodiment, to configure the second SIM, at least one processor, individually and/or collectively, may be configured to select the second SIM from one or more SIMs in the UE. To configure the second SIM, at least one processor, individually and/or collectively, may be configured to determine a capability of the second SIM to provide the at least one service of the plurality of services. To configure the second SIM, at least one processor, individually and/or collectively, may be configured to configure the second SIM of the UE to provide the at least one service.

In an embodiment, the one or more discontinuous coverage parameters may comprise at least one of: a satellite coverage availability information, a satellite ephemeris information, an unavailability configuration, an unavailability information, a start of an unavailability period, an unavailability period duration, an unavailability type, a network operator deployment information, an information from a server, a network broadcast parameter and a network signalling parameter.

In an embodiment, the second SIM may be registered with one of: a Terrestrial Network (TN) and a second NTN.

In an embodiment, for configuring the second SIM of the UE, at least one processor, individually and/or collectively, may be configured to receive one or more second discontinuous coverage parameters associated with the second SIM, wherein the second SIM is registered with the second NTN. For configuring the second SIM of the UE, at least one processor, individually and/or collectively, may be configured to determine a completion status of the at least one service on the second SIM based on the time period and one or more second discontinuous coverage parameters associated with the second SIM, wherein the completion status is one of: successful completion status and a failed completion status. For configuring the second SIM of the UE, at least one processor, individually and/or collectively, may be configured to configure the second SIM to facilitate the at least one service on determining the successful completion status.

In an embodiment, for configuring the second SIM of the UE, at least one processor, individually and/or collectively, may be configured to configure the second SIM registered with the TN, to facilitate the plurality of services for at least a specified time period corresponding to an unavailability period duration of the first SIM.

In an embodiment, the default configuration may be one of: a Default SIM, a Default Service SIM, a Default Data SIM (DDS), a Default Calling SIM, a Default Messaging SIM, a Default Application Usage SIM and a Default Emergency Usage SIM.

In an embodiment, at least one processor, individually and/or collectively, may be configured to determine whether a discontinuous coverage of the first SIM is completed based on the one or more first discontinuous coverage parameters. At least one processor, individually and/or collectively, may be configured to set the first SIM as the default SIM of the UE for providing the plurality of services based on the determining.

In an embodiment, the one or more service parameters may include a service type, a size of service file, a call setup/connection time, a response from server, a response from emergency responder, an estimated call duration based on past history, a data browsing history of the user, an application usage statistics, a service history/statistics and a current uplink/downlink data rate on the one or more SIMs.

In an embodiment, the plurality of services may comprise data services, call services, emergency services, application usage, background services and messaging services.

In an embodiment, a method for multi-Subscriber Identity Module (SIM) operation in a Non-Terrestrial Network (NTN), may comprise receiving, by a User Equipment, one or more first discontinuous coverage parameters associated with a first SIM of the UE. The method may comprise identify an initiation of at least one service of a plurality of services on a first SIM. The method may comprise determining, by the UE, a discontinuous coverage of the first SIM based on the one or more first discontinuous coverage parameters. The method may comprise continuing, by the UE, the at least one service of the plurality of services over a second SIM based on the discontinuous coverage.

According to embodiments, a method performed by a user equipment (UE) for multi-Subscriber Identity Module (SIM) operation, may comprise receiving one or more discontinuous coverage parameters associated with a first SIM of the UE. The method may comprise identifying a default SIM of at least one service as the first SIM of the UE over a first non-terrestrial network (NTN). The method may comprise estimating a time period for completion of the at least one service based on one or more service parameters associated with the at least one service. The method may comprise configuring a second SIM of the UE to provide the at least one service based on the time period and the one or more discontinuous coverage parameters. The method may comprise switching the default SIM of at least one service from the first SIM to the second SIM of the UE.

In an embodiment, the configuring the second SIM may further comprise selecting the second SIM from among multi-SIMs of the UE. The configuring the second SIM may further comprise determining a capability of the second SIM to provide the at least one service. The configuring the second SIM may further comprise configuring the second SIM of the UE to provide the at least one service.

In an embodiment, the one or more discontinuous coverage parameters may comprise at least one of: a satellite coverage availability information, a satellite ephemeris information, an unavailability configuration, an unavailability information, a start of an unavailability period, an unavailability period duration, an unavailability type, a network operator deployment information, an information from a server, a network broadcast parameter, or a network signalling parameter.

In an embodiment, the second SIM may be registered with one of: a Terrestrial Network (TN) and a second NTN.

In an embodiment, the configuring the second SIM of the UE may comprise receiving one or more another discontinuous coverage parameters associated with the second SIM, wherein the second SIM is registered with a second NTN. The configuring the second SIM of the UE may comprise determining a completion status of the at least one service on the second SIM based on the time period and the one or more another discontinuous coverage parameters associated with the second SIM, wherein the completion status is one of: successful completion status and a failed completion status. The configuring the second SIM of the UE may comprise configuring the second SIM to facilitate the at least one service on determining the successful completion status.

In an embodiment, the configuring the second SIM of the UE may comprise configuring the second SIM registered with the TN, to facilitate the plurality of services for at least a specified time period corresponding to an unavailability period duration of the first SIM.

In an embodiment, the method may comprise performing a negotiation of discontinuous coverage support with the first NTN. The method may comprise receiving, from the first NTN, the one or more discontinuous coverage parameters associated with the first SIM in the multi-SIM of the UE.

In an embodiment, the method may comprise determining whether a discontinuous coverage of the first SIM is completed based on the one or more discontinuous coverage parameters. The method may comprise setting the first SIM as the default SIM of the UE based on the determining that the discontinuous coverage of the first SIM is completed.

In an embodiment, the one or more service parameters may include a service type, a size of service file, a call setup/connection time, a response from server, a response from emergency responder, an estimated call duration based on past history, a data browsing history of the user, an application usage statistics, a service history/statistics and a current uplink/downlink data rate on the one or more SIMs.

In an embodiment, the at least one service may comprise data services, call services, emergency services, application usage, background services, or messaging services.

In an embodiment, a User Equipment (UE) for multi-Subscriber Identity Module (SIM) operation, may comprise a first SIM configured to provide at least one service for the UE over a first NTN. The UE may comprise a second SIM. The UE may comprise memory, storing instructions, including one or more storage media. The UE may comprise at least one processor including processing circuitry. The instructions, when executed by the at least one processor individually and/or collectively, may cause the UE to receive one or more discontinuous coverage parameters associated with the first SIM of the UE. The instructions, when executed by the at least one processor individually and/or collectively, may cause the UE to identify a default SIM of at least one service as the first SIM of the UE over the first NTN. The instructions, when executed by the at least one processor individually and/or collectively, may cause the UE to estimate a time period for completion of the at least one service based on one or more service parameters associated with the at least one service. The instructions, when executed by the at least one processor individually and/or collectively, may cause the UE to configure the second SIM of the UE to provide the at least one service based on the time period and the one or more discontinuous coverage parameters. The instructions, when executed by the at least one processor individually and/or collectively, may cause the UE to switch the default SIM of at least one service from the first SIM to the second SIM of the UE.

In an embodiment, the instructions, for configuring the second SIM, when executed by the at least one processor individually and/or collectively, may cause the UE to select the second SIM from among multi-SIMs of the UE. The instructions, for configuring the second SIM, when executed by the at least one processor individually and/or collectively, may cause the UE to determine a capability of the second SIM to provide the at least one service. The instructions, for configuring the second SIM, when executed by the at least one processor individually and/or collectively, may cause the UE to configure the second SIM of the UE to provide the at least one service.

In an embodiment, the one or more discontinuous coverage parameters may comprise at least one of: satellite coverage availability information, a satellite ephemeris information, an unavailability configuration, an unavailability information, a start of an unavailability period, an unavailability period duration, an unavailability type, a network operator deployment information, an information from a server, a network broadcast parameter, or a network signalling parameter.

In an embodiment, the second SIM may be registered with one of: a Terrestrial Network (TN) and a second NTN.

In an embodiment, the instructions, for configuring the second SIM, when executed by the at least one processor individually and/or collectively, may cause the UE to receive one or more another discontinuous coverage parameters associated with the second SIM, wherein the second SIM is registered with a second NTN. The instructions, for configuring the second SIM, when executed by the at least one processor individually and/or collectively, may cause the UE to determine a completion status of the at least one service on the second SIM based on the time period and the one or more another discontinuous coverage parameters associated with the second SIM, wherein the completion status is one of: successful completion status and a failed completion status. The instructions, for configuring the second SIM, when executed by the at least one processor individually and/or collectively, may cause the UE to configure the second SIM to facilitate the at least one service on determining the successful completion status.

In an embodiment, the instructions, for configuring the second SIM, when executed by the at least one processor individually and/or collectively, may cause the UE to configure the second SIM registered with the TN, to facilitate the plurality of services for at least a specified time period corresponding to an unavailability period duration of the first SIM.

In an embodiment, the instructions, when executed by the at least one processor individually and/or collectively, may cause the UE to perform a negotiation of discontinuous coverage support with the first NTN. The instructions, when executed by the at least one processor individually and/or collectively, may cause the UE to receive, from the first NTN, the one or more discontinuous coverage parameters associated with the first SIM in the multi-SIM of the UE.

In an embodiment, the instructions, when executed by the at least one processor individually and/or collectively, may cause the UE to determine whether a discontinuous coverage of the first SIM is completed based on the one or more first discontinuous coverage parameters. The instructions, when executed by the at least one processor individually and/or collectively, may cause the UE to set the first SIM as the default SIM of the UE based on the determining that the discontinuous coverage of the first SIM is completed.

In an embodiment, the one or more service parameters may include a service type, a size of service file, a call setup/connection time, a response from server, a response from emergency responder, an estimated call duration based on past history, a data browsing history of the user, an application usage statistics, a service history/statistics and a current uplink/downlink data rate on the one or more SIMs.

In an embodiment, a non-transitory computer-readable medium may store one or more programs including instructions, when individually and/or collectively executed by at least one processor of a user equipment (UE) with a first SIM configured to provide at least one service for the UE over a first non-terrestrial network (NTN) and a second SIM, cause the UE to receive one or more discontinuous coverage parameters associated with the first SIM of the UE. The non-transitory computer-readable medium may store one or more programs including instructions, when individually and/or collectively executed by the at least one processor, cause the UE to identify a default SIM of at least one service as the first SIM of the UE over the first NTN. The non-transitory computer-readable medium may store one or more programs including instructions, when individually and/or collectively executed by the at least one processor, cause the UE to estimate a time period for completion of the at least one service based on one or more service parameters associated with the at least one service. The non-transitory computer-readable medium may store one or more programs including instructions, when individually and/or collectively executed by the at least one processor, cause the UE to configure the second SIM of the UE to provide the at least one service based on the time period and the one or more discontinuous coverage parameters. The non-transitory computer-readable medium may store one or more programs including instructions, when individually and/or collectively executed by the at least one processor, cause the UE to switch the default SIM of at least one service from the first SIM to the second SIM of the UE.

The terms “an embodiment”, “embodiment”, “embodiments”, “the embodiment”, “the embodiments”, “one or more embodiments”, “some embodiments”, and “one embodiment” may refer, for example, to “one or more (but not all) embodiments of the disclosure” unless expressly specified otherwise.

The terms “including”, “comprising”, “having” and variations thereof may refer, for example, to “including but not limited to”, unless expressly specified otherwise.

The enumerated listing of items does not imply that any or all the items are mutually exclusive, unless expressly specified otherwise. The terms “a”, “an” and “the” may refer, for example, to “one or more”, unless expressly specified otherwise.

A description of an embodiment with several components in communication with each other does not imply that all such components are required. A variety of optional components are described to illustrate the wide variety of possible embodiments of the disclosure.

When a single device or article is described herein, it will be clear that more than one device/article (whether they cooperate) may be used in place of a single device/article. Similarly, where more than one device/article is described herein (whether they cooperate), it will be clear that a single device/article may be used in place of the more than one device/article, or a different number of devices/articles may be used instead of the shown number of devices or programs. The functionality and/or features of a device may be alternatively embodied by one or more other devices which are not explicitly described as having such functionality/features. Thus, various embodiments of disclosure need not include the device itself.

The language used in the disclosure has been selected for readability and instructional purposes, and it may not have been selected to delineate or circumscribe the disclosed subject matter. It is therefore intended that the scope of the disclosure not be limited not by this detailed description. Accordingly, embodiments of the present disclosure are intended to be illustrative, but not limiting.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

It will be understood by those within the art that, in general, terms used herein, and are generally intended as “open” terms (e.g., the term “including” should be interpreted as “including but not limited to,” the term “having” should be interpreted as “having at least,” the term “includes” should be interpreted as “includes but is not limited to,” etc.). For example, as an aid to understanding, the detail description may contain usage of the introductory phrases “at least one” and “one or more” to introduce recitations. However, the use of such phrases should not be construed to imply that the introduction of a recitation by the indefinite articles “a” or “an” limits any particular part of description containing such introduced recitation to embodiments containing only one such recitation, even when the introductory phrases “one or more” or “at least one” and indefinite articles such as “a” or “an” (e.g., “a” and/or “an” should typically be interpreted to refer to “at least one” or “one or more”) are included in the recitations; the same holds true for the use of definite articles used to introduce such recitations. In addition, even if a specific part of the introduced description recitation is explicitly recited, those skilled in the art will recognize that such recitation should typically be interpreted to refer to at least the recited number (e.g., the bare recitation of “two recitations,” without other modifiers, typically indicates at least two recitations or two or more recitations).

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the detailed description including the appended claims and their equivalents. It will also be understood that any of the embodiment(s) described herein may be used in conjunction with any other embodiment(s) described herein.

No claim element is to be construed under the provisions of 35 U.S.C. § 112, sixth paragraph, unless the element is expressly recited using the phrase “means for” or “means”.

What is claimed is:

1. A method performed by a user equipment (UE) for multi-Subscriber Identity Module (SIM) operation, comprising:
receiving one or more discontinuous coverage parameters associated with a first SIM of the UE;
identifying a default SIM of at least one service as the first SIM of the UE over a first non-terrestrial network (NTN);
estimating a time period for completion of the at least one service based on one or more service parameters associated with the at least one service;
configuring a second SIM of the UE to provide the at least one service based on the time period and the one or more discontinuous coverage parameters; and
switching the default SIM of at least one service from the first SIM to the second SIM of the UE.

2. The method of claim 1, wherein configuring the second SIM further comprises:
selecting the second SIM from among multi-SIMs of the UE;
determining a capability of the second SIM to provide the at least one service; and
configuring the second SIM of the UE to provide the at least one service.

3. The method of claim 1, wherein the one or more discontinuous coverage parameters comprise at least one of: a satellite coverage availability information, a satellite ephemeris information, an unavailability configuration, an unavailability information, a start of an unavailability period, an unavailability period duration, an unavailability type, a network operator deployment information, an information from a server, a network broadcast parameter, or a network signalling parameter.

4. The method of claim 1, wherein the second SIM is registered with one of: a Terrestrial Network (TN) and a second NTN.

5. The method of claim 1, wherein configuring the second SIM of the UE comprises:
receiving one or more another discontinuous coverage parameters associated with the second SIM, wherein the second SIM is registered with a second NTN;
determining a completion status of the at least one service on the second SIM based on the time period and the one or more another discontinuous coverage parameters associated with the second SIM, wherein the completion status is one of: successful completion status and a failed completion status; and
configuring the second SIM to facilitate the at least one service on determining the successful completion status.

6. The method of claim 4, wherein configuring the second SIM of the UE comprises:
configuring the second SIM registered with the TN, to facilitate the plurality of services for at least a specified time period corresponding to an unavailability period duration of the first SIM.

7. The method of claim 1, further comprising:
performing a negotiation of discontinuous coverage support with the first NTN; and
receiving, from the first NTN, the one or more discontinuous coverage parameters associated with the first SIM in the multi-SIM of the UE.

8. The method of claim 1, further comprising:
determining whether a discontinuous coverage of the first SIM is completed based on the one or more discontinuous coverage parameters; and
setting the first SIM as the default SIM of the UE based on the determining that the discontinuous coverage of the first SIM is completed.

9. The method of claim 1, wherein the one or more service parameters include a service type, a size of service file, a call setup/connection time, a response from server, a response from emergency responder, an estimated call duration based on past history, a data browsing history of the user, an application usage statistics, a service history/statistics and a current uplink/downlink data rate on the one or more SIMs.

10. The method of claim 1, wherein the at least one service comprises: data services, call services, emergency services, application usage, background services, or messaging services.

11. A User Equipment (UE) for multi-Subscriber Identity Module (SIM) operation, comprising:
a first SIM configured to provide at least one service for the UE over a first NTN;
a second SIM;
memory, storing instructions, including one or more storage media; and
at least one processor including processing circuitry,
wherein the instructions, when executed by the at least one processor individually and/or collectively, cause the UE to:
receive one or more discontinuous coverage parameters associated with the first SIM of the UE;
identify a default SIM of at least one service as the first SIM of the UE over the first NTN;
estimate a time period for completion of the at least one service based on one or more service parameters associated with the at least one service;
configure the second SIM of the UE to provide the at least one service based on the time period and the one or more discontinuous coverage parameters; and
switch the default SIM of at least one service from the first SIM to the second SIM of the UE.

12. The UE of claim 11, wherein the instructions, for configuring the second SIM, when executed by the at least one processor individually and/or collectively, cause the UE to:
select the second SIM from among multi-SIMs of the UE;
determine a capability of the second SIM to provide the at least one service; and
configure the second SIM of the UE to provide the at least one service.

13. The UE of claim 11, wherein the one or more discontinuous coverage parameters comprise at least one of: satellite coverage availability information, a satellite ephemeris information, an unavailability configuration, an unavailability information, a start of an unavailability period, an unavailability period duration, an unavailability type, a network operator deployment information, an information from a server, a network broadcast parameter, or a network signalling parameter.

14. The UE of claim 11, wherein the second SIM is registered with one of: a Terrestrial Network (TN) and a second NTN.

15. The UE of claim 11, wherein the instructions, for configuring the second SIM, when executed by the at least one processor individually and/or collectively, cause the UE to:
receive one or more another discontinuous coverage parameters associated with the second SIM, wherein the second SIM is registered with a second NTN;
determine a completion status of the at least one service on the second SIM based on the time period and the one or more another discontinuous coverage parameters associated with the second SIM, wherein the completion status is one of: successful completion status and a failed completion status; and
configure the second SIM to facilitate the at least one service on determining the successful completion status.

16. The UE of claim 14, wherein the instructions, for configuring the second SIM, when executed by the at least one processor individually and/or collectively, cause the UE to:
configure the second SIM registered with the TN, to facilitate the plurality of services for at least a specified time period corresponding to an unavailability period duration of the first SIM.

17. The UE of claim 11, wherein the instructions, when executed by the at least one processor individually and/or collectively, cause the UE to:
perform a negotiation of discontinuous coverage support with the first NTN; and
receive, from the first NTN, the one or more discontinuous coverage parameters associated with the first SIM in the multi-SIM of the UE.

18. The UE of claim 11, wherein the instructions, when executed by the at least one processor individually and/or collectively, cause the UE to:
determine whether a discontinuous coverage of the first SIM is completed based on the one or more first discontinuous coverage parameters; and
set the first SIM as the default SIM of the UE based on the determining that the discontinuous coverage of the first SIM is completed.

19. The UE of claim 11, wherein the one or more service parameters include a service type, a size of service file, a call setup/connection time, a response from server, a response from emergency responder, an estimated call duration based on past history, a data browsing history of the user, an application usage statistics, a service history/statistics and a current uplink/downlink data rate on the one or more SIMs.

20. A non-transitory computer-readable medium storing one or more programs including instructions, when individually and/or collectively executed by at least one processor of a user equipment (UE) with a first SIM configured to provide at least one service for the UE over a first non-terrestrial network (NTN) and a second SIM, cause the UE to:
receive one or more discontinuous coverage parameters associated with the first SIM of the UE;
identify a default SIM of at least one service as the first SIM of the UE over the first NTN;
estimate a time period for completion of the at least one service based on one or more service parameters associated with the at least one service;
configure the second SIM of the UE to provide the at least one service based on the time period and the one or more discontinuous coverage parameters; and
switch the default SIM of at least one service from the first SIM to the second SIM of the UE.
